(19) United States
(12) Patent Application Publication
(10) Pub. No.: US 2007/0255893 A1
(43) Pub. Date: Nov. 1, 2007

(54) Nonvolatile semiconductor memory device

(76) Inventor: Ken Takeuchi, Stanford, CA (US)

Correspondence Address: FROMMER LAWRENCE & HAUG, 745 FIFTH AVENUE- 10TH FL., NEW YORK, NY, 10151, US

(21) Appl. No.: 11/823,694

(22) Filed: Jun. 28, 2007

Related U.S. Application Data
(63) Continuation of application No. 10/126,990, filed on Apr. 18, 2002.

(30) Foreign Application Priority Data
Apr. 18, 2001 (JP) 2001-119659

(51) Int. Cl. G06F 12/00

(52) U.S. Cl. 711/103

(57) ABSTRACT

A nonvolatile semiconductor memory device is disclosed, which comprises a memory cell portion including at least one memory cell configured to store n levels (n is 3 or more), a bit line connected to one end of the memory cell portion, a data input/output circuit, and a data circuit which is connected to the bit line and the input/output circuit and configured to store write data or read data of 2 bits or more into or from the memory cell portion, in which, during a write operation, the write data inputted from the data input/output circuit is held in the data circuit and the read data read from the memory cell is held on the bit line.

### CROSS-REFERENCE TO RELATED APPLICATIONS

This application is based upon and claims the benefit of priority from the prior Japanese Patent Application No. 2001-119659, filed Apr. 18, 2001 the entire contents of which are incorporated herein by reference.

### BACKGROUND OF THE INVENTION

1. Field of the Invention

The present invention relates to a nonvolatile semiconductor memory device, particularly to a multi-level or multi-value NAND cell type EEPROM device (electrically erasable and programmable read only memory) such as a four-level NAND cell type EEPROM device.

2. Description of the Related Art

As one of nonvolatile semiconductor memories, a NAND cell type EEPROM device is known. The EEPROM device has a memory cell array constituted of a plurality of NAND cell units. Each NAND cell unit is connected between a bit line and a source line and is constituted of a plurality of memory cells connected in series to one another and two select transistors connected to ends of the series-connected memory cells.

Each memory cell is constituted of an n-channel MOS transistor having a so-called stacked gate structure in which a control gate electrode is stacked onto a floating gate electrode. Similarly, each select transistor is constituted of an n-channel MOS transistor having a structure in which an upper electrode is stacked onto a lower electrode. However, for example, the lower electrode functions as the gate electrode of the select transistor.

One source region or one drain region is shared by two transistors arranged adjacent to each other among a plurality of transistors (memory cell, select transistor) in the NAND cell unit.

A concrete structure of the NAND cell type EEPROM device will be described hereinafter.

FIG. 29 shows a part of the memory cell array of the NAND cell type EEPROM device.

A NAND cell unit is connected between a bit line BLi and a source line SL and is constituted of a plurality of (such as four, eight, sixteen) memory cells connected in series to one another and two select transistors each connected to ends of the series-connected memory cells. The source line SL is connected to a reference potential line constituted of a conductive material such as aluminum, polysilicon or the like in a predetermined position.

The source lines SL extend in a row direction, and the bit lines BLi and reference potential lines extend in a column direction. Contact portions of the source lines SL and reference potential lines are provided in respective intersections of the source lines SL and, for example, 64 bit lines BL0, . . . , BL63. The reference potential lines are connected to so-called peripheral circuits provided in a peripheral portion of the memory cell array.

Word lines (control gate lines) WL1, . . . WLn extend in the row direction, and select gate lines SG1, SG2 also extend in the row direction. A group of memory cells connected to one word line (control gate line) WLi is called one page. The group of memory cells connected to the word lines WL1, . . . WLn sandwiched between two select gate lines SG1, SG2 is called one NAND block or simply one block.

One page is constituted, for example, of 256 bytes (256×8 cells) of memory cells. Data is written in the memory cells in one page substantially at the same time. Moreover, when one page is constituted of 256 bytes of memory cells, and one NAND cell unit is constituted of eight memory cells, then one block is constituted of 2048 bytes (2048×8 cells) of memory cells. Data is erased from the memory cells in one block substantially at the same time.

FIG. 30 shows a plan view of one NAND cell unit in the memory cell array. FIG. 31A shows a cross sectional view taken along the line XXXIA-XXXIA, FIG. 31B shows a cross sectional view taken along the line XXXIB-XXXIB of FIG. 30, and FIG. 32 shows an equivalent circuit of the NAND cell unit of FIG. 30.

In a p-type substrate (p-sub) 11-1, a so-called double well region is formed of an n-type well region (Cell n-well) 11-2 and p-type well region (Cell p-well) 11-3. The memory cell and select transistor are formed in the p-type well region 11-3.

The memory cell and select transistor are provided in an element region in the p-type well region 11-3. The element region is surrounded by an element separating oxide film (element separating region) 12 formed on the p-type well region 11-3.

In this example, one NAND cell unit is constituted of eight memory cells M1 to M8 connected in series to one another and two select transistors S1, S2 connected to ends of the series-connected memory cells M1 to M8.

The memory cell is constituted of a silicon oxide film (gate insulating film) 13 formed on the p-type well region (Cell p-well) 11-3, floating gate electrodes 14 (14₁, 14₂, . . . 14₈) on the silicon oxide film 13, a silicon oxide film (inter-gate insulating film) 15 on the floating gate electrodes 14 (14₁, 14₂, . . . 14₈), control gate electrodes 16 (16₁, 16₂, . . . 16₈) on the silicon oxide film 15, and source/drain regions 19 in the p-type well region (Cell p-well) 11-3.

Moreover, the select transistor is constituted of a silicon oxide film (gate insulating film) formed on the p-type well region 11-3, gate electrodes 14 (14₉, 14₁₀) and 16 (16₉, 16₁₀) on the silicon oxide film, and source/drain regions 19 in the p-type well region 11-3.

A reason why the structure of the select transistor is similar to the structure of the memory cell lies in that the memory cell and select transistor are simultaneously formed in the same process, and manufacturing cost is reduced by reducing the number of steps of the process.

One drain region (n+ type diffusion layer) 19 is shared by two transistors provided adjacent to each other in a plurality of transistors (memory cell, select transistor) in the NAND cell unit, one source region (n+ type diffusion layer) 19.

The memory cell and select transistor are coated with a silicon oxide film (CVD oxide film) 17 formed by a CVD process. A bit line 18 is connected to one end of the NAND cell unit (n+ type diffusion layer 19) and is provided on the CVD oxide film 17.

FIG. 33 shows a well structure of a NAND cell type EEPROM device. In the p-type substrate (p-sub) 11-1, a so-called double well region constituted of the n-type well region (Cell n-well) 11-2 and p-type well region (Cell p-well) 11-3, n-type well region (n-well) 11-4, and p-type well region (p-well) 11-5 are formed.

The double well region is formed in a memory cell array portion, while the n-type well region 11-4 and p-type well region 11-5 are formed in the peripheral circuit portion.

The memory cell is formed in the p-type well region 11-3. The n-type well region 11-2 and p-type well region 11-3 are set to the same potential.

A high-voltage n-channel MOS transistor to which a voltage higher than a power voltage is applied is formed on the p-type substrate (p-sub) 11-1. The low-voltage p-channel MOS transistor to which a power voltage is applied is formed on the n-type well region (n-well) 11-4, and the low-voltage n-channel MOS transistor to which the power voltage is applied is formed on the p-type well region (p-well) 11-5.

A basic operation of the NAND cell type EEPROM device will next be described. First, to easily understand the following description, prerequisites are defined as follows. It is assumed that binary data “0”, “1” are stored in the memory cell, a state in which the threshold voltage of the memory cell is low (e.g., a negative state of the threshold voltage) is a “0” state, and a state in which the threshold voltage of the memory cell is high (e.g., a positive state of the threshold voltage) is a “1” state.

Usually, in the binary NAND cell type EEPROM device, the state in which the threshold voltage of the memory cell is low is regarded as the “1” state, and the state in which the threshold voltage of the memory cell is high is regarded as the “0” state. As described later, the present invention mainly relates to a multi-level (e.g., four-level) NAND type EEPROM device as described later. In consideration of this respect, as described above, the state in which the threshold voltage of the memory cell is low is regarded as the “0” state, and the state in which the threshold voltage of the memory cell is high is regarded as the “1” state.

Moreover, for the memory cell, the “0” state is regarded as an erase state, and the “1” state is regarded as a write state. The “write” state includes a “0” write and a “1” write. The “0” write indicates that the erase state (“0” state) is maintained, and the “1” write indicates that the “0” state changes to the “1” state.

Write Operation (Program Operation)

In the write operation, the potential of the bit line is set to a value in accordance with write data for the selected memory cell connected to the bit line. For example, the potential is set to a ground potential (0 V) Vss, when the write data is “1” (write “1”). The potential is set to a power potential Vcc, when the write data is “0” (write “0”).

The potential of the select gate line SG1 on a bit line side (drain side) in the selected block (i.e., NAND cell unit including the selected memory cell) is set to the power potential Vcc, and the potential of the select gate line SG2 on a source line side is set to the ground potential (0 V) Vss.

The potentials of two select gate lines SG1, SG2 in a unselected block (i.e., the NAND cell unit not including the selected memory cell) are both set to the ground potential (0 V) Vss.

Moreover, with the write “1”, the ground potential (0 V) Vss is transmitted to the channel of the selected memory cell in the selected block. On the other hand, with the write “0”, the potential of the channel of the selected memory cell in the selected block is set to Vcc-Vthsg (Vthsg indicates the threshold voltage of the select transistor S1). Thereafter, since the select transistor S1 on the bit line side (drain side) in the selected block is turned off, the channel of the selected memory cell in the selected block maintains a potential of Vcc-Vthsg, and is brought into an electrically floating state.

Additionally, when the selected memory cell is not a memory cell closest to the bit line, and the threshold voltage of the memory cell positioned on the bit line side from the selected memory cell (or at least one of a plurality of memory cells positioned on the bit line side from the selected memory cell) is a positive voltage Vthcell, the channel of the selected memory cell maintains the potential of Vcc-Vthcell, and is brought in the floating state.

Thereafter, a write potential (e.g., about 20 V) is applied to the selected word line in the selected block, that is, the control gate electrode of the selected memory cell, and an intermediate potential Vpass (e.g., about 10 V) is applied to the unselected word line in the selected block, that is, the control gate electrode of the unselected memory cell.

In this case, in the selected memory cell as an object of the write “1”, since the channel potential is the ground potential (0 V) Vss, a high voltage necessary for the write “1” is applied between the floating gate electrode and the channel (Cell p-well), and an electron moves to the floating gate electrode from the channel by a tunnel effect. As a result, the threshold voltage of the selected memory cell rises (e.g., moves to a positive value from a negative value).

On the other hand, in the selected memory cell as the object of the write “0”, the channel potential is Vcc-Vthsg or Vcc-Vthcell, and the channel has the floating state. Therefore, when Vpp or Vpass is applied to the word line, the potential of the channel rises by a capacity coupling between the control gate electrode and the channel. As a result, the high voltage necessary for the write “1” is not applied between the floating gate electrode and the channel (Cell p-well), and the threshold voltage of the selected memory cell maintains the present situation (i.e., maintains the erase state).

Erase Operation

The data is erased on a basis of one block, and the data of the memory cells in the selected block is erased substantially at the same time. A concrete erase operation is as follows. First, all the word lines (control gate electrodes) in the selected block are set to 0 V. Moreover, after all the word lines (control gate electrodes) in the unselected block and all the select gate lines in all the blocks are set to an initial potential Va, and then brought into a floating state.

Thereafter, a high potential VppE (e.g., about 20 V) for erasing the data is applied to the p-type well region (Cell p-well) and n-type well region (Cell n-well).

In this case, in the memory cells in the selected block, since the potential of the word line (control gate electrode) is 0 V and the potential of the well region is VppE, then a sufficiently high voltage for erasing the data is applied between the control gate electrode and the well region.

Therefore, in the memory cells in the selected block, the electrons in the floating gate electrodes move to the well region, and the threshold voltages of the memory cells drop by the tunnel effect (e.g., the threshold voltage becomes negative).

On the other hand, the potentials of all the word lines in the unselected block rise to VppE or to the vicinity of VppE from the initial potential Va by the capacity coupling of the word lines and well region. Similarly, the potentials of all the select gate lines in all the blocks rise to VppE or to the vicinity of VppE from the initial potential Va by the capacity coupling of the select gate lines and well region.

Therefore, a sufficient high voltage for erasing the data is not applied between the control gate electrodes and the well region in the memory cells in the unselected block. That is, since there is no movement of electrons in the floating gate electrode, the threshold voltages of the memory cells do not change (the present situation is maintained).

Read Operation

A data read operation is performed by changing the potentials of the bit lines in accordance with the data of the memory cells and detecting the change of the potentials of the bit lines. First, the bit lines connected to the memory cells as data read objects (all the bit lines, or some of the bit lines when a bit line shield read technique is used) are pre-charged, the bit lines are set to a pre-charge potential (e.g., the power potential Vcc), and brought into the floating state.

Thereafter, the selected word line, that is, the control gate electrode of the selected memory cell is set to 0 V, the unselected word line (the control gate electrode of the unselected memory cell) and select gate line are set to the power potential Vcc (e.g., about 3 V), and the source line is set to 0 V.

In this case, when the data of the selected memory cell is “1” (the threshold voltage Vth of the memory cell is Vth>0), the selected memory cell is brought into an off state, and the bit line connected to the memory cell therefore maintains the pre-charge potential (e.g., power potential Vcc).

On the other hand, when the data of the selected memory cell is “0” (the threshold voltage Vth of the memory cell is Vth<0), the selected memory cell is brought into an on state. As a result, a charge of the bit line connected to the selected memory cell is discharged, and the potential of the bit line drops from the pre-charge potential by ΔV.

Since the potential of the bit line changes in accordance with the data of the memory cell in this manner, the change is detected by a sense amplifier circuit, and the data of the memory cell can therefore be read.

Additionally, in recent years, development and practical use of a so-called multi-level NAND cell type EEPROM device in which information of three or more levels is stored in one memory cell have proceeded for a purpose of increasing the memory capacity of one chip and reducing the cost per bit.

In the above-described NAND cell type EEPROM device, the binary (one bit) data (“0”, “1”) can be stored in the memory cell. However, n-level NAND cell type EEPROM device (n is a natural number of 3 or more) is characterized in that n-level data can be stored in the memory cell.

For example, in the four-level NAND cell type EEPROM device, four-level (2 bit) data (“00”, “11”, “10”, “11”) can be stored in the memory cell. Known examples of the multi-level NAND cell type EEPROM device include Jpn. Pat. Appln. KOKAI Publication No. 1998-3792.

Usually, in the n-level NAND cell type EEPROM device, a plurality of latch circuits are provided for one bit connected to the selected memory cell. That is, when the n-level data is written or read with respect to the selected memory cell, the plurality of latch circuits temporarily store the n-level data.

For example, as described in Jpn. Pat. Appln. KOKAI Publication No. 1998-3792, in the four-level NAND cell type EEPROM device, two latch circuits are provided for one bit line connected to the selected memory cell, so that four-level (two bits) data is temporarily stored during write/read. This latch circuit is constituted of static RAM (SRAM) cells.

However, the latch circuit constituted of the SRAM cells has a large area. Furthermore, when the amount of data stored in one memory cell is increased (the value of n is increased), the number of latch circuits provided for one bit line connected to the memory cell also increases.

For example, in the four (=2²)-level NAND cell type EEPROM device, two latch circuits are provided for one bit line connected to the selected memory cell. In the eight (=2³)-level NAND cell type EEPROM device, three latch circuits are provided for one bit line connected to the selected memory cell.

Therefore, when the data stored in the memory cell is multi-level (n-level) and the value of n increases, then the number of latch circuits in a memory chip increases and thus a chip area disadvantageously increases.

In consideration of the above-described circumstances, the inventor of the present application has proposed that a data circuit connected to temporarily store write data or read data for each bit line of a multi-level memory, e.g. 4-level memory, is constituted of one latch circuit and dynamic RAM (DRAM) cells in a nonvolatile semiconductor described in Jpn. Pat. Appln. KOKAI Publication No. 2001-167590.

As well known, the area of the DRAM cell is smaller than the area of the SRAM cell, and thus according to Jpn. Pat. Appln. KOKAI Publication No. 2001-167590, the area of the data circuit can be reduced as compared with that of the conventional art.

However, even the constitution proposed as described above cannot necessarily sufficiently solve the problem that the number of elements in the data circuit increases and the chip area increases.

### BRIEF SUMMARY OF THE INVENTION

According to a first aspect of the present invention, there is provided a nonvolatile semiconductor memory device comprising a memory cell portion including at least one memory cell configured to store n levels (n is 3 or more); a bit line connected to one end of the memory cell portion; a data input/output circuit; and a data circuit which is connected to the bit line and the input/output circuit and configured to store write data or read data of 2 bits or more into or from the memory cell portion, in which, during a write operation, the write data inputted from the data input/output circuit is held in the data circuit and the read data read from the memory cell is held on the bit line.

According to a second aspect of the present invention, there is provided a nonvolatile semiconductor memory device comprising a memory cell portion including at least one memory cell configured to store n levels (n is 3 or more); a bit line connected to one end of the memory cell portion; a data input/output circuit; and a data circuit which is connected to the bit line and the input/output circuit and configured to store write data or read data of 2 bits or more into or from the memory cell portion, in which, during a write operation, the write data inputted from the data input/output circuit is held in the data circuit while a write voltage is supplied to the memory cell, and during a verify read operation in which it is checked whether the data is sufficiently written in the memory cell, the read data read from the memory cell is held on the bit line and the write data inputted from the data input/output circuit is held in the data circuit.

According to a third aspect of the present invention, there is provided a nonvolatile semi-conductor memory device comprising a memory cell portion including at least one memory cell configured to store n levels (n is 3 or more); a bit line connected to one end of the memory cell portion; a data input/output circuit; and a data circuit which is connected to the bit line and the input/output circuit and configured to store write data or read data of 2 bits or more into or from the memory cell portion, in which, during a write operation, the read data read from the memory cell is held in the data circuit only in a predetermined period of a verify read operation in which it is checked whether the data is sufficiently written in the memory cell.

According to a fourth aspect of the present invention, there is provided a nonvolatile semi-conductor memory device comprising a memory cell portion including at least one memory cell configured to store n levels (n is 3 or more); a bit line connected to one end of the memory cell portion; a data input/output circuit; and a data circuit having a latch circuit and a capacitor, which is connected to the bit line and the input/output circuit and configured to store write data or read data of 2 bits or more into or from the memory cell portion, in which, in a verify read operation in which it is checked whether the data is sufficiently written in the memory cell in a write operation, the read data read from the memory cell is stored in the latch circuit during a predetermined period of the verify read operation, and the write data inputted from the data input/output circuit during predetermined period of the verify read operation is held in the capacitor.

According to a fifth aspect of the present invention, there is provided a nonvolatile semi-conductor memory device comprising a memory cell portion including a memory cell configured to store n levels (n is 3 or more); a bit line connected to one end of the memory cell portion; a data input/output circuit; and a data circuit having a latch circuit, which is connected to the bit line and the input/output circuit and configured to store write data or read data of 2 bits or more into or from the memory cell portion, in which, a write operation to the memory cell is performed based on the data inputted from the data input/output circuit and stored in the latch circuit and on the data read from the memory cell and held on the bit line.

According to a sixth aspect of the present invention, there is provided a nonvolatile semi-conductor memory device comprising a memory cell portion including a memory cell configured to store n levels (n is 3 or more); a bit line connected to one end of the memory cell portion; a data input/output circuit; and a data circuit having a latch circuit, which is connected to the bit line and the input/output circuit and configured to store write data or read data into or from the memory cell portion, in which the memory cell contains a first data selected by a first address and a second data selected by a second address, and a write operation to the memory cell is performed based on the first data stored in the latch circuit and inputted from the data input/output circuit in a first write operation in which the first address is selected, and a write operation to the memory cell is performed based on the second data inputted from the data input/output circuit and stored in the latch circuit and on the first data read from the memory cell and held on the bit line in a second write operation in which the second address is selected.

According to a seventh aspect of the present invention, there is provided a nonvolatile semi-conductor memory device comprising a memory cell portion including a memory cell configured to store n levels having a first threshold level in a “1” state, a second threshold level in a “2” state, a third threshold level in a “3” state, and an i-th threshold level in an “i” state (i is a natural number of n or less, and n is a natural number of 3 or more); a bit line connected to one end of the memory cell portion; a data input/output circuit; and a data circuit having a latch circuit, which is connected to the bit line and the input/output circuit and configured to store write data or read data of into or from the memory cell portion, in which the memory cell contains a first data selected by a first row address and a second data selected by a second row address, and a write operation to the memory cell is performed to set the memory cell to a “1”, “2”, . . . “m−1”, or “m” state (m is a natural number) based on the first data stored in the latch circuit and inputted from the data input/output circuit in a first write operation in which the first row address is selected, and a write operation to the memory cell is performed to set the memory cell to a “1”, “2”, . . . “k−1”, or “k” state (k is a natural number larger than m) based on the second data inputted from the data input/output circuit and stored in the latch circuit and on the first data read from the memory cell and held on the bit line in a second write operation in which the row second address is selected.

### BRIEF DESCRIPTION OF THE SEVERAL VIEWS OF THE DRAWING

FIG. 1 is a diagram showing an outline of a multileveled NAND cell type EEPROM device according to the present invention.

FIG. 2 is a diagram showing a data circuit in a memory of FIG. 1.

FIG. 3 is a diagram showing a memory cell array in the memory of FIG. 1.

FIG. 4 is a diagram showing a part of a column decoder in the memory of FIG. 1.

FIG. 5 is a diagram showing a collective detection circuit in the memory of FIG. 1.

FIG. 6 is a diagram showing a word line control circuit in the memory of FIG. 1.

FIG. 7 is a diagram showing a device structure in a first memory cell block of FIG. 6.

FIG. 8 is a diagram showing a device structure in a second memory cell block of FIG. 6.

FIG. 9 is a diagram showing a row address decoder RADD1 of FIG. 6.

FIG. 10 is a diagram showing a word line driver RMAIN1 of FIG. 6.

FIG. 11 is a diagram showing a row address decoder RADD2 of FIG. 6.

FIG. 12 is a diagram showing a word line driver RMAIN2 of FIG. 6.

FIG. 13 is a diagram showing a relation between four-level data and a threshold voltage of the memory cell.

FIG. 14 is a diagram showing a threshold voltage distribution of the memory cell after the writing of even-numbered page data.

FIG. 15 is a diagram showing the threshold voltage distribution of the memory cell after the writing of odd-numbered page data.

FIG. 16 is a waveform diagram showing an operation timing concerning the reading of the even-numbered page data.

FIG. 17 is a waveform diagram showing the operation timing concerning the reading of the odd-numbered page data.

FIG. 18 is a waveform diagram showing the operation timing concerning the reading of the odd-numbered page data.

FIG. 19 is a flowchart showing a series of a read operation of the even-numbered page data.

FIG. 20 is a waveform diagram showing the operation timing concerning program pulse application during the write operation.

FIG. 21 is a waveform diagram showing the operation timing concerning “01” verify read during the write operation.

FIG. 22 is a waveform diagram showing the operation timing concerning “Program Completion Detection” during the write operation.

FIG. 23 is a flowchart showing a series of write operation of the odd-numbered page data.

FIG. 24 is a waveform diagram showing the operation timing concerning “10A” verify read during the write operation.

FIG. 25 is a waveform diagram showing the operation timing concerning “00” verify read during the write operation.

FIG. 26 is a waveform diagram showing the operation timing concerning an erase pulse application during an erase operation.

FIG. 27 is a waveform diagram showing the operation timing concerning an erase verify read during the erase operation.

FIG. 28 is a waveform diagram showing the operation timing concerning “Erase Completion Detection” during the erase operation.

FIG. 29 is a circuit diagram showing a memory cell array of a NAND cell type EEPROM device.

FIG. 30 is a plan view showing a device structure of a NAND cell unit.

FIG. 31A shows a sectional view taken along lines XXXIA-XXXIA.

FIG. 31B shows a sectional view taken along lines XXXIB-XXXIB.

FIG. 32 is a diagram showing an equivalent circuit of the NAND cell unit of FIG. 30.

FIG. 33 is a diagram showing a well structure of the NAND cell type EEPROM device.

### EMBODIMENTS OF THE INVENTION

Nonvolatile semiconductor memory devices according to embodiments of the present invention will be described hereinafter in detail with reference to the drawings.

In the following embodiment, a four-level NAND cell type EEPROM device will be described as a representative embodiment. However, the present invention is not limited to the four-level NAND cell type EEPROM device, and is applicable to a nonvolatile semiconductor memory device in which n-level data (n is a natural number of 3 or more) is stored in a memory cell.

Four-level data “00”, “01”, “10”, “11” are stored in the memory cell, a state in which the threshold voltage of the memory cell is lowest (e.g., a negative state of the threshold voltage) is regarded as data “11” (or a “0” state), a state in which the threshold voltage of the memory cell is second low (e.g., a positive state of the threshold voltage) is regarded as data “10” (or a “1” state), a state in which the threshold voltage of the memory cell is third low (e.g., a positive state of the threshold voltage) is regarded as data “01” (or a state “2”), and a state in which the threshold voltage of the memory cell is highest (e.g., a positive state of the threshold voltage) is regarded as data “00” (or a state “3”).

Moreover, since the four-level data is stored in the memory cell, a write/read operation of odd-numbered page data and a write/read operation of even-numbered page data are necessary. Here, in 2-bit data “**”, the left * indicates the even-numbered page data and the right * indicates the odd-numbered page data.

Furthermore, for the memory cell, a state in which data “11” is stored is regarded as an erase state, and a state in which data “10”, “01”, “00” are stored is regarded as a write state.

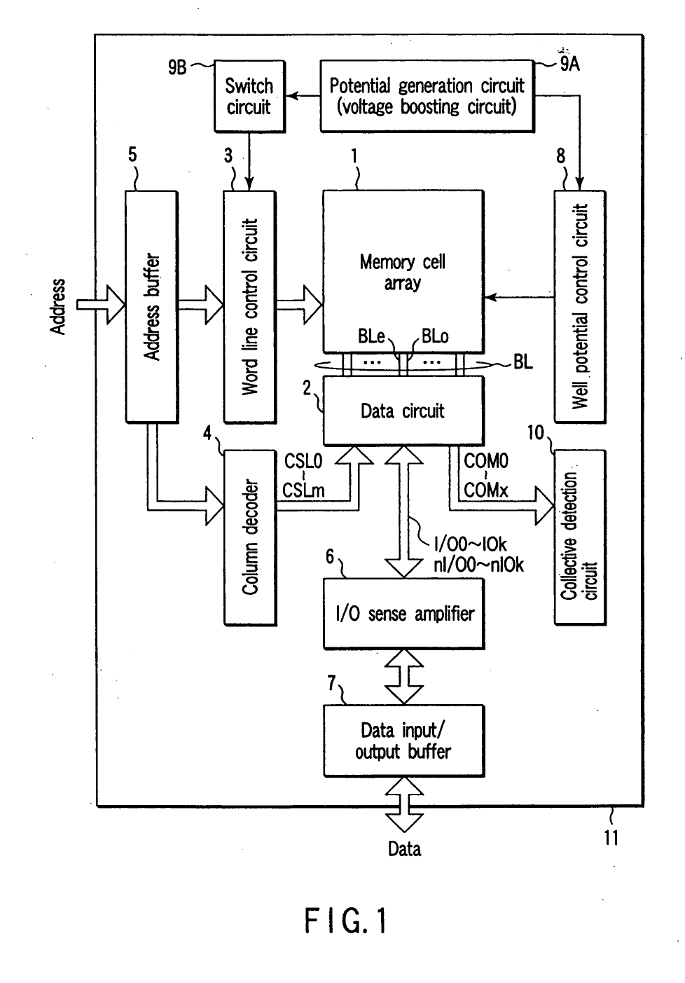

FIG. 1 is a block diagram showing a main part of a four-level NAND cell type EEPROM device according to embodiments of the present invention.

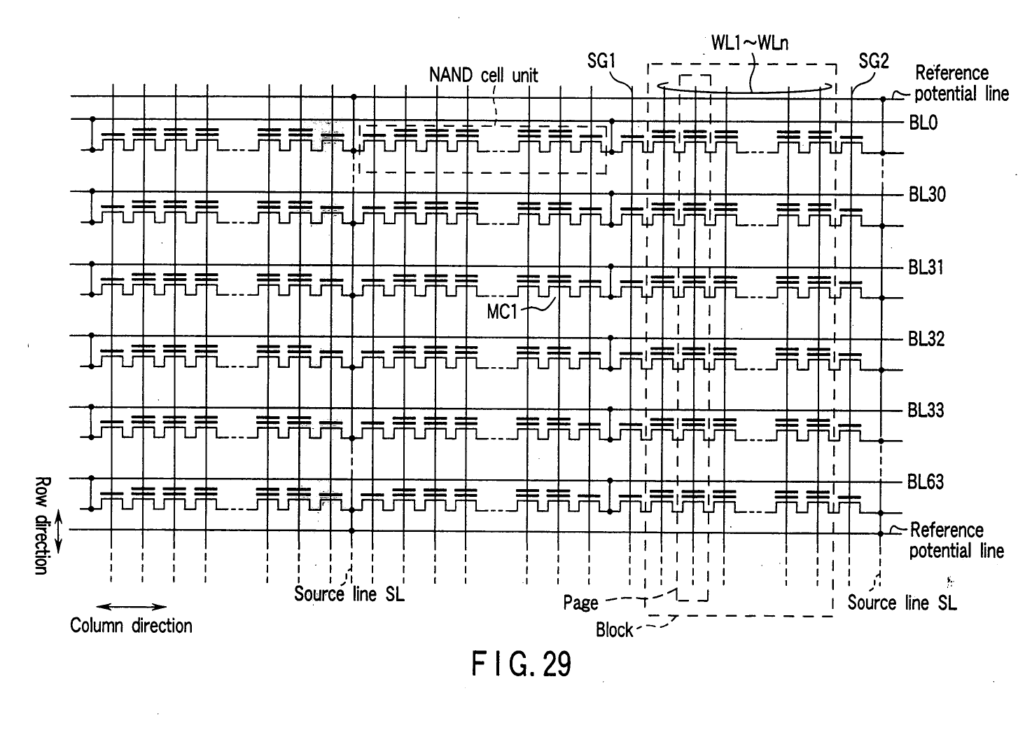

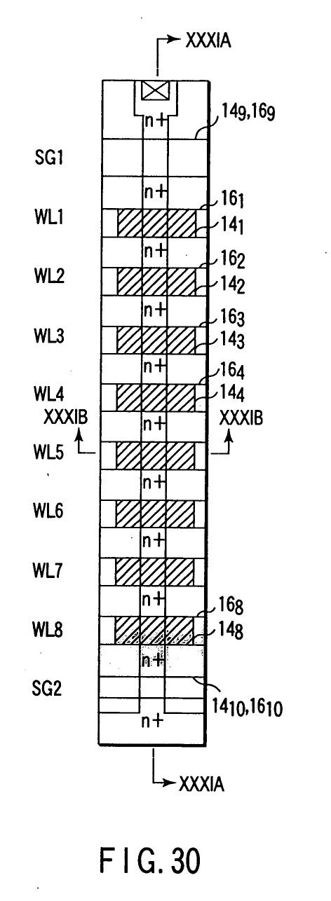

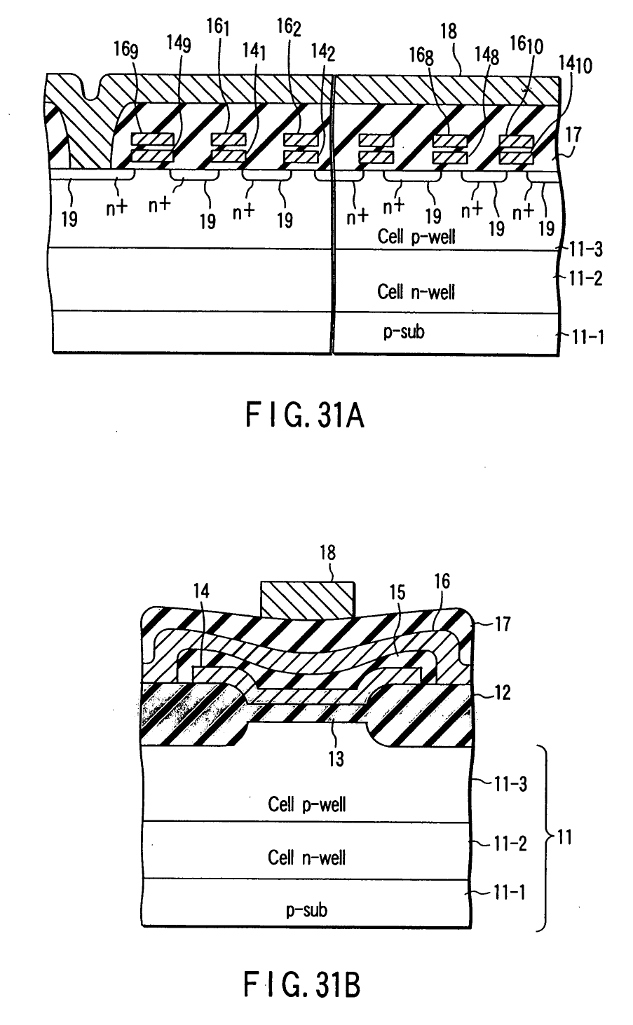

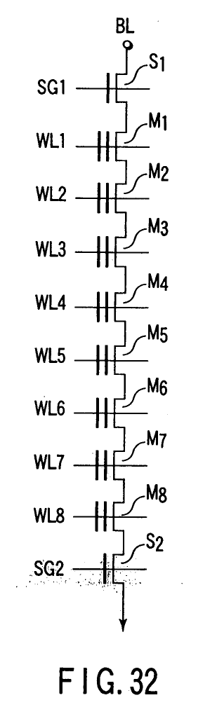

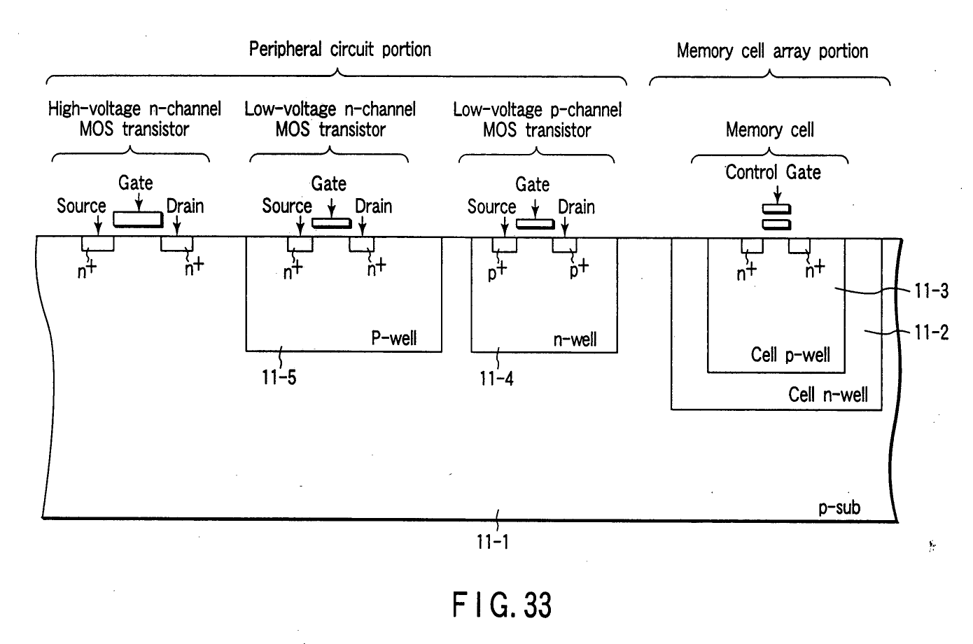

Reference numeral 1 denotes a memory cell array. The memory cell array 1 has a NAND cell unit constituted of a plurality of memory cells connected in series connected to one another and two select transistors connected to ends of the series-connected memory cells. A concrete structure of the memory cell array 1 is shown in FIGS. 29 to 32.

The structure and equivalent circuit of the memory cell array 1 are substantially the same as those of a binary NAND cell type EEPROM device, however the four-level data is stored in the memory cell in the four-level NAND cell type EEPROM device.

A data circuit 2 includes a storage circuit in which 2-bits (four-level) write data to the memory cell is temporarily stored during writing, and 2-bits (four-level) read data from the memory cell is temporarily stored during reading.

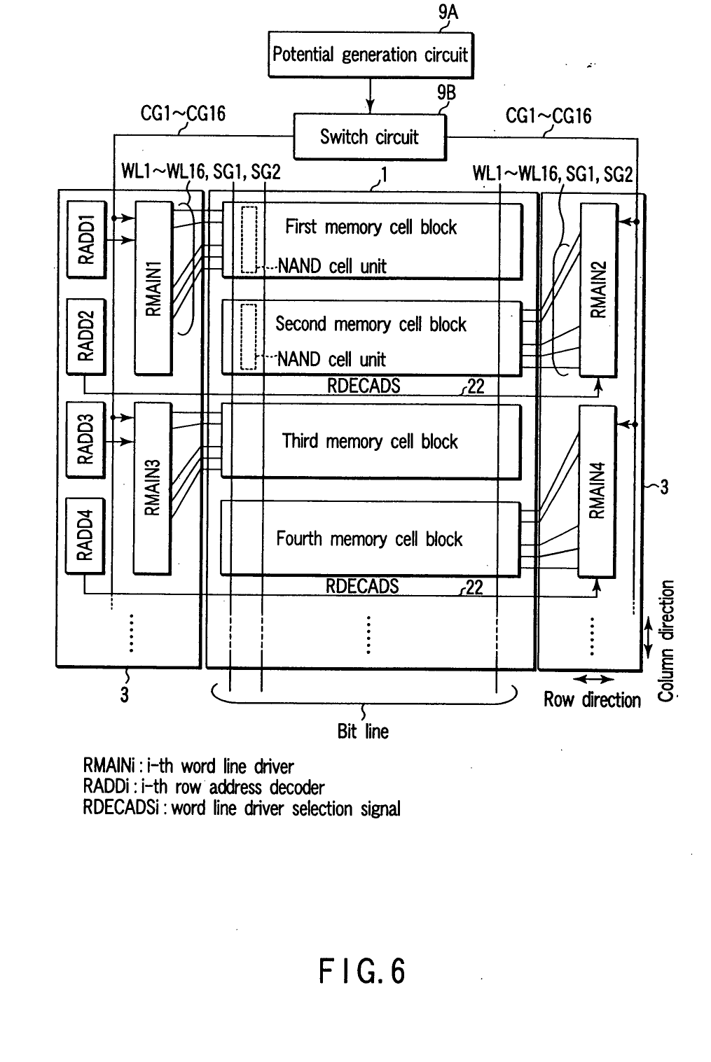

A word line control circuit 3 includes a row address decoder and word line drivers, and has a layout in which the row address decoder is disposed only on one side of the memory cell array 1 and the word line drivers are disposed on opposite sides of the memory cell array 1. The word line control circuit 3 will be described later with reference to FIG. 6.

The word line control circuit 3 controls the potential of each word line in the memory cell array 1 based on an operation mode (write, erase, read, and the like) or a row address signal. In this case, a signal line connecting the row address decoder on one side to the word line driver on the other side of the memory cell array 1 is provided on the memory cell array 1.

A column decoder 4 selects a column of the memory cell array 1 based on a column address signal. During the writing, input data is inputted into the storage circuit in the data circuit belonging to the selected column via a data input/output buffer 7 and I/O sense amplifier 6. Moreover, during the reading, output data of the storage circuit in the data circuit belonging to the selected column is outputted to the outside of a memory chip 11 via the I/O sense amplifier 6 and data input/output buffer 7.

The row address signal is inputted into the word line control circuit 3 via an address buffer 5. The column address signal is inputted into the column decoder 4 via the address buffer 5.

A well potential control circuit 8 controls the potential of a cell well region (e.g., a double well region constituted of an n well and p well) in which the memory cells are arranged based on the operation mode (write, erase, read, and the like). In the present embodiment, the cell P well and cell N well are biased to the same potential.

A potential generation circuit (boosting circuit) 9A generates a write potential (e.g., about 20 V) Vpp and transfer potential (e.g., about 10 V) Vpass, for example, during the writing. These potentials Vpp, Vpass are selectively supplied to a plurality of word lines, for example, in the selected block via a switch circuit 9B.

Moreover, the potential generation circuit 9A generates an erase potential (e.g., about 20 V) VppE, for example, during erasing, and the potential VppE is given to the cell well region (including both the n well and p well) in which the memory cells are arranged.

A collective detection circuit 10 verifies whether or not predetermined data is sufficiently written in the memory cell during the writing, and verifies whether or not the data of the memory cell is sufficiently erased during the erasing.

The data circuit 2 will briefly be described now, and described later in detail. The data circuit 2 includes one latch circuit (e.g., SRAM cell) connected to one bit line connected to the selected memory cell, and one capacitor for temporarily storing the data of the latch circuit. In this constitution, a chip area can be reduced as compared with a constitution in which two capacitors are used per one latch circuit.

During the write operation, the data read from the memory cell is held in the bit line, and the write data inputted from the outside is held in the latch circuit. That is, during the write operation, when a write voltage is applied to the memory cell, the write data inputted from the outside is held in the latch circuit. During a verify read operation for checking whether the data is sufficiently written in the memory cell, the data read from the memory cell is held on the bit line, and the write data inputted from the outside is held in the latch circuit. Additionally, the data read from the memory cell is held on the bit line as a bit line pre-charge potential during the verify reading.

Moreover, the data read from the memory cell during the write operation is held in the latch circuit only in a predetermined period of the verify read operation for checking whether the data is sufficiently written in the memory cell (held as the bit line pre-charge potential on the bit line during periods other than the predetermined period).

Furthermore, the data read from the memory cell in the verify read operation for checking whether the data is sufficiently written in the memory cell during the write operation is stored in the latch circuit in the predetermined period of the verify read odd-numbered page data for checking whether the data is sufficiently written in the memory cell. In the predetermined period, the write data inputted from the outside is held in the capacitor.

The constitution and operation of the four-level NAND cell type EEPROM device according to the present embodiment will be described hereinafter in detail.

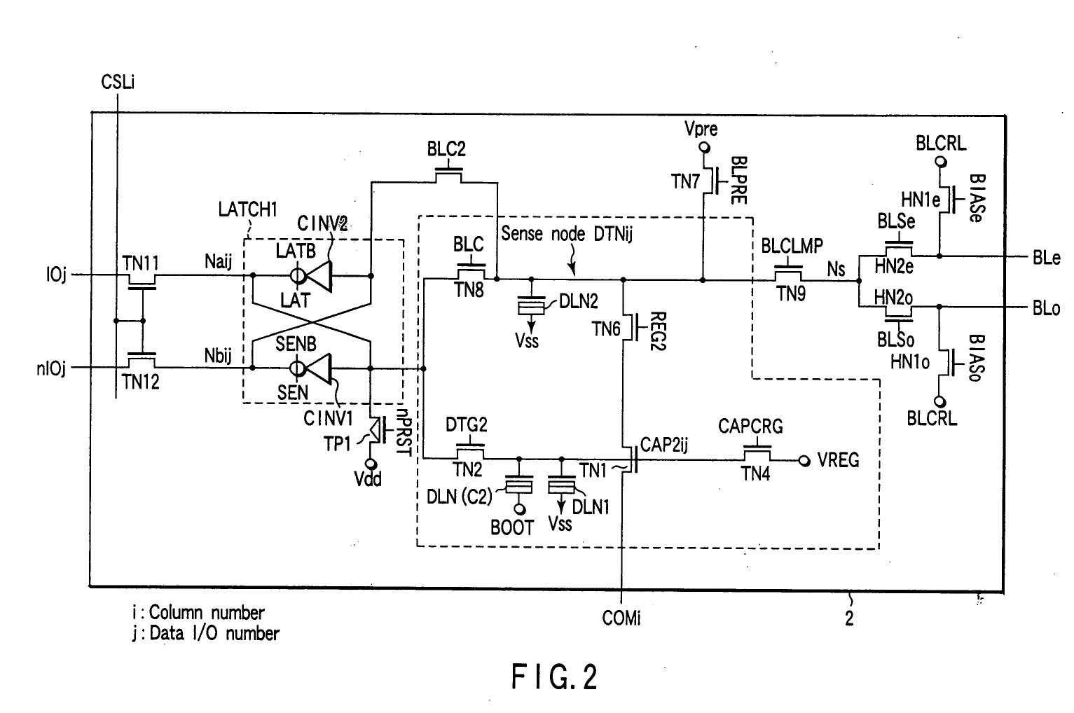

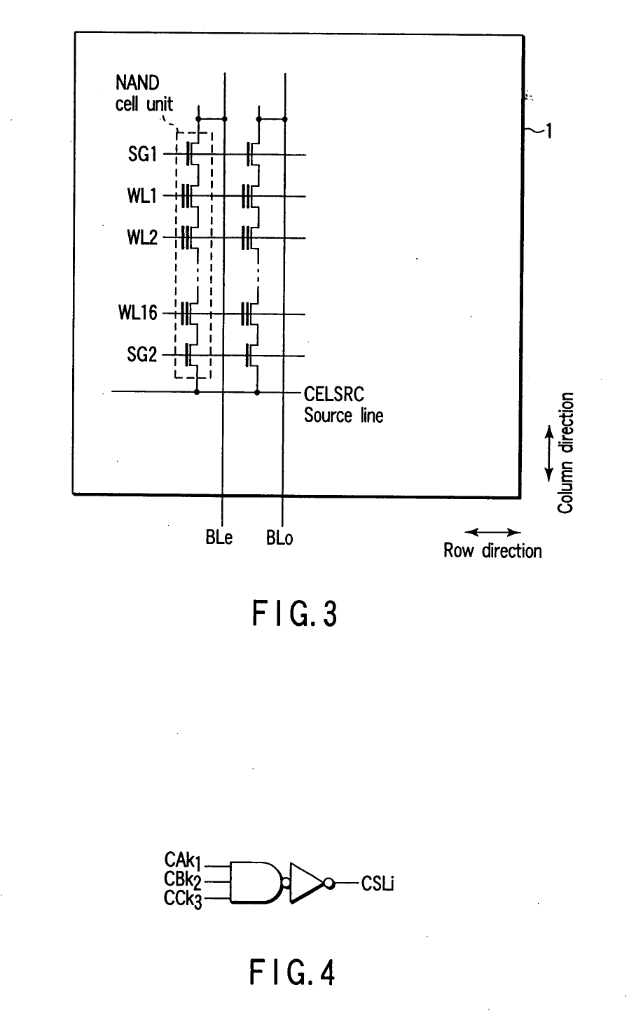

FIG. 2 shows one example of the data circuit 2 of FIG. 1. FIG. 3 shows a part of the memory cell array 1 of FIG. 2. In this example, the data circuit for only one column is shown. In actual, one data circuit is provided for each of a plurality of columns of the memory cell array 1. That is, the data circuit 2 of FIG. 1 is constituted of a plurality of data circuits for a plurality of columns of the memory cell array 1.

Moreover, in the present example, two bit lines BLe, BLo are arranged in one column. The two bit lines BLe, BLo are connected to one data circuit. A reason why two bit lines BLe, BLo are connected to one data circuit in this manner is to achieve the advantages such as (a) to prevent a noise from being caused between the bit lines disposed adjacent to each other by capacity coupling during the reading, and (b) to decrease the number of data circuits, and reduce the chip area.

Furthermore, it is assumed in the present example to store the four-level data (2-bits data) in one memory cell. Therefore, for example, a latch circuit LATCH is provided as a storage circuit for temporarily storing the four-level data during the writing/reading in one data circuit.

The latch circuit LATCH is constituted of a flip-flop circuit (SRAM cell) constituted of clocked inverters CINV1, CINV2. The latch circuit LATCH is controlled by control signals SEN, SENB, LAT, LATB.

Additionally, signal “***B” means a reversed signal of a signal “***”. That is, a level of the signal “***B” has a phase reverse to that of the level of the signal “***” (when one is “H”, the other is “L”). The same also applies to the following.

Moreover, in FIG. 2, a MOS transistor with a symbol “HN**” (* denotes a number, alphabet, or the like) attached thereto is, for example, a high-voltage enhancement N-channel MOS transistor which has a threshold voltage of about 0.6 V. A voltage higher than a power voltage Vcc is applied to the MOS transistor. The MOS transistor has an off state, when a gate indicates 0 V.

Furthermore, a MOS transistor with a symbol “DLN**” attached thereto is, for example, a low-voltage depression N-channel MOS transistor which has a threshold voltage of about −1 V. The voltage not more than the power voltage Vcc is applied to the transistor. In the present example, the transistor is used as a MOS capacitor.

Additionally, a MOS transistor with a symbol “TN**” attached thereto is, for example, a low-voltage enhancement N-channel MOS transistor which has a threshold voltage of about 0.6 V. The voltage not more than the power voltage Vcc is applied to the transistor. The transistor has an off state, when the gate indicates 0 V.

MOS transistors HN1e, HN1o, HN2e, HN2o have a function of using one of two bit lines BLe, BLo as the bit line from which the data is read, and using the remaining one line as a shield bit line during the reading.

That is, BLCRL is set to the ground potential Vss. Moreover, when BIASo is “H”, and BIASe is “L”, the data is read in the bit line BLe, and the bit line BLo functions as the shield bit line for preventing a noise during the reading of the data in the bit line BLe.

On the other hand, when BIASe is “H”, and BIASo is “L”, the data is read in the bit line BLo, and the bit line BLe functions as the shield bit line for preventing the noise during the reading of the data in the bit line BLo.

A MOS transistor TN7 is a MOS transistor for pre-charging the bit line so that one of two bit lines BLe, BLo, with the data read therefrom, is set, for example, to a pre-charge power potential Vpre. The MOS transistor TN7 is controlled by a control signal BLPRE.

A MOS transistor TN9 is a MOS transistor for clamping, which controls electric connection and disconnection of the bit lines BLe, BLo and data circuit (main part). The MOS transistor TN9 operates to retain the bit lines BLe, BLo in the floating state, until the data read in the bit lines BLe, BLo is sensed after the bit lines BLe, BLo are pre-charged. The MOS transistor TN9 is controlled by a control signal BLCLMP.

The MOS transistors TN1, TN2, TN4, TN6, TN8 are provided to control the odd-numbered/even-numbered page data during the writing/reading (or the verify reading), and check whether or not the data is sufficiently written/erased with respect to all the selected memory cells after the verify reading during the writing/erasing (Program/Erase completion detection). Additionally, an output signal COMi is used during the program/erase completion detection.

A MOS transistor TP1 is a preset transistor, which presets a sense node DTNij to Vdd. The MOS transistor TP1 is controlled by the control signal nPRST.

A switching MOS transistor TN5 is inserted between an output node Naij of the latch circuit LATCH and the sense node DTNij. The MOS transistor TN5 is controlled by a control signal BCL2.

The MOS transistors TN11, TN12 function as column switches for determining electric connection and disconnection of two output nodes Naij, Nbij of the latch circuit LATCH and input/output lines IOj, nIOj. When a column selection signal CSLi indicates “H”, the MOS transistors TN11, TN12 are in the on state, and the output nodes Naij, Nbij of the latch circuit are electrically connected to the input/output lines IOj, nIOj.

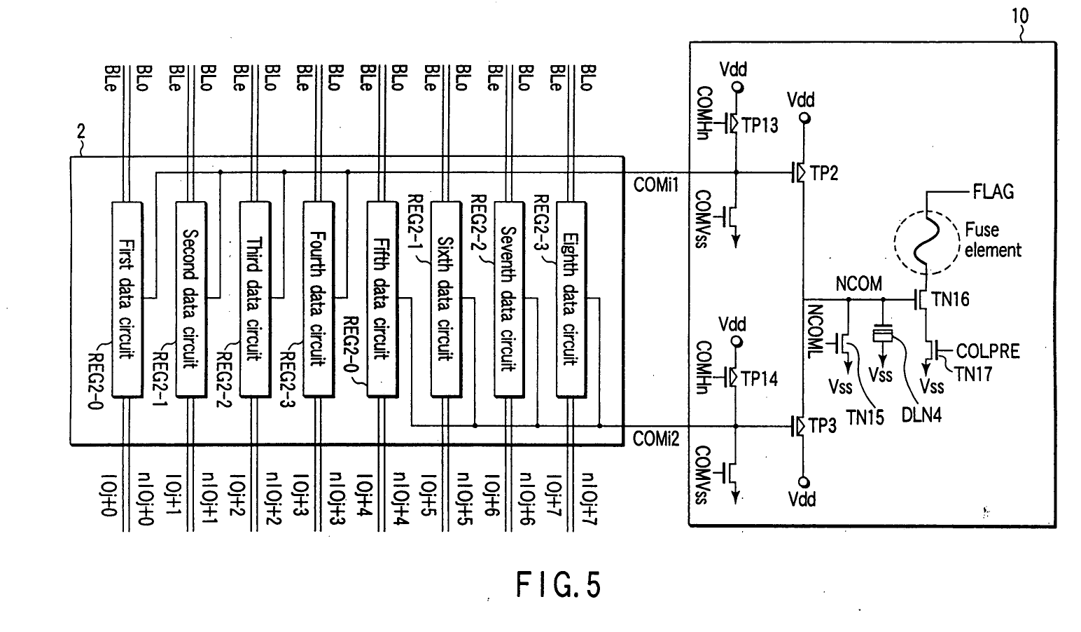

The column selection signal CSLi is outputted from the column decoder 4 of FIG. 1. For example, as shown in FIG. 4, the column decoder is constituted of an AND circuit. That is, for example, when CAKk, CBk2, CCk3 indicate “H”, the column selection signal CSLi indicates “H”.

Additionally, in FIG. 2, Vdd (e.g., about 2.3 V) is an in-chip power potential which is lower than an external power potential Vcc. The in-chip power potential Vdd is generated from the external power potential Vcc by a down-converter circuit. Additionally, instead of the in-chip power potential Vdd, the external power potential Vcc may be supplied to the data circuit.

FIG. 5 shows a main part of the collective detection circuit 10 of FIG. 1. The collective detection circuit 10 checks whether or not the data is sufficiently written/erased with respect to all the selected memory cells after the verify read operation (Program/Erase completion detection).

First to eighth data circuits are provided for eight input/output pins (I/O pins) inputted from the outside and have a structure shown in FIG. 2.

REG2-k (k=0, 1, 2, 3) corresponds to REG2 (FIG. 2) in the k+1-th and k+5-th data circuits. That is, REG2 in the first and fifth data circuits is controlled by REG2-0. REG2 in the second and sixth data circuits is controlled by REG2-1. REG2 in the third and seventh data circuits is controlled by REG2-2. REG2 in the fourth and eighth data circuits is controlled by REG2-3.

The output nodes COMi of the first to fourth data circuits are connected in common, and the common-connected node COMi1 is connected to the gate of a P-channel MOS transistor TP2.

Similarly, the output nodes COMi of the fifth to eighth data circuits are connected in common, and the common-connected node COMi2 is connected to the gate of a P-channel MOS transistor TP3.

P-channel MOS transistors TP13, TP14 operates to set nodes COMi1, COMi2 to the in-chip power potential Vdd, and subsequently retain the nodes in the floating state during the program/erase completion detection. The MOS transistors TN13, TN14 are controlled by a control signal COMHn.

An N-channel MOS transistor TP15 operates to set node NCOM to the ground potential Vss, and subsequently retain the node in the floating state during the program/erase completion detection. The MOS transistor TN15 is controlled by a control signal NCOML.

In the data circuit for the memory cell in which the data is not sufficiently written/erased during the program/erase completion detection, a potential level of COMi (see FIG. 2) drops to “L” from “H”. Therefore, the node NCOM drops to “H” from “L”, and FLAG indicates “L”.

On the other hand, when the data is sufficiently written/erased with respect to all the memory cells, the potential levels of the output signals COMi (see FIG. 2) of all the data circuits maintain “H”. Therefore, the node NCOM still indicates “L”, and FLAG indicates “H”.

When the potential level of the node FLAG is detected in this manner, it can be checked whether or not the data is sufficiently written/erased with respect to all the selected memory cells. Additionally, an operation for the program/erase completion detection will be described later in detail.

In this example, eight data circuits are connected into one, the voltage level of a node FLAG is detected, and it is checked whether or not the data is sufficiently written/erased with respect to the memory cells of eight columns for the eight data circuits.

The eight data circuits are connected into one in this manner, because the memory cells are replaced by a redundancy circuit (not shown) by a unit of eight columns for these eight data circuits. That is, when a fuse element (a portion surrounded with a broken line) is disconnected, the memory cells connected to these eight data circuits are constantly in an unselected state, and spare memory cells of a redundancy region are selected instead.

Therefore, when the memory cells are replaced by the redundancy circuit by a unit of n columns for n data circuits (n is a natural number), n data circuits are connected into one.

Additionally, FLAG is a common node corresponding to all the columns. For example, when the number of columns is 2048, and eight data circuits (columns) are used as one unit of redundancy replacement, 256 circuits shown in FIG. 5 are present in the chip. Moreover, these 256 circuits are connected to the common node FLAG.

FIG. 6 shows a concrete example of the word line control circuit 3 of FIG. 1. The memory cell array 1 is constituted of a plurality of memory cell blocks arranged in a column direction. Each memory cell block has a plurality of NAND cell units arranged in a row direction. Concrete examples of the memory cell array and NAND cell unit are shown in FIGS. 29 to 32.

In this example, one row address decoder and one word line driver are provided for one memory cell block.

For example, word lines WL1, . . . WL16 and select gate lines SG1, SG2 in a first memory cell block are connected to a first word line driver RMAIN1, and the first word line driver RMAIN1 receives an output signal (decode result) of a first row address decoder RADD1 for determining whether the first memory cell block is selected/unselected.

In this manner, the word lines WL1, . . . WL16 and select gate lines SG1, SG2 in the i-th (i=1, 2, . . . ) memory cell block are connected to the i-th word line driver RMAINi, and the i-th word line driver RMAINi receives the output signal (decode result) of the i-th row address decoder RADDi for determining whether the i-th memory cell block is selected/unselected.

The word line drivers are disposed on opposite sides (two ends of the row direction) of the memory cell array 1.

Concretely, the word line drivers RMAIN1, RMAIN3, . . . corresponding to the odd-numbered memory cell block are disposed on one (left side) of two ends of the row direction of the memory cell array 1, and the word line drivers RMAIN2, RMAIN4, . . . corresponding to the even-numbered memory cell block are disposed on the other one (right side) of two ends of the row direction of the memory cell array 1.

When the word line drivers RMAINi are disposed on the opposite ends of the memory cell array 1 in this manner, the word line driver RMAINi can easily be designed (or the degree of freedom of a layout can be increased). That is, in this example, one word line driver can secure a layout space for two memory cell blocks in the column direction.

Moreover, the word lines WL1, . . . WL16 and select gate lines SG1, SG2 in one memory cell block are constantly driven from one side (or the other side) of the memory cell array 1 by the word line driver corresponding to the memory cell block. Therefore, a deviation is not generated in a timing in which a driving signal is supplied with respect to the memory cell and select transistor in one predetermined NAND cell unit in the selected block.

On the other hand, the row address decoder RADDi (I=1, 2 . . . ) is disposed only on one of two ends (one side) of the row direction of the memory cell array 1. In this case, a signal line (address bus) for supplying a row address signal to the row address decoder RADDi may be disposed only one side of the memory cell array 1, so that the area of the address bus can be reduced. As a result, this can contribute to the reduction of the chip area.

That is, similarly to the word line drivers RMAINi, if the row address decoders RADDi are disposed on two ends of the row direction of the memory cell array 1, the address buses have to be also disposed on two ends of the row direction of the memory cell array 1. This is disadvantageous for the reduction of the chip area.

In this example, the row address decoder RADDi is disposed only on one of two ends (one side) of the row direction of the memory cell array 1, then a signal line 22 is provided on the memory cell array 1. The signal line 22 is used to supply output signals (decode results) RDECADS of the row address decoders RADD2, RADD4, . . . corresponding to the even-numbered memory cell array block to the word line drivers RMAIN2, RMAIN4, . . .

The signal RDECADS is transmitted through the signal line 22 during a normal operation. Therefore, during the normal operation, it is necessary to prevent the potential of the signal line 22 from aversely affecting the operation of the memory cell. Then, the row address decoder RADDi and word line driver RMAINi are constituted such that the potential of the signal line 22 does not adversely affect the operation of the memory cell. The row address decoder RADDi and word line driver RMAINi will be described later in detail.

The potential generation circuit 9A has a voltage boosting circuit (charge pump circuit), and generates, for example, the write potential Vpp for use in the writing and the transfer potential Vpass. The potential generation circuit 9A is connected to the switch circuit 9B. The switch circuit 9B operates to selectively supply the potentials such as the write potential Vpp, transfer potential Vpass, in-chip power potential Vdd, and ground potential Vss to signal lines CG1, . . . CG16 corresponding to the word lines WL1, . . . WL16.

The signal lines CG1, . . . CG16 are connected to the word line driver RMAINi. That is, the signal lines CG1, . . . CG16 are connected to the word lines WL1, . . . WL16 via transistors for transferring the potential HNt1, HNt2, . . . HNt16 (described later) in the word line driver RMAINi.

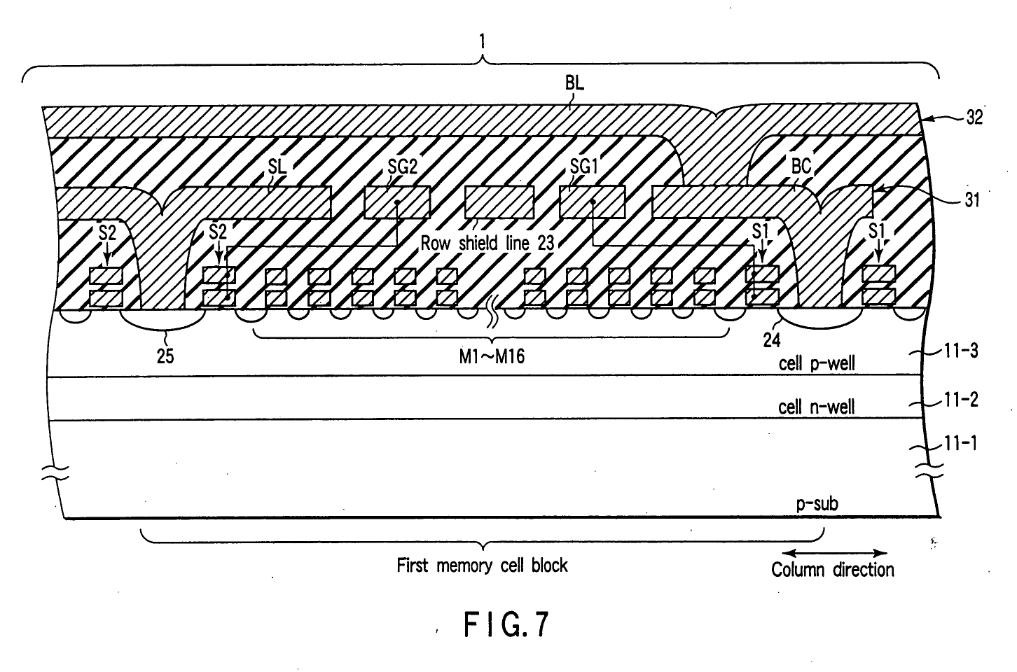

FIG. 7 shows a cross section of the column direction of the odd-numbered memory cell block in FIG. 6. In the odd-numbered memory cell block, since the row address decoders RADD1, RADD3, . . . and word line drivers RMAIN1, RMAIN3, . . . are disposed on the same side of the memory cell array 1, the signal lines for connecting the row address decoders RADD1, RADD3, . . . and word line drivers RMAIN1, RMAIN3, . . . are not provided on the memory cell array 1.

A concrete structure will be described hereinafter. In a p-type silicon substrate 11-1, the double region constituted of a n-type well region 11-2 and p-type well region 11-3 is formed. For example, 16 memory cells M1, . . . M16 connected in series are formed on the p-type well region 11-3. Each memory cell is constituted of the N-channel MOS transistor, and has a stack gate structure constituted of the floating gate electrode and control gate electrode. Two ends of the memory cells M1, . . . M16 connected in series are connected to select transistors S1, S2. The select transistors S1, S2 are constituted of N-channel MOS transistors. For example, a diffusion layer (drain) 24 of the select transistor S1 on the bit line side is connected to a metal wiring BC in a first wiring layer 31, and a diffusion layer (source) 25 of the select transistor S2 on the source line side is connected to a source line SL in the first wiring layer 31.

A gate electrode (select gate line (polysilicon)) of the select transistor S1 is connected to the metal wiring SG1 in the first wiring layer 31 so as to reduce a wiring resistance of the select gate line. A contact portion of the select gate line (polysilicon) and metal wiring SG1 is provided in respective intersections of the select gate line with 528 bit lines.

Similarly, the gate electrode (select gate line (polysilicon)) of the select transistor S2 is connected to the metal wiring SG2 in the first wiring layer 31 so as to reduce the wiring resistance of the select gate line. The contact portion of the select gate line (polysilicon) and metal wiring SG2 is provided in respective intersections of the select gate line with 528 bit lines.

The bit line BL is provided in the second wiring layer 32 provided on the first wiring layer 31. The bit line BL extends in the column direction, and is connected to the diffusion layer (drain) 24 of the select transistor S1 via the metal wiring BC in the first wiring layer 31. Additionally, each signal line in the first and second wiring layers 31, 32 is constituted of aluminum, copper, or an alloy of these metals.

A row shield line 23 is provided between the metal wirings SG1, SG2 on the memory cells M1, . . . M16. The row shield line 23 is provided to prevent a so-called coupling noise during the writing/reading and to sufficiently raise the potential of the unselected word line during the erasing. The row shield line 23 is usually set to the same potential as the potential of the double well regions (cell well) 11-2, 11-3.

During the writing/reading, the cell well potential is usually set to the ground potential Vss. Therefore, the row shield line 23 is also fixed to the ground potential Vss. In this case, since a capacity coupling between the bit line BL and the word line WL is substantially eliminated, the coupling noise can be prevented from being generated with respect to data transmitted through the bit line.

Moreover, during the writing/reading, the select gate lines (metal wirings) SG1, SG2 in the unselected block are set to the ground potential Vss. Therefore, the select gate lines (metal wirings) SG1, SG2 also functions as the shield line in the writing/reading.

As described above, during the writing/reading, the row shield line 23 and select gate lines (metal wirings) SG1, SG2 in the unselected block are set to the ground potential Vss, and thereby the capacity coupling between the bit line BL and the word line WL is reduced, so that the coupling noise is prevented from being added to the data transmitted through the bit line.

On the other hand, during the erasing, the row shield line 23 is set to an erase potential Vera (e.g., about 20 V). A reason lies in that the potential of the word line WL in the unselected block is sufficiently raised during the erasing.

That is, during the erasing, the word line of the unselected block (control gate line) WL is in the floating state. When the erase potential (e.g., about 20 V) is applied to the double well regions (cell well) 11-2, 11-3, the potential of the word line WL of the unselected block is raised by the capacity coupling.

Therefore, when the row shield line 23 is set to the erase potential Vera during the erasing, and when the potentials of the cell wells 11-2, 11-3 are raised to the erase potential Vera from the ground potential Vss, the potential of the word line WL is not influenced by the potential of the row shield line 23. The potential of the word line WL in the unselected block can sufficiently be raised to the same degree as that of the erase potential Vera.

Moreover, since the potential of the word line WL in the unselected block sufficiently rise to the same degree as that of the erase potential Vera, a large electric field is not applied to a tunnel oxide film between the floating gate electrode and the cell well in the unselected memory cell, and erroneous erasing can be prevented.

In this case, if the potential of the row shield line 23 is the ground potential Vss or the power potential Vcc, the potential of the word line WL is influenced by the potential (Vss or Vcc) of the row shield line 23, and does not rise to the same degree as that of the erase potential Vera. Therefore, in the unselected memory cell, the large electric field is applied to the tunnel oxide film, and the erroneous erase is sometimes generated.

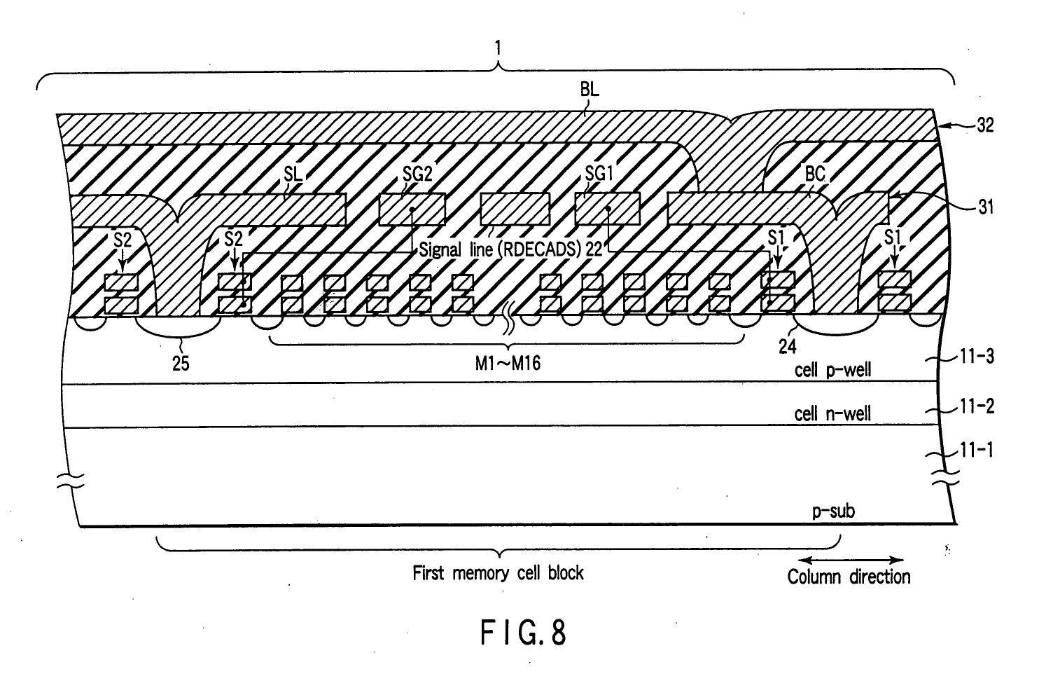

FIG. 8 shows a cross section of the column direction of the even-numbered memory cell block in FIG. 6. In the even-numbered memory cell block, since the row address decoders RADD2, RADD4, . . . are disposed on one end of the row direction of the memory cell array 1, and the word line drivers RMAIN2, RMAIN4, . . . are disposed on the other end of the row direction of the memory cell array 1. Therefore, a signal line 22 connecting the row address decoders RADD2, RADD4, . . . and word line drivers RMAIN2, RMAIN4, . . . is disposed on the memory cell array 1.

A concrete structure will be described hereinafter. In the p-type silicon substrate 11-1, the double region constituted of the n-type well region 11-2 and p-type well region 11-3 is formed. For example, 16 memory cells M1, . . . M16 connected in series to one another are formed on the p-type well region 11-3. Each memory cell is constituted of the N-channel MOS transistor, and has a stack gate structure constituted of the floating gate electrode and control gate electrode.

Two ends of the memory cells M1, . . . M16 connected in series are connected to the select transistors S1, S2. The select transistors S1, S2 are constituted of the N-channel MOS transistors. For example, the diffusion layer (drain) 24 of the select transistor S1 on the bit line side is connected to the metal wiring BC in the first wiring layer 31, and the diffusion layer (source) 25 of the select transistor S2 on the source line side is connected to the source line SL in the first wiring layer 31.

The gate electrode (select gate line (polysilicon)) of the select transistor S1 is connected to the metal wiring SG1 in the first wiring layer 31 so as to reduce the wiring resistance of the select gate line. The contact portion of the select gate line (polysilicon) and metal wiring SG1 is provided in the respective intersections of the select gate line with 528 bit lines.

Similarly, the gate electrode (select gate line (polysilicon)) of the select transistor S2 is connected to the metal wiring SG2 in the first wiring layer 31 so as to reduce the wiring resistance of the select gate line. The contact portion of the select gate line (polysilicon) and metal wiring SG2 is provided in respective intersections of the select gate line with 528 bit lines.

The bit line BL is provided in the second wiring layer 32 provided on the first wiring layer 31. The bit line BL extends in the column direction, and is connected to the diffusion layer (drain) 24 of the select transistor S1 via the metal wiring BC in the first wiring layer 31. Additionally, each signal line in the first and second wiring layers 31, 32 is constituted of aluminum, copper, or the alloy of these metals.

The signal line 22 is provided as a path of a signal RDECADS between the metal wirings SG1, SG2 on the memory cells M1, . . . M16. The even-numbered memory cell block portion is characterized in that the signal line 22 is provided instead of the row shield line 23 (see FIG. 7) of the odd-numbered memory cell block portion.

As described above with reference to FIG. 6, the signal line 22 transmits the output signal RDECADS of the row address decoder to the word line driver. Therefore, the potential of the signal line 22 cannot be set to the same as that of the row shield line.

The word line control circuit 3 in FIG. 6 can be constituted to set the potential of the signal line 22 to an optimum value in accordance with the operation mode, prevent the so-called coupling noise during the writing/reading, and sufficiently raise the potential of the unselected word line during the erasing.

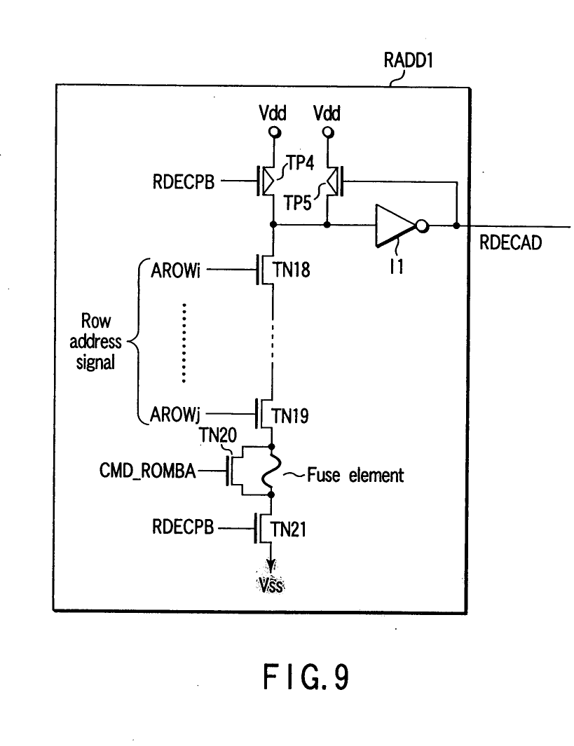

Structures of the circuits of the word line control circuit 3 (FIG. 6) will be described hereinafter with reference to FIGS. 9-12, and the potential level of the signal line 22 (FIGS. 7 and 8) in each operation mode will be described.

First, the symbols attached to the FIGS. 9-12 are defined as follows. The MOS transistor with the symbol “HN**” (* denotes a number, alphabet, or the like) attached thereto is, for example, the high-voltage enhancement N-channel MOS transistor which has a threshold voltage of about 0.6 V. A voltage higher than the power voltage Vcc is applied to the transistor. The transistor has an off state, when the gate indicates 0 V.

The MOS transistor with a symbol “IHN**” (* denotes a number, alphabet, or the like) attached thereto is, for example, the high-voltage enhancement N-channel MOS transistor which has a threshold voltage of about 0.1 V. A voltage higher than the power voltage Vcc is applied to the transistor. The MOS transistor with a symbol “DHN**” attached thereto is, for example, the high-voltage depression N-channel MOS transistor which has a threshold voltage of about −1 V. When the gate and drain are set to the power potential Vcc, the potential Vcc of the drain is transferred to the source. Moreover, the transistor has an off state, when the source and drain indicate Vcc, and the gate is set to 0 V.

Furthermore, the MOS transistor with symbol “TN**” attached thereto is, for example, the low-voltage enhancement N-channel MOS transistor which has a threshold voltage of about 0.6 V, and a voltage not less than the power voltage Vcc is applied. The MOS transistor with symbol “TP**” attached thereto is, for example, the low-voltage enhancement P-channel MOS transistor which has a threshold voltage of about 0.6 V.

FIG. 9 shows a main part of the row address decoder provided for the odd-numbered memory cell block. The row address decoder RADD1 functions as a block decoder. That is, for example, when the first memory cell block is selected, all row address signals AROWi, . . . AROWj indicate “H”, and an output signal RDECAD indicates “H”. An operation of the row address decoder RADD1 will be described later in detail.

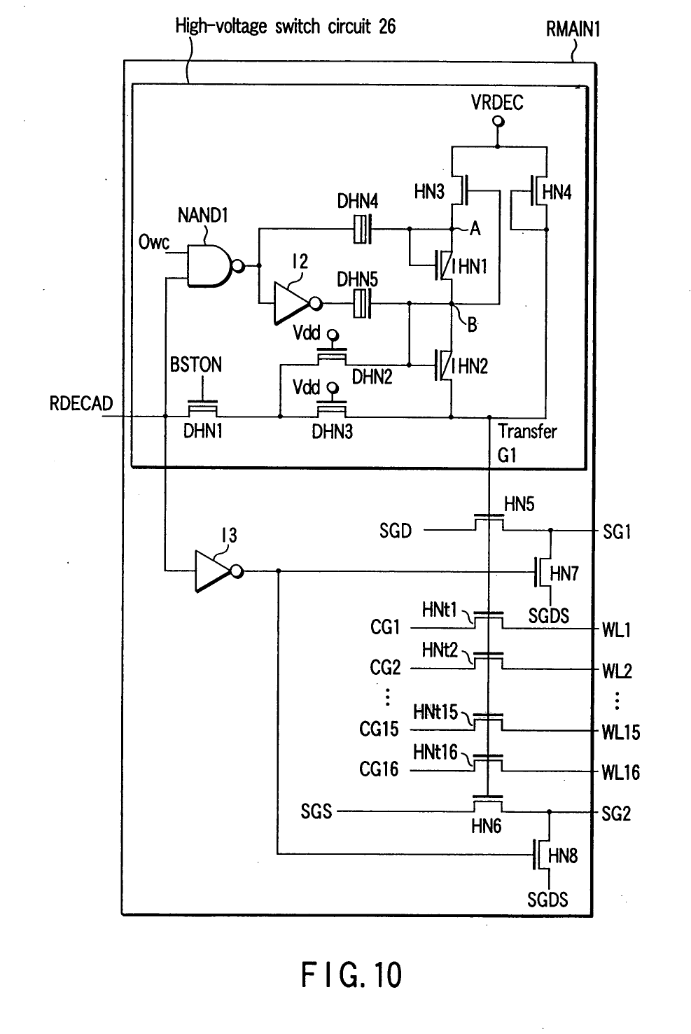

FIG. 10 shows a main part of the word line driver provided for the odd-numbered memory cell block. Main constituting elements of the word line driver RMAIN1 is a high-voltage switch circuit 26 and transfer MOS transistors HN5, HN6, HNt1, . . . Hnt16. The word line driver RMAIN1 further comprises inverter I3 and MOS transistors HN7 and HN8.

The high-voltage switch circuit 26 includes a first boosting unit constituted of a MOS capacitor DHN4 and MOS transistor IHN1, and a second boosting unit constituted of a MOS capacitor DHN5 and MOS transistor IHN2.

The gate of the MOS transistor HN3 is connected to a connection node B of the MOS transistors IHN1, IHN2. In this case, while the potential levels of the gate and source of the MOS transistor HN3 maintain a reverse phase, the potentials of the respective nodes A, B, TransferG1 gradually rise in synchronization with a clock signal Owc, and a boosting efficiency is enhanced.

The high-voltage switch circuit 26 is in an operative state, when the output signal RDECAD of the row address decoder RADD1 indicates “H”. That is, when the output signal RDECAD indicates “H”, the output signal of a NAND circuit NAND1 is a clock signal having a phase reverse to that of the clock signal Owc. The output signal of the NAND circuit NAND1 is applied directly to one end of MOS capacitor DHN4, and applied through inverter I2 to one end of capacitor DHN5.

As a result, a boosted potential is applied to the gates of the transfer MOS transistors HN5, HN6, HNt1, . . . HNt16, and the transfer MOS transistors HN5, HN6, HNt1, . . . HNt16 are turned on.

When the output signal RDECAD of the row address decoder RADD1 indicates “H”, the MOS transistors HN7, HN8 are turned off. In this case, signal lines SGD, SGS indicate, for example, the in-chip power potential Vdd, and Vdd is supplied to the select gate lines SG1, SG2 via the MOS transistors for transfer HN5, HN6.

Moreover, when the signal lines CG1, CG2, . . . CG16 are set to predetermined potentials by the switch circuit 9B (FIG. 1) in accordance with the operation mode. Furthermore, the potentials of the signal lines CG1, CG2, . . . CG16 are supplied to the word lines WL1, WL2, . . . WL16 via the MOS transistors for transfer HNt1, . . . HNt16.

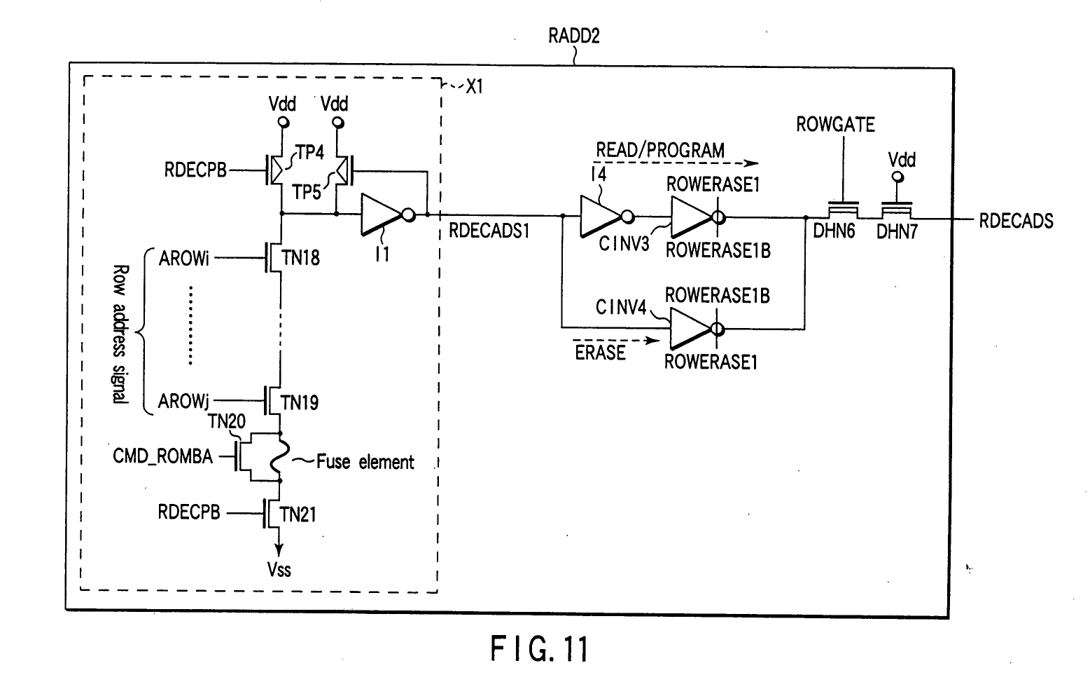

FIG. 11 shows a main part of the row address decoder provided for the even-numbered memory cell block. The row address decoder RADD2 includes the same circuit (portion surrounded with a broken line X1) as that of the row address decoder RADD1 shown in FIG. 9, inverter I4, clocked inverters CINV3, CINV4 and depression-type high-voltage N-channel MOS transistors DHN6, DHN7. Additionally, in FIG. 11, the same part as that of FIG. 9 is denoted with the same reference numerals.

The clocked inverter CINV4 operates to set the output signal RDECADS (potential of the signal line 22 of FIG. 8) of the row address decoder corresponding to the selected memory cell block to the ground potential Vss during the erase, and set the output signal RDECADS of the row address decoder corresponding to the unselected memory cell block to the in-chip power potential Vdd.

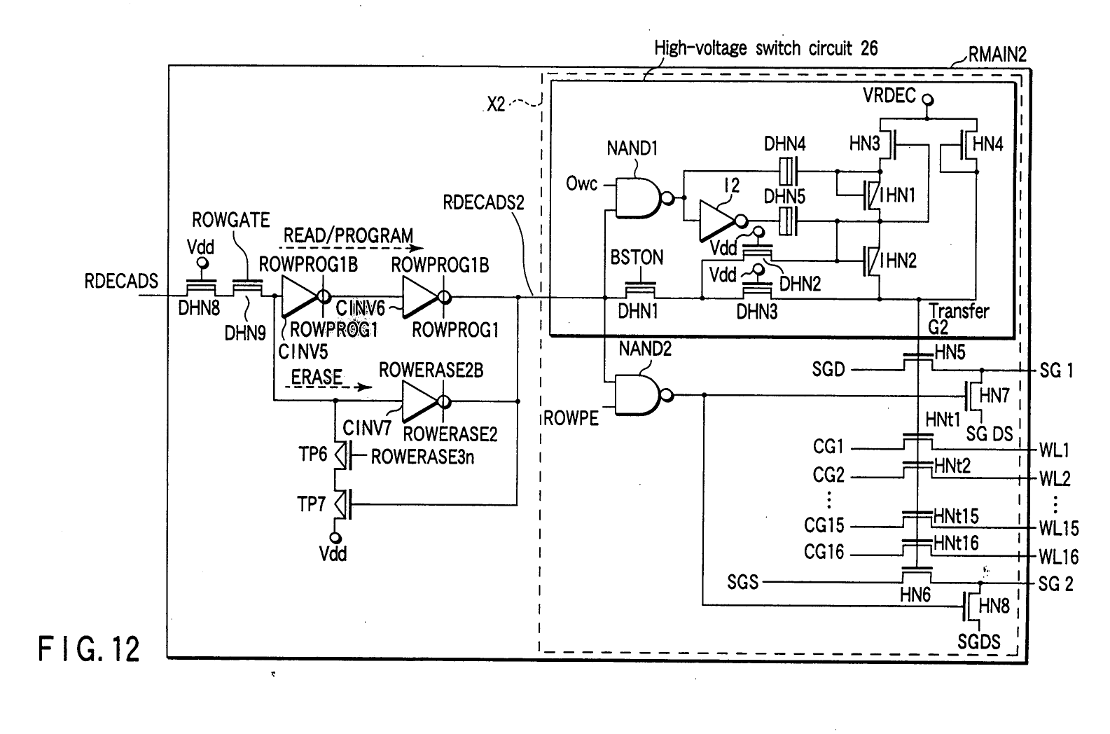

The MOS transistor DHN6 operates to set the signal line 22 (see FIG. 8) to the floating state together with a transistor DHN9 of FIG. 12 described later.

During the erase, a signal RDECADS1 indicates “H (Vdd)” in the selected memory cell block, and a signal RDECADS1 indicates “L (Vss)” in the unselected memory cell block.

Similarly to the conventional art, if the signal RDECADS1 is applied to the signal line 22 (FIG. 8) on the memory cell array, the signal line 22 (FIG. 8) on the memory cell array indicates “L (Vss)” in the unselected memory cell block. In the case, when the erase potential Vera is applied to the cell well by the capacity coupling of the cell well and word line, and the potential of the word line in the unselected memory cell block is to be raised, the potential of the word line does not sufficiently rise by the influence of the signal line 22 (FIG. 8) set to the ground potential Vss. In the present embodiment, however, since the clocked inverter CINV4 is provided, during the erase, the output signal RDECADS indicates “L (Vss)” in the selected memory cell block, and the signal RDECADS indicates “H (Vdd)” in the unselected memory cell block. That is, in the unselected memory cell block, the signal line 22 (see FIG. 8) on the memory cell array indicates “H (Vdd)”, and has the floating state by cut-off of the MOS transistors DHN6 and DHN9 (FIG. 12). Therefore, when the potential of the word line in the unselected memory cell block is raised by the capacity coupling of the cell well and word line, the influence of the signal line 22 (FIG. 8) having the in-chip power potential Vdd is reduced, and the potential of the word line sufficiently rises.

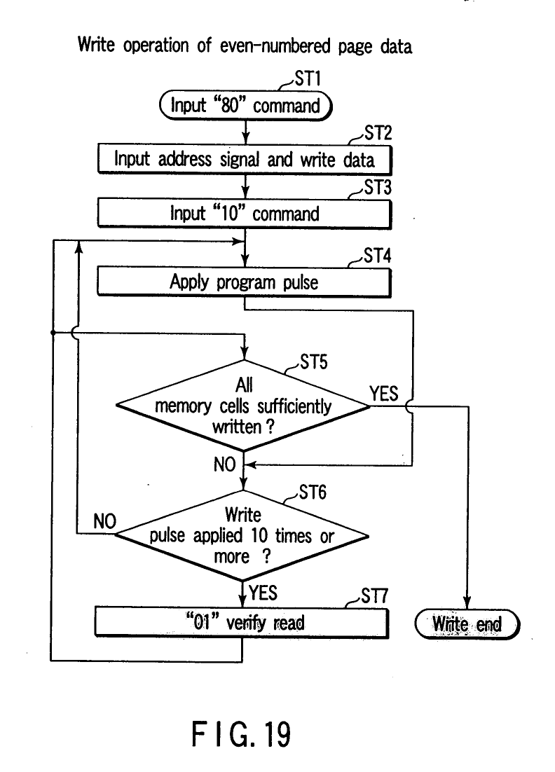

FIG. 12 shows a main part of the word line driver provided for the even-numbered memory cell block. The word line driver RMAIN2 includes the same circuit (portion surrounded with a broken line X2) as that of the word line driver RMAIN1 shown in FIG. 19, that is, the high-voltage switch circuit 26, MOS transistors for transfer HN5, HN6, HNt1, . . . HNt16, clocked inverters CINV5, CINV6, CINV7, depletion-type high-voltage N-channel MOS transistors DHN8, DHN9 and enhancement-type P-channel MOS transistors TP6, TP7. Additionally, in FIG. 12, the same part as that of FIG. 10 is denoted with the same reference numerals.

The clocked inverter CINV7 operates to return the output signal RDECADS (the potential of the signal line 22 of FIG. 8) of the row address decoder for the selected memory cell block to the in-chip power potential Vdd from the ground potential Vss during the erase, return the output signal RDECADS of the row address decoder for the unselected memory cell block to the ground potential Vss from the in-chip power potential Vdd, and subsequently apply a signal RDECADS2 to the circuit in the broken line X2.

The MOS transistor DHN9 operates to set the signal line 22 (see FIG. 8) to the floating state together with the transistor DHN6 of FIG. 11.

Additionally, in FIGS. 9 to 12, Vdd (in-chip power potential lower than the external power potential Vcc) is used as a power potential, however, for example, an external power potential Vcc may be used instead.

The potential level of the signal line 22 (FIG. 8) in each operation mode will next be described. Additionally, only the potential level of the signal line 22 will be described here, and the operation of the word line control circuit including the potential level of the signal line 22 will be described later in detail.

In this example, the signal line 22 (FIG. 8) connects the row address decoder (FIG. 11) and word line driver (FIG. 12) for the even-numbered memory cell block. Therefore, the potential level of the word line driver selection signal RDECADS transmitted through the signal line 22 (FIG. 8) will be described with reference to FIGS. 11 and 12.

The potential level of the output signal RDECADS of the row address decoder RADD2 differs by the operation mode.

In the operations (write/read/verify read) other than the erase operation, ROWERASE1B, ROWPROG1, ROWERASE2B, ROWERASE3n, ROWGATE are set to the power potential Vdd (the in-chip power potential lower than the external power potential Vcc, additionally the external power potential Vcc may be set), and ROWERASE1, ROWPROG1B, ROWERASE2 are set to the ground potential Vss.

In this case, the clocked inverters CINV3, CINV5, CINV6 are in the operative state, and the clocked inverters CINV4, CINV7 are in an inoperative state. Moreover, the MOS transistor TP6 is turned off.

In the selected memory cell block, the output signal RDECADS1 of the portion surrounded with the broken line X1 (FIG. 11) indicates “H”, that is, the in-chip power potential Vdd, and the output signal RDECADS of the row address decoder RADD2 also indicates “H”, that is, the in-chip power potential Vdd.

On the other hand, in the unselected memory cell block, the output signal RDECADS1 of the portion surrounded with the broken line X1 (FIG. 11) indicates “L”, that is, the ground potential Vss, and the output signal RDECADS of the row address decoder RADD2 also indicates “L”, that is, the ground potential Vss.

Therefore, in the operation other than the erase operation, the signal line 22 (FIG. 8) provided on the memory cell array in the unselected memory cell block is set to the ground potential Vss, the select gate lines SG1, SG2 in the unselected memory cell block are set to the ground potential Vss, and these signal lines 22, SG1, SG2 function as the shield lines between the bit line and word line (the same function as that of the row shield line 23 of FIG. 7). As a result, the coupling noise generated in the data transmitted through the bit line can be reduced.

In the erase operation, ROWERASE1B, ROWPROG1, ROWERASE2B, ROWERASE3n, ROWGATE are set to the ground potential Vss, and ROWERASE1, ROWPROG1B, ROWERASE2 are set to the in-chip power potential Vdd. The in-chip power potential Vdd may be replaced by the power potential Vcc.

In this case, the clocked inverters CINV4, CINV7 are in the operative state, and the clocked inverters CINV3, CINV5, CINV6 are in the inoperative state. Moreover, the MOS transistor TP6 is turned on.

In the selected memory cell block, the output signal RDECADS1 of the portion surrounded with the broken line X1 (FIG. 11) indicates “H”, that is, the in-chip power potential Vdd, and the output signal RDECADS of the row address decoder RADD2 indicates “L”, that is, the ground potential Vss.

On the other hand, in the unselected memory cell block, the output signal RDECADS1 of the portion surrounded with the broken line X1 (FIG. 11) indicates “L”, that is, the ground potential Vss, and the output signal RDECADS of the row address decoder RADD2 indicates “H”, that is, the in-chip power potential Vdd.

Moreover, ROWGATE is set to the ground potential Vss. Therefore, when the potential (potential of RDECADS) of the signal line 22 (FIG. 8) in the unselected memory cell block is of the order of 1 to 1.5 V, the MOS transistors DHN6, DHN9 are turned off, and thereby the signal line is set into the floating state.

In this manner, during the erase operation, the signal line 22 (FIG. 8) provided on the memory cell array in the unselected memory cell block indicates 1 to 1.5 V, and is in the floating state. That is, the erase potential Vera is applied to the cell well, similarly to the word line, the potential of the signal line 22 (FIG. 8) rises due to the capacity coupling. Therefore, the signal line 22 (FIG. 8) does not suppress the rise of the potential of the word line.

Therefore, during the application of the erase potential Vera to the cell well, an effect can be obtained that the potential of the word line in the unselected memory cell block easily rises by the capacity coupling between the cell well and the word line.

Moreover, accordingly, since the large electric field is not applied to the tunnel oxide film of the memory cell in the unselected memory cell block, the erroneous erase in the unselected memory cell block can be prevented.

Additionally, the fuse element (the same as the fuse element of FIG. 9) in the broken line X of FIG. 11 is not disconnected, when the memory cell block corresponding to the fuse element (row address decoder) is used as a usual memory region for a user.

Additionally, the fuse element in the broken line X of FIG. 11 is not disconnected, when the memory cell block corresponding to the fuse element (row address decoder element) is used as a usual memory region for a user. This is the same as the fuse element of FIG. 9.

However, when the memory cell block corresponding to the fuse element (row address decoder) is used, for example, as a ROM BLOCK region for storing, for example, a device code, the fuse element is disconnected, and the user is prevented from writing/erasing the data with respect to the ROM BLOCK region.

This ROM BLOCK region has the following significance. In recent years, a NAND-type flash memory has been in a memory of various electronic apparatuses. However, the NAND-type flash memory is sometimes used as memories of data concerning copyright such as a memory for storing music information by telephone communication.

In this case, the number of the chip, that is, a device code is stored in the NAND-type flash memory in order to prevent an illegal copy.

The device code is essential to each NAND-type flash memory. However, if the user can freely rewrite the device code, the original object of the device code cannot be achieved.

Therefore, the device code is written in the ROM BLOCK region of the NAND-type flash memory before a product is shipped, and the user cannot write/erase the data with respect to the ROM BLOCK region. That is, before a product is shipped, the fuse element is disconnected in the memory cell block as the ROM BLOCK region.

Thereby, when music information is to be copied to the NAND-type flash memory on an information reception side from the NAND-type flash memory on an information provider side, the device code is read from the NAND-type flash memory on the information provider side. When this code is different from the device code of the NAND-type flash memory on the information reception side, the information cannot be copied.

The fuse element is disconnected immediately after the device code is written in the memory cell block as the ROM BLOCK region.

If a pre-shipping test is carried out in the non-disconnected state of the fuse element, the device code is erased in this test.

That is, in the pre-shipping test, all the blocks are simultaneously selected, and the data is written/erased in order to reduce a test time. That is, all row address signals AROWi, . . . AROWj indicate “H”. Therefore, unless the fuse element is disconnected, and even when CMD ROMBA indicates “L”, RDECADS1 indicates “H” (RDECAD indicates “H” in FIG. 9), and the memory cell block as the ROM BLOCK region is selected.

On the other hand, in the pre-shipping test, even when all the row address signals AROWi, . . . AROWj indicate “H”, and when the fuse element is disconnected, the CMD ROMBA indicates “L”. Therefore, RDECADS1 indicates “L” (RDECAD indicates “L” in FIG. 9), and the memory cell block as the ROM BLOCK region is not selected.

Even when the fuse element is disconnected, it is necessary to read out the device code stored in the ROM BLOCK region.

The data reading with respect to the ROM BLOCK region can be achieved, when CMD ROMBA is set to “H”. That is, when CMD ROMBA indicates “H”, and AROWi, . . . AROWj in the ROM BLOCK region indicate “H”, the memory cell block as the ROM BLOCK region is selected.

Moreover, even after the fuse element is disconnected, a special command is inputted, thereby AROWi, . . . AROWj in CMD ROMBA and ROM BLOCK region are set to “H”, and the data in the ROM BLOCK region can be rewritten. In this case, a command for setting CMD ROMBA to “H” is not open to general users, so that the data in the ROM BLOCK region is prevented from being illegally rewritten.

Additionally, in this example, the case in which the fuse in the ROM BLOCK region is disconnected has been described. However, the fuse of FIG. 9 or the fuse in the broken line X of FIG. 11 is disconnected, even when the memory cell block is a defective block. In this case, the defective block is replaced by a spare block by the redundancy circuit (not shown).

The operation of the main part of the four-level NAND cell type EEPROM device (FIG. 1) of the present embodiment in the respective operation modes such as the read, write, erase, test (bar in), concretely, the operation of the data circuit (FIG. 2), collective detection circuit (FIG. 5) and word line control circuit (FIGS. 6, 9 to 12) will be described in detail.

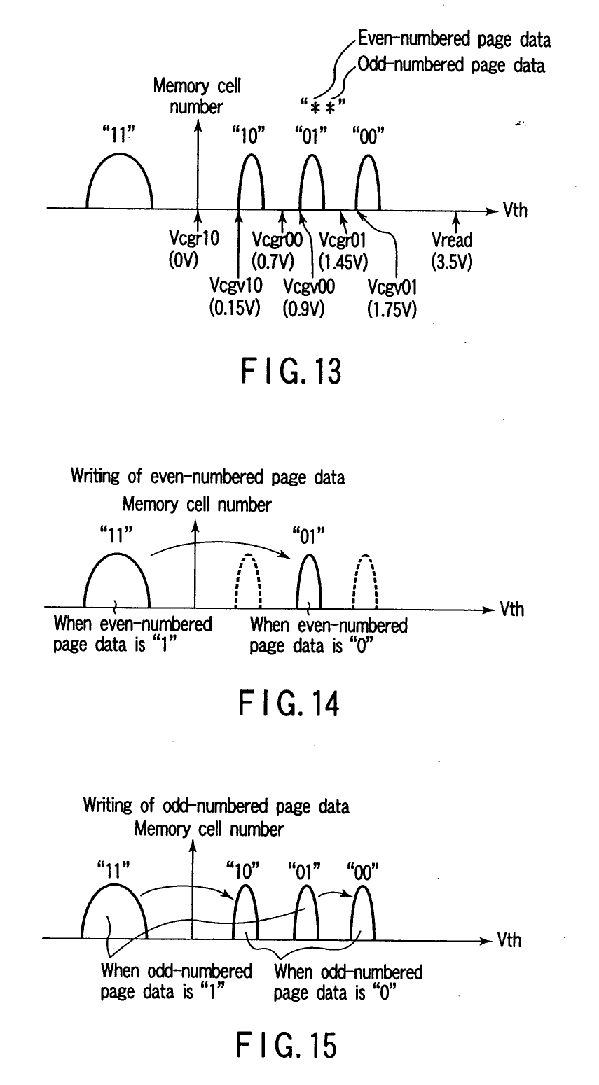

Before the description of the operation, first, one example of the threshold voltage of the memory cell and data writing method will briefly be described. FIG. 13 shows a distribution of two bits of four-level data (“11”, “10”, “01”, “00”) stored in the memory cell of the four-level NAND cell type EEPROM device and the threshold voltage (Vth) of the memory cell.

The memory cell in the erase state “11” has a negative threshold voltage Vth. Moreover, the memory cells in the write state “10”, “01”, “00” have a positive threshold voltage Vth. Moreover, in the write state, the state “10” has a lowest threshold voltage, the state “00” has a highest threshold voltage, and the state “01” has a threshold voltage between the states “10” and “00”.

Similarly to that as described in Jpn. Pat. Appln. KOKAI Publication No. 1998-3792, the two-bits data of one memory cell corresponds to different row addresses (even-numbered page and odd-numbered page). Therefore, the four-level data (two-bits data) is constituted of even-numbered page data and odd-numbered page data, and the even-numbered page data and odd-numbered page data are written in the memory cell by separate write operations, that is, two write operations.

First, the even-numbered page data is written. All the memory cells are assumed to be in the erase state, that is, the state “11”. In this state, as shown in FIG. 14, when the even-numbered page data is written, the distribution of the threshold voltages Vth of the memory cells is divided into two in accordance with the value of the even-numbered page data (“1”, “0”).

That is, when the even-numbered page data is “1”, the high electric field is prevented from being applied to the tunnel oxide film of the memory cell, and the threshold voltage Vth of the memory cell is prevented from rising. As a result, the memory cell maintains the erase state (state “11”) (the writing of even-numbered page data “1”).

On the other hand, when the even-numbered page data is “0”, the high electric field is applied to the tunnel oxide film of the memory cell, an electron is implanted to a floating gate electrode, and the threshold voltage Vth of the memory cell is raised by a predetermined amount. As a result, the memory cell changes to the write state (state “01”) (the writing of the even-numbered page data “0”).

Thereafter, the odd-numbered page data is written. The odd-numbered page data is written based on the write data inputted from the outside of the chip (i.e., the odd-numbered page data) and the even-numbered page data already written in the memory cell.

That is, as shown in FIG. 15, when the odd-numbered page data is “1”, the high electric field is prevented from being applied to the tunnel oxide film of the memory cell, and the threshold voltage Vth of the memory cell is prevented from rising. As a result, the memory cell in the state “11” (erase state) maintains the state “11” as it is, and the memory cell in the state “01” maintains the state “01” as it is (the writing of the odd-numbered page data “1”).

On the other hand, when the odd-numbered page data is “0”, the high electric field is applied to the tunnel oxide film of the memory cell, the electron is implanted into the floating gate electrode, and the threshold voltage Vth of the memory cell is raised by the predetermined amount. As a result, the memory cell in the state “11” (erase state) changes to the state “01”. The memory cell in the state “01” changes to the state “00” (the writing of the odd-numbered page data “0”).

That is, in this example, when the even-numbered page data is “1”, and the odd-numbered page data is “1”, data “11” is written in the memory cell. When the even-numbered page data is “0”, and the odd-numbered page data is “1”, data “01” is written in the memory cell. Moreover, when the even-numbered page data is “1”, and the odd-numbered page data is “0”, data “01” is written in the memory cell. When the even-numbered page data is “0”, and the odd-numbered page data is “0”, data “00” is written in the memory cell.

In this manner, the distribution of the threshold voltage Vth of the memory cell is divided into four (“11”, “10”, “01”, “00”) by two write operations.

A concrete operation will be described hereinafter with reference to an operation timing chart.

1. Read Operation

The read operation includes a read operation of the even-numbered page data and a read operation of the odd-numbered page data.

1.-1. Read Operation of Even-Numbered Page Data

As apparent from FIG. 13, the “11” and “10” states indicate the even-numbered page data “1”, and the “01” and “00” states indicate the even-numbered page data “0”. That is, it can be judged by one read operation “READ01” whether the even-numbered page data is “1” or “0”. Therefore, the read operation of the even-numbered page data is constituted only of “READ01”.

1.-1.-1. “READ01”

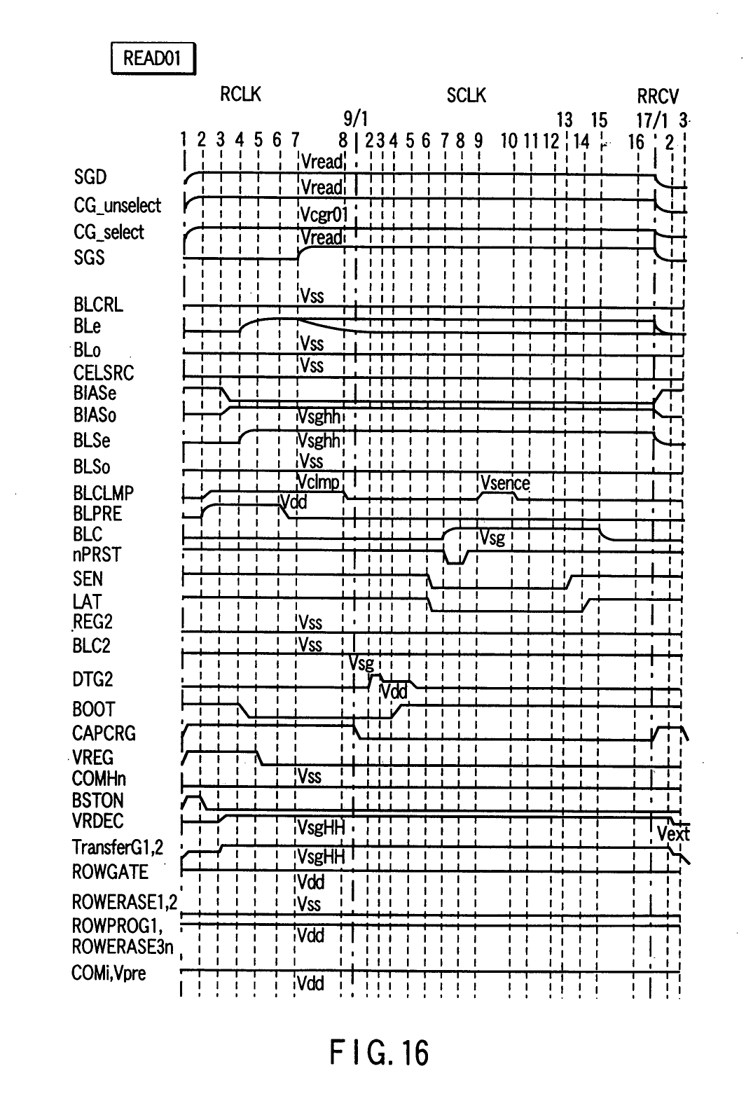

FIG. 16 shows a “READ01” operation. The “READ01” operation is an operation of setting the read potential (potential of the selected word line) to Vcgr01 (e.g., about 0.7 V), and judging whether the data of the memory cell is “01”, “00”, or other data “11”, “10”.

First, in the row address decoder (FIGS. 9, 11), RDECPB is set to “L”. At this time, both RDECAD (FIG. 9) and RDECADS1 (FIG. 11) indicate “L (Vss)”, and all the memory cell blocks are in the unselected state.

Thereafter, RDECPB changes to “H” from “L”. In this case, the MOS transistor TP4 is turned off, and the MOS transistor TN21 is turned on (FIGS. 9, 11).

Moreover, in the selected memory cell block, all the row address signals AROWi, . . . AROWj turn to “H”, and both RDECAD (FIG. 9) and RDECADS1 (FIG. 11) turn to “H”. In the unselected memory cell block since at least one of the row address signals AROWi, . . . AROWj indicates “L”, RDECAD (FIG. 9) and RDECADS1 (FIG. 11) maintain “L”.

In the word line driver (FIGS. 10, 12) in the selected memory cell block, since the input signals RDECAD and RDECADS1 turn to “H”, the high-voltage switch circuit (NMOS charge pump circuit) 26 operates by an oscillation signal (clock signal) Owc.

Therefore, in the word line driver (FIGS. 10, 12) in the selected memory cell block, a potential VRDEC is transferred to the output node of the high-voltage switch circuit 26.

For example, when the word line driver RMAIN1 (FIG. 10) in the first memory cell block is selected, the potential VRDEC (e.g., about 6 V) is transferred to an output node TransferG1. When the word line driver RMAIN2 (FIG. 12) in the second memory cell block is selected, the potential VRDEC (e.g., about 6 V) is transferred to an output node TransferG2.

As a result, the gates of transistors for transfer HNt1, HNt2, . . . HNt16 indicate VRDEC, and the potentials of the signal lines CG1, CG2, . . . CG16 are transferred to the word lines (control gate lines) WL1, WL2, . . . WL16 via the transistors for transfer HNt1, HNt2, . . . HNt16.

Moreover, the potentials of the signal lines SGD, SGS are also transferred to the select gate lines SG1, SG2 via the transistors for transfer HN5, HN6.

Here, the potential of one signal line selected from the signal lines CG1, CG2, . . . CG16 is set to Vcgr01 (e.g., about 0.7 V) by the switch circuit (FIG. 1), and the potentials of the remaining unselected signal lines are set to Vread (e.g., about 3.5 V) by the switch circuit (FIG. 1). Moreover, the potentials of the signal lines SGD, SGS are also set to Vread (e.g., about 3.5 V).

On the other hand, for the word line driver (FIGS. 10, 12) in the unselected memory cell block, the potentials RDECAD, RDECADS2 are transferred to the output nodes TransferG1, TransferG2 of the high-voltage switch circuit 26.

That is, for the word line driver (FIGS. 10, 12) in the unselected memory cell block, the output nodes TransferG1, TransferG2 are both set to the ground potential Vss.

As a result, the transistors for transfer HNt1, HNt2, . . . HNt16 are turned off, and the word lines (control gate lines) WL1, WL2, . . . WL16 are set into the floating state. Moreover, the select gate lines SG1, SG2 are grounded by the signal lines SGS, SGD.

An operation timing of FIG. 16 will be described in detail.

Additionally, it is assumed that the memory cell to be connected to a bit line BLe is selected, and the bit line BLo is used as the shield bit line. On the row side (word line control circuit side), BSTON turns to “H” in time RCLK1. At this time, in the selected memory cell block, Vdd (RDECAD or RDECADS2) is transferred to the output node (TransferG1 or TransferG2) of the high-voltage switch circuit in the word line driver.

Moreover, BSTON turns to “L” in time RCLK2, and VRDEC turns to VsgHH in time RCLK3. Therefore, in the selected memory cell block, the potential of the output node (TransferG1 or TransferG2) of the high-voltage switch circuit in the word line driver rises to VsgHH.

The potential of the selected word line CG select is set to Vcgr01 (e.g., about 0.7 V), and the potential of an unselected word line CG unselect and potential SGD of the select gate line SG1 are set to Vread (e.g., about 3.5 V).

On the other hand, BLPRE turns to Vdd (e.g., about 2.3 V) in time RCLK2 on the column side (data circuit side). Moreover, when BIASe indicates the ground potential Vss, and BIASo indicates Vsghh in time RCLK3, and BLSe indicates Vsghh in time RCLK4, the bit line BLe is pre-charged, and the bit line BLo indicates the ground potential Vss.

While the bit line BLe is being pre-charged, the potential of BLCLMP indicates Vclmp (e.g., about 2 V). Therefore, after the bit line BLe rises to about 0.8 V, the bit line is set into the floating state. Moreover, the pre-charge of the bit line BLe is completed in time RCLK7.

Moreover, when the potential SGS of the select gate line SG2 is set to Vread in time RCLK7, the potential of the bit line BLe drops or is maintained in accordance with the data of the selected memory cell.

That is, when the data of the selected memory cell is “11”, “10”, the selected memory cell is turned on by Vcgr01. Therefore, the bit line BLe is discharged, and the potential of the bit line BLe drops to 0.3 V or less (the unselected memory cell in the selected block is turned on by Vread).

On the other hand, when the data of the selected memory cell is “01”, “00”, the selected memory cell is not turned on by Vcgr01. Therefore, the bit line BLe is not discharged, and the bit line BLe maintains the pre-charge potential (about 0.8 V).

In time SCLK6, both SEN and LAT turn to “L”, and both SENB and LATB turn to “H”. The latch circuit LATCH, that is, the clocked inverters CINV1, CINV2 are in the inoperative state (FIG. 2).

In time SCLK7, when BLC indicates Vsg (about 4.5 V), and nPRST indicates “L”, the sense node (DTNij) indicates Vdd. Moreover, when nPRST indicates “H” in time SCLK8, the sense node is set into the floating state. Moreover, in time SCLK9, BLCLMP indicate Vsense (e.g., about 1.6 V), and the potential of the bit line BLe is conducted to the sense node.

At this time, when the data of the memory cell is “11”, “10”, the bit line BLe has a potential of 0.3 V or less, and the potential of the sense node (DTNij) therefore drops to the potential of 0.3 V or less from Vdd. Moreover, when the data of the memory cell is “01”, “00”, the bit line BLe maintains the pre-charge potential (e.g., about 0.8 V), the MOS transistor for clamp TN9 (see FIG. 2) cuts off, and the sense node (DTNij) maintains Vdd.

Thereafter, in time SCLK13, SEN turns to “H”, SENB turns to “L”, and the clocked inverter CINV1 is in the operative state (FIG. 2).

As a result, when the data of the memory cell is “11”, “10”, the output node Nbij of the clocked inverter CINV1 indicates Vdd. When the data of the memory cell is “01”, “00”, the output node Nbij of the clocked inverter CINV1 indicates Vss.

Moreover, in time SCLK14, LAT indicates “H”, LATB indicates “L”, and the clocked inverter CINV2 is in the operative state (FIG. 2). That is, the read data (data of the sense node) is latched by the latch circuit LATCH.

At this time, when the data of the memory cell is “11”, “10” (the memory cell in which the even-numbered page data is “1”), the output node Naij indicates Vss, and the output node Nbij indicates Vdd. When the data of the memory cell is “01”, “00” (the memory cell in which the even-numbered page data is “0”), the output node Naij indicates Vss, and the output node Nbij indicates Vss.

The data held in the output node Naij of the latch circuit LATCH is shown in “after READ01” in Table 1.

TABLE 1
Read

| | “11” | “10” | “01” | “00” | |
|---|---|---|---|---|---|
| Latch | L | L | H | H | [After first read |
| node | | | | | Read01] |
| N1 (Naij) | | | | | |
| Sense | L | H | H | H | [Second read |
| node | | | | | Read10: After |
| DTNij | | | | | discharge] |
| Latch | L | H | L | L | [Second read |
| node | | | | | Read10: After |
| N1 | | | | | sense node |
| | | | | | discharge] |
| Sense | L | L | L | H | [Third read |
| node | | | | | Read00: After BL |
| DTNij | | | | | discharge] |
| Latch | L | H | L | H | [Third read |
| node | | | | | Read00: After |
| N1 | | | | | sense node charge] |

Thereafter, for the read data, when CSLi is set to “H”, the data (even-numbered page data) of the latch circuit LATCH is outputted to an I/O line (IOj, nIOj), and outputted to the outside of the memory chip.

1.-2. Read Operation of Odd-Numbered Page Data

As apparent from FIG. 13, the “11” and “01” states indicate the odd-numbered page data “1”, and the “10” and “00” states indicate the odd-numbered page data “0”. Therefore, it can be judged whether the odd-numbered page data is “1” or “0” by two read operations “READ10”, “READ00” following the read operation of the even-numbered page data.

1.-1.-2. “READ10”

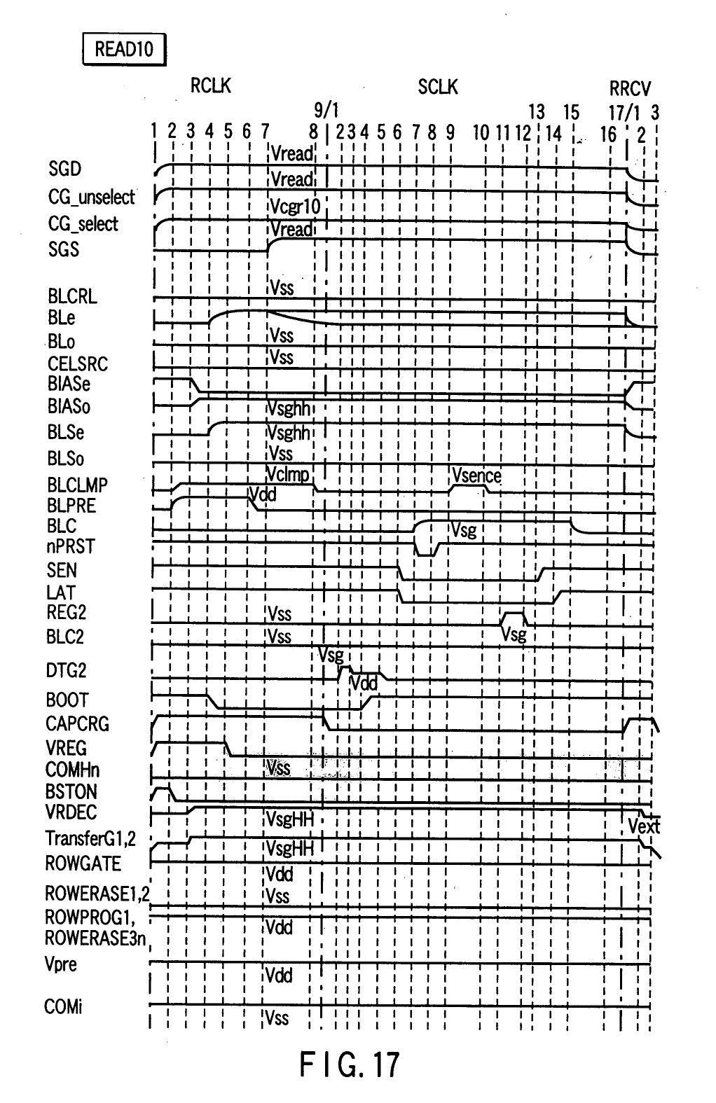

FIG. 17 shows a “READ10” operation. The “READ10” operation is an operation of setting the read potential (potential of the selected word line) to Vcgr10 (e.g., 0.15 V), and judging whether the data of the memory cell is “11”, or other data “10”, “01”, “00”.

The “READ10” operation is substantially the same as the “READ01” operation except the level of the read potential (the potential of the selected word line).

First, from time RCLK1 to time RCLK6, the same operation as the “READ01” operation is performed except the level of the potential of the selected word line. That is, the potential of the selected word line is set to Vcgr10, the potential of the unselected word line in the selected block is set to Vread, the bit line BLe is pre-charged, and then set to the floating state, and the bit line BLo is set to the ground potential Vss.

Thereafter, when the potential SGS of the select gate line SG2 is set to Vread in time RCLK7, the potential of the bit line BLe drops or is maintained in accordance with the data of the selected memory cell.

That is, after “READ01” is performed, the data of the selected memory cell is “11” or “10” in time RCLK8 of “READ 10”. Then, the selected memory cell is turned on by Vcgr10, the bit line BLe is discharged, and the potential of the bit line BLe drops to 0.3 V or less (the unselected memory cell in the selected block is turned on by Vread).

On the other hand, when the data of selected memory cell is “01” or “00”, the selected memory cell is not turned on by Vcgr10, the bit line BLe is not discharged, and the bit line BLe maintains the pre-charge potential (about 0.8 V).

The data of the sense node in time SCLK9 is as shown in “READ10: after BL discharge” in Table 1.

Thereafter, in time SCLK11, REG2 indicates Vsg. With “01”, “00”, since CAP2ij indicates “H”, the sense node is discharged to Vss from COMi, and indicates “L”. In this case, COMHn of FIG. 5 is set to Vdd, and COMVss is set to Vdd.

Thereafter, similarly to the “READ01” operation, the potential of the bit line BLe is sensed, and latched by the latch circuit LATCH. The data held by the output node Naij of the latch circuit LATCH is as shown in “READ10: after sense node discharge” in Table 1.

However, in this stage, it is uncertain whether the odd-numbered page data is “1” or “0”. Then, after the “READ10”, “READ00” is performed.

1.-2.-1. “READ00”

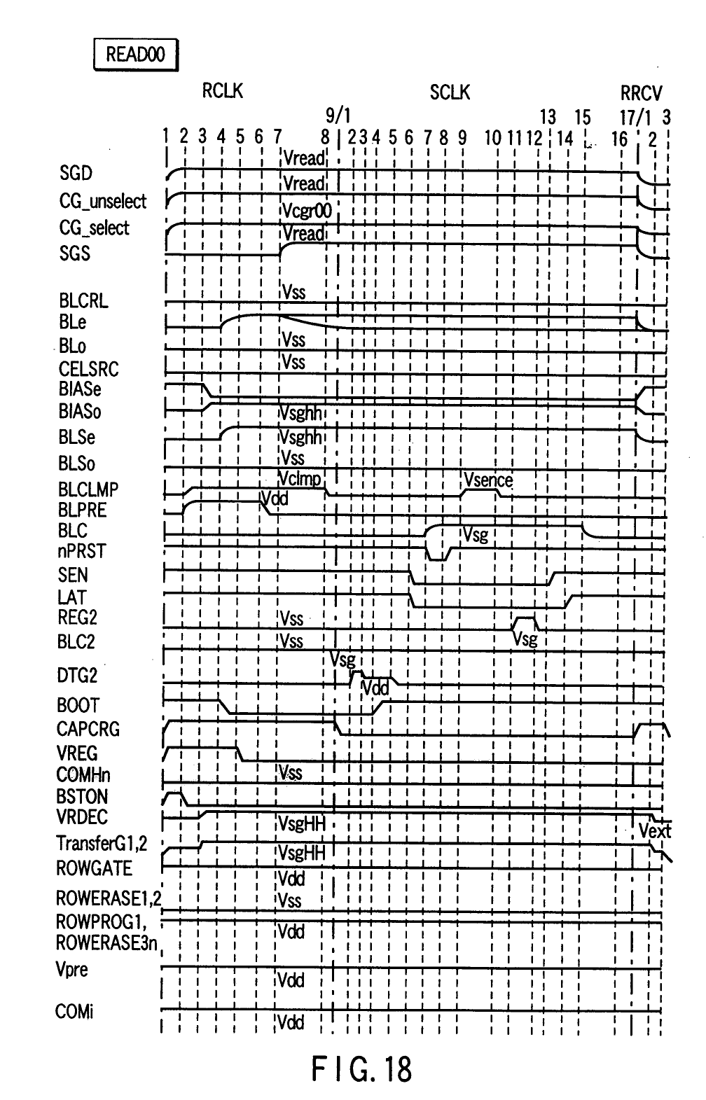

FIG. 18 shows a “READ00” operation. The “READ00” operation is an operation of setting the read potential (the potential of the selected word line) to Vcgr00 (e.g., about 1.45 V), and judging whether the data of the memory cell is either one of “11”, “10”, and “01”, or “00”.

The “READ00” operation is substantially the same as the “READ01” operation except the level of the read potential (the potential of the selected word line).

First, the potential of the selected word line is set to Vcgr00, the potential of the unselected word line in the selected block is set to Vread, the bit line BLe is pre-charged, and then set to the floating state, and the bit line BLo is set to the ground potential Vss (BLe is the selected bit line, and BLo is a shield bit line).

Thereafter, when the potential SGS of the select gate line SG2 is set to Vread in the time RCLK7, the potential of the bit line BLe drops or is maintained in accordance with the data of the selected memory cell.

That is, after “READ10” is performed, the data of the selected memory cell is “11”, “10”, or “01” in the time RCLK8 of “READ10”. Then, the selected memory cell is turned on by Vcgr10, the bit line BLe is discharged, and the potential of the bit line BLe drops to 0.3 V or less (the unselected memory cell in the selected block is turned on by Vread).

On the other hand, when the data of the selected memory cell is “00”, the selected memory cell is not turned on by Vcgr10, the bit line BLe is not discharged, and the bit line BLe maintains the pre-charge potential (about 0.8 V).

The data of the sense node in time SCLK10 is as shown in “READ00: after BL discharge” in Table 1.

Thereafter, in time SCLK11, REG2 indicates Vsg. With “10”, since CAP2ij indicates “H”, the sense node is charged to Vdd from COMi, and indicates “H”. In this case, in FIG. 5, COMHn indicates Vss, and COMVss also indicates Vss.

Thereafter, similarly to the “READ01” operation, the potential of the bit line BLe is sensed, and latched by the latch circuit LATCH. The data held in the output node Naij of the latch circuit LATCH is shown in “READ00: after sense node discharge” in Table 1.

That is, in the memory cell in which the odd-numbered page data is “1”, the potential of the output node Naij of the latch circuit LATCH indicates Vss. In the memory cell in which the odd-numbered page data is “0”, the potential of the output node Naij of the latch circuit LATCH indicates Vdd.

Thereafter, when CSLi is set to “H”, the data (odd-numbered page data) of the latch circuit LATCH is outputted to the I/O line (IOj, nIOj), and outputted to the outside of the memory chip.

2. Write Operation (Program Operation)

As the outline is described with reference to FIGS. 14 and 15, the write operation includes two write operations, that is, the write operation of the even-numbered page data and the write operation of the odd-numbered page data.

2.-1. Write Operation of Even-Numbered Page Data

First, an outline (flow of the operation) of the write operation of the even-numbered page data will be described. Thereafter, a concrete circuit operation (operation timing) will be described.

FIG. 19 shows an outline of the write operation of the even-numbered page data. First, for example, a “80 (hexadecimal)” command is inputted in the chip. Thereafter, the address signal is inputted in the chip, and subsequently the write data of the even-numbered page is inputted in the chip. The write data is inputted in the latch circuit LATCH (FIG. 2) in the data circuit from the outside of the chip via the I/O lines IOj, nIOj in the chip (steps ST1 and ST2).

Subsequently, for example, a “10 (hexadecimal)” command is inputted in the chip. Then, a write pulse is applied to the word line of the memory cell (steps ST3 and ST4).

Here, in this example, to reduce the write time (raise the speed of the writing), a sequence (parallel processing) of applying the write pulse n-times (step ST4), applying a n−1-th write pulse, and detecting whether or not “01” is sufficiently written is used (step ST5).

Additionally, as described hereinafter, as another means for achieving the reduction of the write time (the raising of the write speed), in the present example, a sequence of gradually raising the write potential (size of the write pulse), and not performing the “01” verify read in the beginning of the write operation is employed.

Therefore, in the present example, when the “01” verify read is not performed, it is not detected (step ST5) whether the data is sufficiently written.

When the number of applications of the write pulse to the word line is not more than a predetermined number of times (e.g., nine times), the “01” verify read is omitted, and the write pulse is continuously applied (step ST6). When the verify read is omitted in the beginning of the write operation, the writing can be accelerated.

Additionally, the “01” verify read (VERIFY01) means that the data of the memory cell is read with a verify read potential Vcgv01 (FIG. 13) in order to verify whether or not the data “01” is sufficiently written in the memory cell subjected to the “01” writing.

In this example, the write potential (the level of the write pulse) is set to an initial value, and the application of the write pulse is started. Thereafter, every time the write pulse is applied, the write potential applied to the word line is gradually raised by each predetermined value (e.g., about 0.2 V).

For example, when the write potential is raised by each about 0.2 V, ideally, the width of the threshold voltage distribution of the memory cell in the “10” write state can be set to about 0.2 V. In the actual operation, the width of the threshold voltage distribution of the memory cell in the “01” write state is about 0.4 V by a so-called array noise generated in the verify read.

Additionally, in FIG. 13, it is assumed that the width of the threshold voltage distribution of the memory cell in the write state (“10”, “01”, “00”) indicates about 0.4 V.

From the start of the write operation until, for example, nine applications of the write pulse, the write potential is set to be sufficiently low, so that excessive writing (the writing with a threshold voltage exceeding Vcgr02) is not performed with respect to the memory cell subjected to the “01” writing.

In this manner, the pulse having a low write potential is first applied to the word line, and the write potential is gradually raised for each application of the pulse, so that the electron is implanted in the floating gate electrode little by little, and finally a predetermined amount of electrons are accumulated in the floating gate electrode.

In this case, as compared with a case in which the predetermined amount of electrons are implanted in the floating gate electrode once with one write pulse, the electric field applied to the tunnel oxide film of the memory cell with one write pulse is low, and reliability of the tunnel oxide film is enhanced.

Moreover, the write potential (the level of the write pulse) is gradually raised to a high value from a low value. That is, when the write potential is gradually raised, the width of the threshold voltage distribution of the memory cell can empirically be narrowed as compared with a case in which the initial write potential is set to a high value and the write potential is gradually lowered.

When the number of applications of the write pulse with respect to the word line is, for example, ten or more, to verify whether or not the data “01” is sufficiently written with respect to the memory cell subjected to the “01” writing, the write pulse is applied to the word line, and subsequently the “01” verify read is performed (steps ST6 and ST7).

Moreover, the data read from the memory cell by the “01” verify read indicates whether the “01” writing has been sufficiently performed, and the data is stored in the latch circuit LATCH in the data circuit.

Thereafter, in parallel to an operation of applying the next write pulse to the word line (step ST4), an operation (program completion detection) of verifying whether or not the “01” writing has sufficiently been performed by the previous write pulse based on the data of the latch circuit LATCH is executed (step ST5).

Concretely, in the write operation of the even-numbered page data, as shown in FIG. 14, a “11” writing and “01” writing are present. The “11” writing means that the erase state (“11”) is maintained. The “01” writing means that the threshold voltage is raised by the write pulse, and the “11” state is changed to the “01” state.

When the predetermined data “11”, “01” are sufficiently written in all the selected memory cells (columns) (in actual, when the data “01” is sufficiently written in the memory cell as an object of the “01” writing), the write operation of the even-numbered page data is completed.

When the predetermined data “11”, “01” are not sufficiently written in at least one selected memory cell (column) (in actual, when the data “01” is not sufficiently written in the memory cell as the object of the “01” writing), the “01” verify read and the application of the write pulse are continuously performed.

Additionally, in general, the high electric field is prevented from being applied to the tunnel oxide film thereafter with respect to the sufficiently written memory cell, the high electric field is continuously applied (rewritten) into the tunnel oxide film only with respect to the insufficiently written memory cell, and the excessive writing is prevented with respect to the memory cell having a satisfactory write property.

Moreover, in this example, the operation for detecting sufficiency/insufficiency of the writing (program completion detection) is performed in parallel to the operation for applying the write pulse to the word line. However, for example, when the program completion detection is performed immediately after the “01” verify read, and the result of the program completion detection is insufficient, the write pulse may be applied again.

The outline of the write operation of the even-numbered page data has been described above.

As described above, the write operation of the even-numbered page data includes the write pulse application, “01” verify read (VERIFY01) and program completion detection (detection of whether or not the writing has sufficiently been performed).

These three operations will successively be described hereinafter.

2.-1.-1. Write Pulse Application

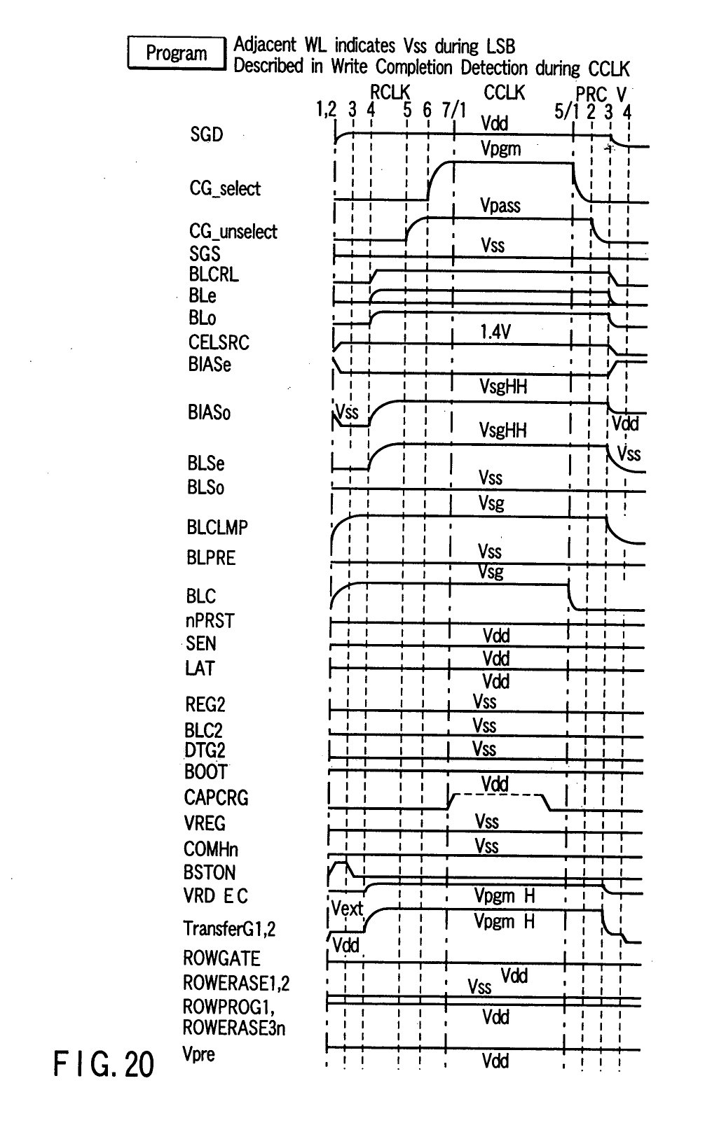

FIG. 20 shows an operation timing concerning the write pulse application. First, when the “01” writing is performed (when the even-numbered page data “0” is written in the memory cell), the write data is inputted in the latch circuit LATCH (FIG. 2) from the outside of the chip, and “L” is latched in the node Naij of the latch circuit LATCH.

Moreover, when the “11” writing is performed (when the even-numbered page data “1” is written in the memory cell), the write data is inputted in the latch circuit LATCH (FIG. 2) from the outside of the chip, and “H” is latched in the node Naij of the latch circuit LATCH.

On the other hand, on the word line control circuit (row) side, first in the row address decoder (FIGS. 9, 11), RDECPB is set to “L”. In this case, both RDECAD (FIG. 9) and RDECADS1 (FIG. 11) indicate “L (Vss)”, and all the memory cell blocks are in the unselected state.

Thereafter, RDECPB changes to “H” from “L”. In this case, the MOS transistor TP4 is in the off state, and the MOS transistor TN21 is in the on state (FIGS. 9, 11).

Moreover, in the selected memory cell block, all the row address signals AROWi, . . . AROWj turn to “H”, and both RDECAD (FIG. 9) and RDECADS1 (FIG. 11) turn to “H”. In the unselected memory cell block, since at least one of the row address signals AROWi, . . . AROWj indicates “L”, RDECAD (FIG. 9) and RDECADS1 (FIG. 11) maintain “L”.

In the word line driver (FIGS. 10, 12) in the selected memory cell block, since the input signals RDECAD and RDECADS1 turn to “H”, the high-voltage switch circuit (NMOS charge pump circuit) 26 operates by the oscillation signal (clock signal) Owc.

Therefore, in the word line driver (FIGS. 10, 12) in the selected memory cell block, a boosted potential VpgmH (potential of about 2 V higher than the write potential Vpgm) generated based on the potential VRDEC is transferred to the output node of the high-voltage switch circuit 26.

For example, when the word line driver RMAIN1 (FIG. 10) in the first memory cell block is selected, the potential VpgmH (e.g., about 18 to 22 V) is transferred to the output node TransferG1. When the word line driver RMAIN2 (FIG. 12) in the second memory cell block is selected, the potential VpgmH is transferred to the output node TransferG2.

As a result, the gates of the transistors for transfer HNt1, HNt2, . . . HNt16 have a sufficiently high potential, and the potentials of the signal lines CG1, CG2, . . . CG16 are transferred to the word lines (control gate lines) WL1, WL2, . . . WL16 via the transistors for transfer HNt1, HNt2, . . . HNt16 without so-called threshold drop.

Moreover, the potentials of the signal lines SGD, SGS are also transferred to the select gate lines SG1, SG2 via the transistors for transfer HN5, HN6.

Here, the potential of one signal line selected from the signal lines CG1, CG2, . . . CG16 is set to Vpgm (e.g., about 16 to 20 V) by the switch circuit (FIG. 1), and the potentials of the remaining unselected signal lines are set to Vpass (e.g., about 10 V) by the switch circuit (FIG. 1).

Moreover, the potential of the signal line SGD is set to Vdd, and the potential of SGS is set to Vss.

On the other hand, for the word line driver (FIGS. 10, 12) in the unselected memory cell block, the potentials RDECAD, RDECADS2 are transferred to the output nodes TransferG1, TransferG2 of the high-voltage switch circuit 26.

That is, for the word line driver (FIGS. 10, 12) in the unselected memory cell block, the output nodes TransferG1, TransferG2 are both set to the ground potential Vss.

As a result, the transfer transistors HNt1, HNt2, . . . HNt16 are turned off, and the word lines (control gate lines) WL1, WL2, . . . WL16 are set into the floating state. The select gate lines SG1, SG2 are grounded by the signal lines SGS, SGD.

The operation timing of FIG. 20 will be described in detail. Additionally, it is assumed that the memory cell to be connected to the bit line BLe is selected in the present example.

On the row side (word line control circuit side), first BSTON turns to “H” in time PCLK1. At this time, in the selected memory cell block, Vdd (RDECAD or RDECADS2) is transferred to the output node (TransferG1 or TransferG2) of the high-voltage switch circuit in the word line driver.

Moreover, BSTON turns to “L” in time PCLK3, and VRDEC indicates VpgmH in time PCLK4. Therefore, in the selected memory cell block, the potential of the output node (TransferG1 or TransferG2) of the high-voltage switch circuit in the word line driver rises to VpgmH.

On the other hand, on the column side (data circuit side), BLC and BLCLMP indicate Vsg (e.g., about 6 V) in time PCLK1, and BLSe indicates VsgHH in time PCLK4. As a result, the latch circuit LATCH is electrically connected to the bit line BLe, and the data of the latch circuit LATCH is transferred to the bit line BLe.

For example, Vss is transferred (the node Naij of the latch circuit indicates Vss) to the bit line (selected bit line) BLe connected to the memory cell subjected to the “01” writing from the latch circuit LATCH. Moreover, Vdd is transferred (the node Naij of the latch circuit indicates Vdd) to the bit line (selected bit line) BLe connected to the memory cell subjected to the “11” writing (the erase state is maintained) from the latch circuit LATCH.

Additionally, the potential of the unselected bit line BLo is set to Vdd. That is, BLSo is constantly set to Vss, BIASo indicates VsgHH and BLCRL indicates Vdd in time PCLK4, and therefore Vdd is transferred to the bit line BLo from BLCRL.

Moreover, after the charging of the bit lines BLe, BLo is completed, in time PCLK5, the unselected word line CG unselect is set to Vpass (e.g., about 10 V). Furthermore, in time PCLK6, the selected word line CG select is set to Vpgmm (e.g., about 16 to 20 V).

Since the selected bit line BLe connected to the memory cell subjected to the “10” writing indicates Vss, the channel potential of the memory cell also indicates Vss. Therefore, in the memory cell subjected to the “10” writing, the high electric field is applied between the channel and the control gate electrode (the selected word line), and the electron is implanted into the floating gate electrode from the channel.

The unselected bit line BLe connected to the memory cell subjected to “11” writing indicates Vdd, and the select gate line SG1 also indicates Vdd. That is, a select transistor connected between the memory cell subjected to the “11” writing and the bit line is cut off.

Therefore, when the potential of the unselected word line indicates Vpass, and the potential of the selected word line indicates Vpgm, the channel potential of the memory cell performing “11” writing rises to about 8 V by the capacity coupling between the channel of the memory cell performing the “11” writing and the word line.

As a result, in the memory cell subjected to the “11” writing, the high electric field is not applied between the channel and the control gate electrode (the selected word line), and the electron is not implanted in the floating gate electrode from the channel (The “01” writing is inhibited. That is, the erase state is maintained).

Additionally, the potential of the bit line BLo indicates Vdd. Therefore, when the select gate line SG1 indicates Vdd, the select transistor connected to the bit line BLo is cut off. That is, in the unselected memory cell connected to the bit line BLo, the channel potential rises, and the “01” writing is inhibited.

Moreover, the write pulse is applied to the selected word line in a period from time PCLK6 to time CCLK10/PRCV1.

Furthermore, the charge of the selected word line is discharged in time PRCV1, and the potential of the selected word line is changed to Vss from Vpgm. Moreover, in time PRCV2, the charge of the unselected word line is discharged, and the unselected word line is changed to Vss from a transfer potential Vpass. Furthermore, the charges of the bit lines BLe, BLo are discharged in time PRCV3.

2.-1.-2. “VERIFY01”

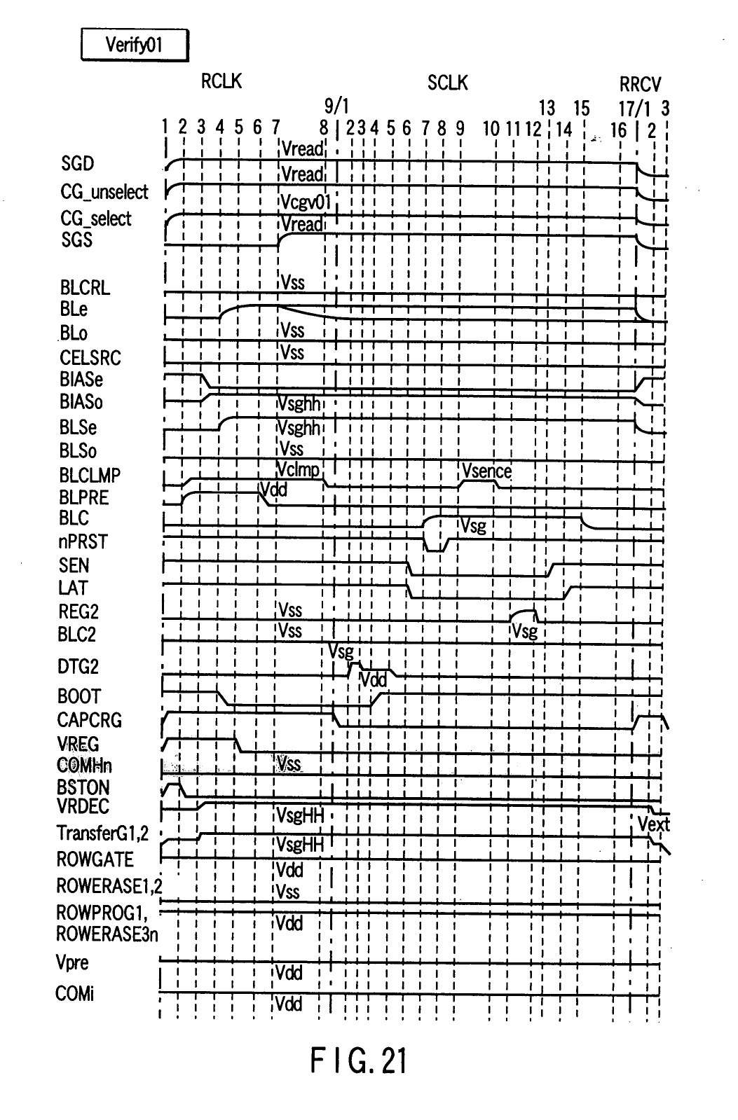

FIG. 21 shows the operation timing of the “01” verify read. In the “01” verify read (VERIFY01), after the bit line is pre-charged, the selected word line is set to Vcgv01 (e.g., about 1.75 V), the potential change of the bit line is detected, and the data of the memory cell is read.

Here, since the write data is already latched in the latch circuit LATCH (FIG. 2), the read data has to be prevented from colliding with the write data.

To solve the problem, while the pre-charging of the bit line, and the discharging (the reading of cell data) are performed, the write data stored in the latch circuit LATCH is transferred to a node CAP2ij, and temporarily stored.

A concrete operation is as follows.

First, CAPCRG and VREG are set to Vdd in time RCLK1, and BOOT is set to Vss in time RCLK4. When VREG indicates Vss in time RCLK5, the node CAP2ij is reset to Vss. Additionally, in this case, DTG2 indicates Vss.

In time RCLK9/SCLK1, CAPCRG indicates Vss, and the node CAP2ij is in the floating state. Thereafter, the DTG2 indicates Vsg (e.g., about 4.5 V) in time SCLK2, and the write data latched in the latch circuit LATCH is transferred to the node CAP2ij via the MOS transistor TN2 and temporarily stored.

That is, when the write data of the even-numbered page is “0” (the “01” writing is performed), the node Naij of the latch circuit LATCH indicates “L”, and the node CAP2ij indicates Vss.

Moreover, when the write data of the even-numbered page is “1” (the “11” writing is performed), the node Naij of the latch circuit LATCH indicates “H”, and the node CAP2ij indicates Vdd.

Thereafter, DTG2 indicates Vdd in time SCLK3, and BOOT indicates Vdd in time SCLK4.

In this case, when the write data of the even-numbered page is “0” (the “01” writing is performed), the node CAP2ij still indicates Vss. Moreover, when the write data of the even-numbered page is “1” (the “11” writing is performed), the potential of the node CAP2ij is booted by a capacitor DLN (C2), and therefore rises to about 3.5 V from Vdd (e.g., about 2.3 V).

Thereafter, in time SCLK5, DTG2 indicates Vss, and the node CAP2ij is electrically disconnected from the latch circuit LATCH.

On the other hand, the data of the memory cell is read in the bit line BLe similarly as the usual read operation (READ01).

That is, after the bit line BLe is pre-charged, SGS indicates Vread, and the potential of the bit line BLe changes in accordance with the data of the memory cell in time RCLK7.

For example, in the selected memory cell subjected to the “11” writing (the selected memory cell in which the write data of the even-numbered page is “1”), the selected memory cell is in the on state by Vcgv01, the charge of the bit line BLe is discharged, and the bit line BLe indicates a potential of 0.3 V or less.

Moreover, in the selected memory cell subjected to the “01” writing (the selected memory cell in which the write data of the even-numbered page is “0”), when “01” is insufficiently written, the selected memory cell is in the on state by Vcgv01, the charge of the bit line BLe is discharged, and the bit line BLe indicates a potential of 0.3 V or less.

Furthermore, in the selected memory cell subjected to the “01” writing (the selected memory cell in which the write data of the even-numbered page is “0”), when “01” is sufficiently written, the selected memory cell is in the off state by Vcgv01, the charge of the bit line BLe is not discharged, and the bit line BLe maintains 0.8 V.

In this case, in time SCLK6, both SEN and LAT indicate “L”, both SENB and LATB indicate “H”, and the latch circuit LATCH in the data circuit, that is, the clocked inverters CINV1, CINV2 are in the inoperative state.

Additionally, in this case, the write data is already transferred to the node CAP2ij, and the node CAP2ij is electrically disconnected from the latch circuit LATCH in the time SCLK5.

In time SCLK7, BLC indicates Vsg (e.g., about 4.5 V), nPRST indicates “L”, the sense node (DTNij) is thereby charged, and the sense node indicates Vdd (Naij also indicates Vdd). Moreover, when nPRST indicates Vdd in time SCLK8, the sense node (DTNij) is in the floating state.

When BLCLMP indicates Vsense (e.g., about 1.6 V) in time SCLK9, the data of the memory cell read in the bit line BLe is transferred to the sense node (DTNij).

That is, for the memory cell in which the data is insufficiently written in the selected memory cell subjected to the “11” writing (the selected memory cell in which the write data of the even-numbered page is “1”), and the selected memory cell subjected to the “01” writing (the selected memory cell which the write data of the even-numbered page is “0”), the bit line BLe indicates a potential of 0.3 V or less. Therefore, the potential of the sense node (DTNij) drops to 0.3 V or less.

For the memory cell in which the data is sufficiently written in the selected memory cells subjected to “01” writing (the selected memory cell in which the write data of the even-numbered page is “0”), the potential of the bit line BLe maintains 0.8 V, the MOS transistor TN9 for clamping cuts off, and the sense node (DTNij) maintains Vdd.

In time SCLK10, the potential of the sense node (DTNij) is as shown in “Verify01: after BL discharge” in Table 2.

TABLE 2
Verify read of even-numbered page

| | “11” | “01” write | | |
|---|---|---|---|---|
| | write | <Fail> | <Pass> | |
| Latch node N1 | H | L | L | [After data load] |
| Sense node Ns | L | L | H | [First verify read |
| | | | | Verify01: After BL |
| | | | | discharge] |
| Sense node Ns | H | L | H | [First verify read |
| | | | | Verify01: After |
| | | | | sense node charge] |
| Latch node N1 | H | L | H | [Rewrite data] |

Thereafter, different from the usual read operation (READ01), in the “01” verify read, REG2 indicates Vsg, and the MOS transistor TN6 is in the on state in time SCLK11.

When the “11” writing is performed (the write data of the even-numbered page is “1”), “H” is latched in the node CAP2ij, and therefore the MOS transistor TN1 has the on state. That is, COMi (set to Vdd) and sense node (DTNij) are short-circuited. As a result, the sense node (DTNij) indicates Vdd.

When the “01” writing is performed (the write data of the even-numbered page is “0”), “L” is latched in the node CAP2ij, and therefore the MOS transistor TN1 has the off state. That is, since COMi (set to Vdd) and sense node (DTNij) are electrically disconnected, the potential of the sense node (DTNij) is unchanged.

Therefore, the potential of the sense node (DTNij) in time SCLK12 is as shown in “Verify01: after sense node charging” in Table 2.

Thereafter, in time SCLK13, SEN indicates Vdd, SENB indicates Vss, and the clocked inverter CINV1 is set to the operative state, and senses the potential of the sense node (DTNij).

As shown in Table 2, while the “11” writing and “01” writing are sufficient, the respective sense nodes (DTNij) indicate “H”, and the output node Nbij of the clocked inverter CINV1 indicates Vss. Moreover, when the “01” writing is insufficient, the sense node (DTNij) indicates “L”, and the output node Nbij of the clocked inverter CINV1 indicates Vdd.

Thereafter, in time SCLK14, LAT indicates Vdd, LATB indicates Vss, and the read data is latched in the latch circuit LATCH.

That is, while the “11” writing and “01” writing are sufficient, the node Naij indicates Vdd, and the node Nbij indicates Vss. When the “01” writing is insufficient, the node Naij indicates Vss, and the node Nbij indicates Vdd.

The data of the latch circuit LATCH in a timing in which the “01” verify read is completed is as shown in “rewrite data” in Table 2.

Additionally, the data of the latch circuit LATCH is subsequently used as new write data (even-numbered page data). That is, in “VERIFY02”, the data latched in the node CAP2ij disappears in the program completion detection described later.

In this manner, when the write data (even-numbered page data) is “0” (i.e., “L”), the writing (“01” writing) is executed, the data is sufficiently written, then the write data is changed to “1” (“H”) from “0” (“L”), and thereafter the writing (“01” writing) is prevented from being performed.

Additionally, in the above-described “01” verify read, as a reason why BOOT is changed to Vdd from Vss in the time SCLK4 and the potential of the node CAP2ij is booted to about 4 V during the “11” writing, when REG2 is set to Vsg in time SCLK11, the sense node (DTNij) is set to Vdd without any drop of the threshold value by the threshold voltage of the N-channel MOS transistor TN1.

If the potential of the node CAP2ij for the “11” writing is Vdd (e.g., about 2.3 V), the sense node (DTNij) rises only to about 1.5 V in the time SCLK11.

It is considered that 1.5 V of the sense node can be regarded as “H” in the logic operation. In this case, there is a disadvantage that a rush-current flows in the clocked inverter CINV1 during the sensing (SCLK13). There are 4000, 8000, or 16000 data circuits in the chip. Therefore, when the rush-current flows through the clocked inverter CINV1 in all the data circuits, a large current of about 100 mA flows in total in the chip.

As a result, problems occur that the in-chip power potential Vdd drops and power consumption largely increases.

As in the present example, when the potential of the node CAP2ij in the “11” writing is boosted to about 4 V, the sense node (DTNij) can be charged without any drop of the threshold value in the MOS transistor TN1, and the above-described drop of the power potential Vdd and the increase of the power consumption can be prevented.

The above-described operation during the “01” verify read is as follows.

That is, after the write data latched in the latch circuit LATCH is transferred to a DRAM cell, the read data is transferred to the sense node (DTNij).

In this case, the data latched in the DRAM cell indicates “H”, that is, indicates that the “11” writing or the “01” writing is sufficient, the sense node (DTNij) indicates “H” irrespective of the read data.

Only when the data latched in the DRAM cell indicates “L”, that is, the insufficiency of the “01” writing, the data is transferred to the sense node (DTNij) in accordance with the state of the memory cell.

For example, when the state of the memory cell does not reach the “01” state (“01” is insufficient), the sense node (DTNij) indicates “L”. When the state of the memory cell reaches the “01” state (“01” is sufficient), the sense node (DTNij) indicates “H”.

Moreover, the data of the sense node (DTNij) is latched in the latch circuit LATCH.

Additionally, thereafter, the next application of the write pulse and the next “01” verify read are performed based on the data latched in the latch circuit LATCH.

2.-1.-3. “Program Completion Detection”

After “VERIFY01”, the “program completion detection” operation is performed so as to detect whether or not “01” is sufficiently written with respect to all the memory cells subjected to the “01” writing. This detection is performed based on the data (see Table 5) latched in the latch circuit LATCH by “VERIFY01”. Moreover, when the “01” writing is not sufficient, the re-writing (the application of the write pulse) is executed. When the “01” writing is sufficient, the writing (the application of the write pulse) is completed.

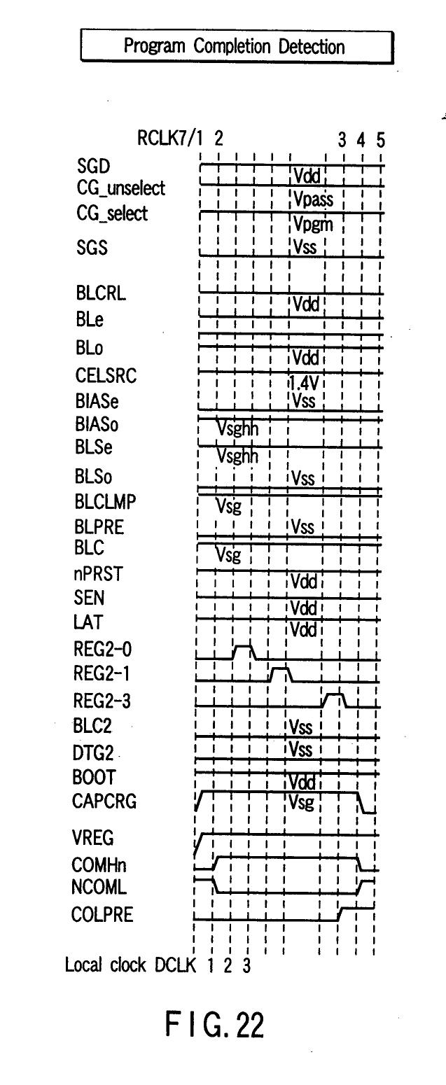

FIG. 22 shows the operation timing of the “program completion detection”. In the “program completion detection”, the collective detection circuit of FIG. 5 is used.

Additionally, after “VERIFY01” ends, the next “application of the write pulse” is immediately performed, and the “program completion detection” is executed in parallel to the “application of the write pulse”.

Therefore, the time PCLK7/CCLK1 is the same as the time PCLK7/CCLK1 in FIG. 22.

Moreover, in the “program completion detection” in the write operation of the even-numbered page data, the time CCLK5 corresponds to the time CCLK9. That is, the operation up to the time CCLK5 is executed, and the operation between the time CCLK5 and CCLK9 is omitted.

Additionally, the operation between the time CCLK5 and CCLK9 is executed in the “program completion detection” in the write operation of the odd-numbered page data described later.

First, in time CCLK1, CAPCRG indicates Vsg, VREG indicates Vdd, the node CAP2ij is charged, and the potential of the node CAP2ij indicates Vdd (DTG2 indicates Vss).

In this case, in “VERIFY01”, the data (even-numbered page data) latched in the node CAP2ij disappears. However, since the new write data is already latched in the latch circuit LATCH in the “VERIFY01”, the write data does not completely disappear.

That is, when the write data (the even-numbered page data) is “0” (i.e., “L”), the writing (“01” writing) is executed. When the data is sufficiently written, the write data changes to “1” from “0”, and thereafter the writing (“01” writing) is not performed.

Thereafter, in time CCLK2 (DCLK1), COMHn (FIG. 5) changes to Vdd from Vss, and NCOML (FIG. 5) changes to Vss from Vdd. Then, COMi1 and COMi2 indicate Vdd and have the floating state, and NCOM indicates Vss and has the floating state.

In time DCLK2, for example, REG2-0 indicates Vdd. In this case, in FIG. 5, first and fifth data circuits are selected, and REG2 in the first data circuit and REG2 in the fifth data circuit indicate Vdd.

In both the first and fifth data circuits, when the data of the node Naij of the latch circuit LATCH indicates Vdd (FIG. 2), that is, when the “11” writing (writing unselected) or “01” writing is sufficient, the sense node DTNij maintains Vdd. Therefore, the MOS transistor TN6 (FIG. 2) has the off state, and COMi1 and COMi2 maintain Vdd. Therefore, NCOM maintains Vss.

On the other hand, in at least one of the first and fifth data circuits, when the data of the node Naij of the latch circuit LATCH indicates Vss (see Table 5), that is, when the “01” writing is insufficient, the sense node DTNij maintains Vss. Therefore, the MOS transistor TN6 (FIG. 2) has the on state, and COMi1 or COMi2 changes to Vss from Vdd. Therefore, NCOM changes to Vdd from Vss.

Similarly, REG2-1, REG2-2, REG2-3 successively indicate Vdd. That is, when REG2-1 indicates Vdd, the second and sixth data circuits are selected. When REG2-2 indicates Vdd, the third and seventh data circuits are selected. When REG2-3 indicates Vdd, the fourth and eighth data circuits are selected. In the data circuit, the state of the latch circuit LATCH, that is, the sufficiency/insufficiency of the “01” writing is detected.

As a result, when data indicating sufficiency of the “11” writing (writing unselected) or the “01” writing is outputted from all the first to eighth data circuits, NCOM indicates Vss in the time CCLK3. Moreover, when the data indicating the insufficiency of the “10” writing is outputted from at least one of the first to eighth data circuits, NCOM indicates Vss in the time CCLK3.

Moreover, all the columns are connected in parallel to the FLAG node (FIG. 5). Therefore, the FLAG node is set beforehand to Vdd and the floating state, COLPRE is set to Vdd in time CCLK3, and the MOS transistor TN17 (FIG. 5) is turned on.

In this case, when the data indicating the sufficiency of the “11” writing (writing unselected) or the “01” writing is outputted from all the data circuits corresponding to all the columns, NCOM indicates Vss, and the MOS transistor TN16 (FIG. 5) has the off state. Therefore, the FLAG node maintains Vdd.

Moreover, when the data indicating the insufficiency of the “01” writing is outputted from at least one of all the data circuits corresponding to all the columns, NCOM indicates Vdd, and therefore the MOS transistor TN16 (FIG. 5) has the on state. Therefore, the FLAG node changes to Vss from Vdd.

In this case, when there is no memory cell subjected to the insufficient “01” writing in all the columns, the FLAG node maintains Vdd. When there is a memory cell subjected to the insufficient “01” writing in at least one column, the FLAG node indicates Vss.

Therefore, when the level of the FLAG node is detected, and the FLAG node indicates Vdd, that is, when the column (memory cell) subjected to the insufficient “01” writing is not present, a write routine of the even-numbered page data is completed. Moreover, when the FLAG node indicates Vss, that is, when there is at least one column (memory cell) subjected to the insufficient “01” writing, the “01” verify read is performed again, and thereafter the program completion detection is performed in parallel to the application of the write pulse.

Additionally, in a defective column in which a defective cell is replaced with a spare cell by the redundancy circuit (eight columns are regarded as a replacement unit), the fuse element of the collective detection circuit 10 of FIG. 5 is disconnected. Therefore, the FLAG node is prevented from indicating Vss because of the defective column.

2.-2. Write Operation of Odd-Numbered Page Data

First, an outline of the write operation of the odd-numbered page data (a flow of the operation will be described. Thereafter, a concrete circuit operation (operation timing) will be described.

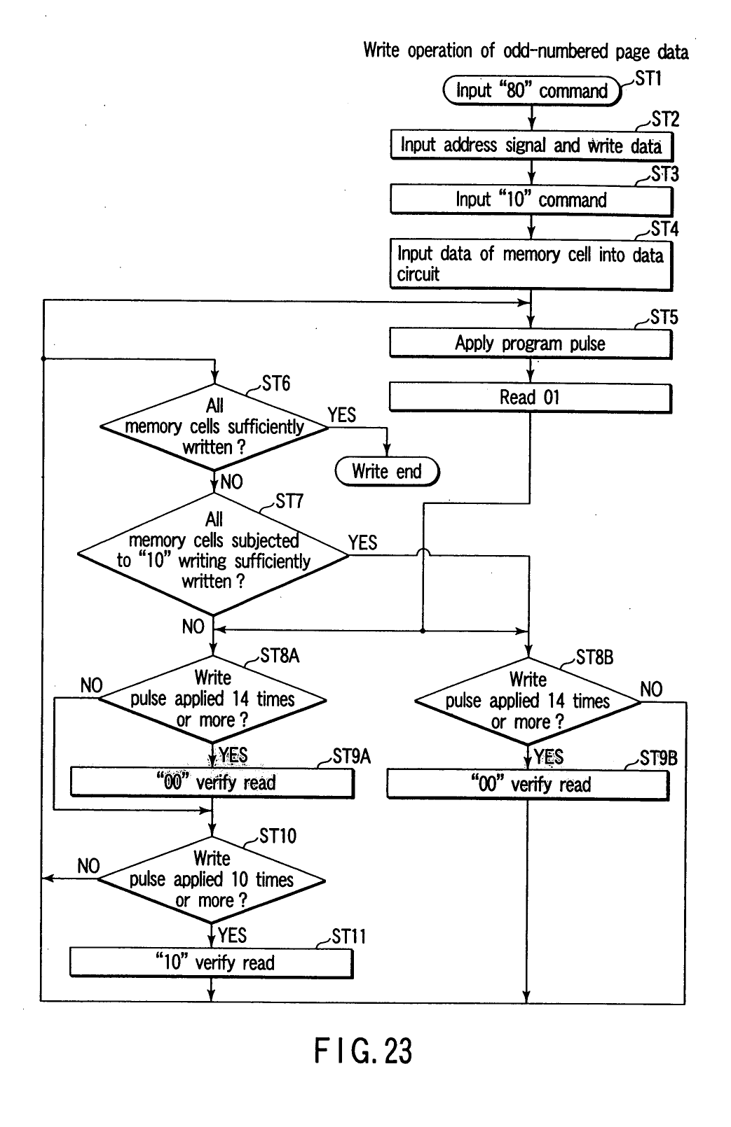

FIG. 23 shows the outline of the write operation of the odd-numbered page data. Before the odd-numbered page data is written, the above-described even-numbered page data is already written as described above, and therefore the memory cell is in the “11” state or the “01” state.

First, for example, a “80 (hexadecimal)” command is inputted in the chip. Thereafter, an address signal is inputted in the chip, and the write data of the odd-numbered page is inputted in the chip. The write data is inputted into the latch circuit LATCH (FIG. 2) in the data circuit from the outside of the chip via the I/O lines IOj, nIOj in the chip (steps ST1 and ST2).

Subsequently, for example, a “10 (hexagonal)” command is inputted in the chip. Then, first the even-numbered page data stored in the memory cell is read out (internal data load). Thereafter, the write pulse is applied based on the odd-numbered page data inputted from the outside of the chip (write data) and the even-numbered page data read from the memory cell (steps ST3 to ST5).

Here, in this example, to reduce the write time (to raise the speed of the writing), a sequence (parallel processing) of applying the write pulse n-times (step ST5), simultaneously applying a n−1-th write pulse, and detecting whether or not “10” and “00” are sufficiently written is used (steps ST5 to ST7).

Additionally, as described hereinafter, as another means for achieving the reduction of the write time (the raising of the write speed), in the present example, a sequence of gradually raising the write potential (size of the write pulse), and not performing the “10” verify read and “00” verify read in the beginning of the write operation is employed.

Therefore, in the present example, when the “10” verify read is not performed, it is not detected whether the “10” is sufficiently written. Moreover, when the “00” verify read is not performed, it is not detected whether the “00” is sufficiently written.

Additionally, the “10” verify read (VERIFY10) means that the data of the memory cell is read with the verify read potential Vcgv01 (FIG. 13) in order to verify whether or not the data “10” is sufficiently written in the memory cell subjected to the “10” writing.

Moreover, the “00” verify read (VERIFY00) means that the data of the memory cell is read with the verify read potential Vcgv00 (FIG. 13) in order to verify whether or not the data “00” is sufficiently written in the memory cell subjected to the “00” writing.

When the number of applications of the write pulse into the word line is not more than a first predetermined number (e.g., nine times), the “10” verify read is omitted, and the write pulse is continuously applied (step ST10). When the number of applications of the write pulse into the word line is not more than a second predetermined number (e.g., 13 times), the “00” verify read is omitted (steps ST8A, 8B).

The number of omissions of the “00” verify read is more than the number of omissions of the “10” verify read, because the threshold voltage is higher and it is more difficult to read the data in the “00” state. When the verify read is omitted, the speed of the entire writing can be raised.

In this example, the write potential (the level of the write pulse) is set to the initial value, and the application of the write pulse is started. Thereafter, every time the write pulse is applied, the write potential applied to the word line is gradually raised by each predetermined value (e.g., about 0.2 V).

For example, when the write potential is raised by each about 0.2 V, ideally, the width of the threshold voltage distribution of the memory cell in the “00” and “10” write states can be set to about 0.2 V. In the actual operation, the width of the threshold voltage distribution of the memory cell in the “10” and “00” write states is about 0.4 V by the so-called array noise generated in the verify read.

From the start of the write operation until, for example, nine applications of the write pulse (during the omission of the verify read), the voltage of the write pulse is sufficiently low, and set to a sufficiently low value to completely write “10”. Moreover, from the start of the write operation until, for example, 13 applications of the write pulse, the write potential is set to a sufficiently low value to completely write “00”.

Therefore, excessive writing (the writing with a threshold voltage exceeding Vcgr00) is not performed with respect to the memory cell subjected to the “10” or “00” writing.

The verify read is omitted in this manner in the beginning of the writing. In the above-described technique of gradually raising the write potential, there is little possibility that the predetermined data is sufficiently written in the memory cell in the beginning of the writing. Therefore, in order to raise the write speed, it is more advantageous to omit the verify read than to perform the verify read.

Moreover, the pulse having a low write potential is applied to the word line in the beginning of the writing, and the write potential is gradually raised for each application of the pulse, so that the electron is implanted in the floating gate electrode little by little, and finally the predetermined amount of electrons are accumulated in the floating gate electrode.

In this case, as compared with the case in which the predetermined amount of electrons are implanted in the floating gate electrode once with one write pulse, the electric field applied to the tunnel oxide film of the memory cell with one write pulse is low, and reliability of the tunnel oxide film is enhanced.

Moreover, the write potential (the level of the write pulse) is gradually raised to a high value from a low value. That is, when the write potential is gradually raised, the width of the threshold voltage distribution of the memory cell can be small as compared with the case in which the initial write potential is set to a high value and the write potential is gradually lowered.

When the number of applications of the write pulse with respect to the word line is, for example, ten or more, to verify whether or not the data “01” is sufficiently written with respect to the memory cell subjected to the “10” writing, the write pulse is applied to the word line, and subsequently the “10” verify read is performed (steps ST10 and ST11).

Moreover, when the number of applications of the write pulse with respect to the word line is, for example, 14 or more, to verify whether or not the data “00” is sufficiently written with respect to the memory cell subjected to the “00” writing, the write pulse is applied to the word line, and subsequently the “00” verify read is performed (steps ST8A and 9A and ST8B and 9B).

The data read from the memory cell by the “10” verify read indicates whether the “10” writing has been sufficiently performed, and the data is stored in the latch circuit LATCH in the data circuit present in the column as a “10” write object.

The data read from the memory cell by the “00” verify read indicates whether the “00” writing has been sufficiently performed, and the data is stored in the latch circuit LATCH in the data circuit present in the column as a “00” write object.

Thereafter, the sufficiently written memory cell is not written. The sufficiently written memory cell is additionally written. As a result of the verify read, an operation of detecting whether there is the insufficiently written memory cell. The operation may be performed after the verify read, however is performed during the application of the program pulse in order to reduce the operation time. When the data is sufficiently written in all the columns, the writing ends.

Thereafter, in parallel to the operation of applying the next write pulse to the word line (step ST5), the operation (program completion detection) of verifying whether or not the “10” or “00” writing has sufficiently been performed by the previous write pulse based on the data of the latch circuit LATCH is executed (steps ST6 and ST7).

Concretely, in the write operation of the odd-numbered page data, as shown in FIG. 15, there are four types of writing: “11”, “10”, “01”, and “00”. In the “11” writing and “01” writing, the state of the memory cell in which the even-numbered page data is written is maintained. Moreover, the “10” writing means that the threshold voltage is raised by the write pulse, and the “11” state is changed to the “10” state. The “00” writing means that the threshold voltage is raised by the write pulse, and the “01” state is changed to the “00” state.

When the predetermined data “11”, “10”, “01”, “00” are sufficiently written in all the selected memory cells (columns) (in actual, when the data “00” and “10” are sufficiently written in the memory cell as the object of the “00”, “10” writing), the write operation of the even-numbered page data is completed (step ST6).

When the predetermined data “11”, “10”, “01”, “00” are not sufficiently written in at least one selected memory cell (column) (in actual, when the data “00” and “10” are not sufficiently written in the memory cell as the object of the “00”, “10” writing), the “00” verify read, “10” verify read and application of the write pulse are continuously performed (steps ST5 to ST11).

Here, in the present example, after “10” is sufficiently written in all the memory cells as the object of the “10” writing, the “00” verify read is not performed. Thereafter, only the “10” verify read and program completion detection are performed (route of the steps ST7, ST8B, ST9B).

As a reason for this sequence, since the “10” writing usually ends before the “00” writing (the threshold voltage in the “10” state is lower than the threshold voltage in the “00” state), the “00” verify read after the end of the “10” writing is omitted, and the write time is reduced (the write speed is raised).

Additionally, in this example, the operation (program completion detection) of detecting the sufficiency/insufficiency of the writing is performed in parallel to the operation of applying the write pulse to the word line. For example, the program completion detection is performed immediately after the “00” verify read or the “10” verify read. Thereafter, when the result of the program completion detection is insufficient, the application of the write pulse may be performed again.

Moreover, thereafter, the application of the write pulse is not performed with respect to the sufficiently written memory cell, the application of the write pulse (re-writing) is continuously performed only with respect to the insufficiently written memory cell, and excessive writing may not be performed with respect to the memory cell having a satisfactory writing property.

The outline of the write operation of the odd-numbered page data has been described above.

As described above, the write operation of the odd-numbered page data is constituted of the application of the write pulse, the reading of the even-numbered page data stored in the memory cell (internal data load), “10” verify read (VERIFY10), “00” verify read (VERIFY00), program completion detection and “00” program completion detection.

In the following, these operations will successively be described in detail.

2.-2.-1. Write Pulse Application

The write pulse application is performed in the same operation timing as that of the application of the write pulse in the even-numbered page data as shown in FIG. 20.

In the “10” writing and “00” writing, as shown in Table 3, since the node Naij of the latch circuit LATCH indicates “L”, the bit line indicates Vss. Therefore, the high electric field is applied to the tunnel oxide film of the selected memory cell, the electron is implanted in the floating gate electrode by the FN tunnel effect, and the writing is performed.

TABLE 3
Verify read of odd-numbered page

| | “11” | “10” write | | “01” | “00” write | | |
|---|---|---|---|---|---|---|---|
| | write | <Fail> | <Pass> | write | <Fail> | <Pass> | |
| Latch node | H | L | L | H | L | L | [After data load] |
| N1 | | | | | | | |
| Sense node | L | L | L | H | H | H | [Read01: After BL discharge] |
| DTNij | | | | | | | |
| Latch node | L | L | L | H | H | H | [Read01: After BL discharge] |
| N1 | | | | | | | |
| BL level | H | H | H | L | L | L | [Verify10A: After BL precharge] |
| Sense node | L | L | H | L | L | L | [Verify10A: After BL discharge] |
| DTNij | | | | | | | |
| Sense node | H | L | H | H | L | L | [Verify10A: After sense node |
| DTNij | | | | | | | recharge] |
| Latch node | H | L | H | H | L | L | [Verify10A: After sense node |
| N1 | | | | | | | recharge] |
| Sense node | L | L | L | L | L | H | [Verify00: After BL discharge] |
| DTNij | | | | | | | |
| Sense node | H | L | H | H | L | H | [Verify00: After sense node |
| DTNij | | | | | | | recharge] |
| Latch node | H | L | H | H | L | H | Rewrite data |
| N1 | | | | | | | |

In the “11” writing and “01” writing (writing unselected), as shown in Table 3, since the node Naij of the latch circuit LATCH indicates “H”, the bit line indicates Vdd. Therefore, the high electric field is not applied to the tunnel oxide film of the selected memory cell, and the state of the memory cell is unchanged (the “11” state or the “01” state is held).

2.-2.-2. Reading of Even-Numbered Page Data “READ01”

As shown in Table 3, “READ01” is performed in the beginning of the verify read. The operation is similar to the operation of “READ01” described above with reference to FIG. 13. As a result of “READ01”, the data of the even-numbered page of the memory cell is stored in the latch circuit LATCH. That is, when the memory cell is “11” or “10”, a node N1 (Naij) indicates “L”. When the memory cell is “01” or “00”, the node N1 (Naij) indicates “H”.

In this case, the write data of the odd-numbered page stored in the latch circuit LATCH is transferred to the node CAP2ij, and temporarily stored. Thereby, the read data is prevented from colliding with the odd-numbered page data. The verify operation “VERIFY10A” is continuously performed.

2.-2.-3. “VERIFY10A”

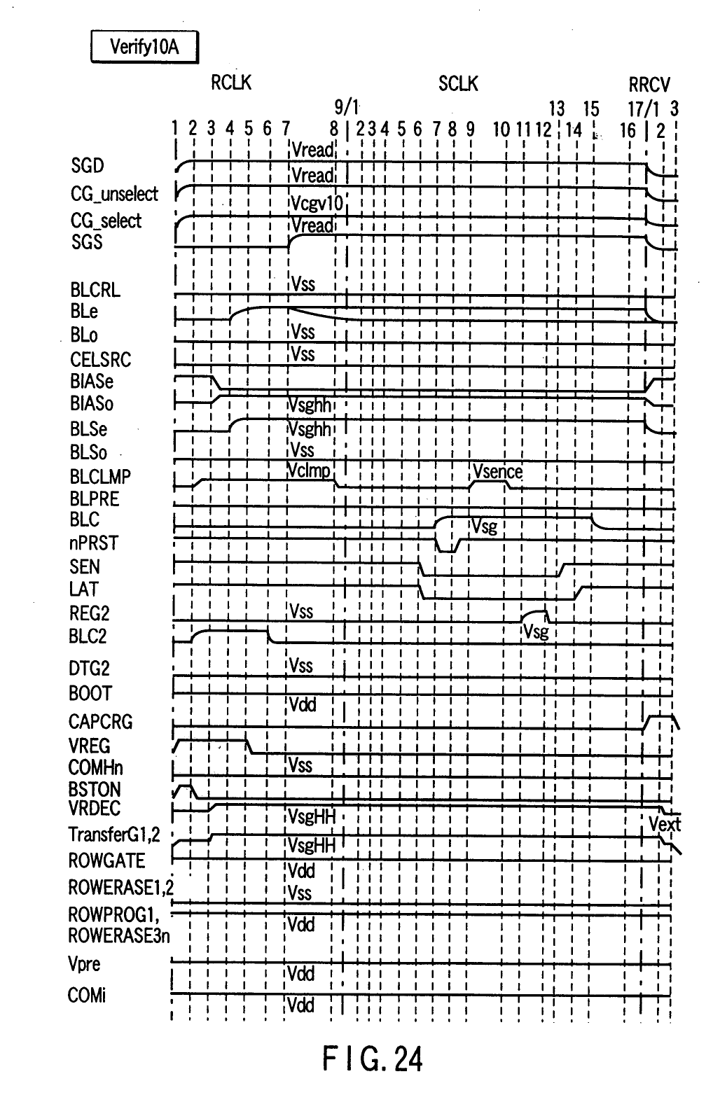

FIG. 24 shows the operation timing of the verify operation “VERIFY10A”.

In “VERIFY10A”, when the latch circuit holds the write data other than “10”, the write data is held as it is. When the “10” writing is sufficiently performed, the content of the latch circuit indicates the writing unselected.

When “00” is sufficiently written, the data of the latch circuit is set to a writing unselected state during “VERIFY00” after the “VERIFY10A”, and therefore the write state is held in the “VERIFY10A” (i.e., the node Naij indicates Vss).

The operation is characteristic in that the bit line pre-charge potential is changed based on the even-numbered page data held in the latch circuit. That is, when a control pulse BLC2 indicates Vdd in the time RCLK2 in FIG. 21, the bit line is pre-charged based on the data stored in the latch circuit.

As shown in “VERIFY10A: BL pre-charge” in Table 3, the bit line is pre-charged at 0.8 V during the “11”, “10” writing, and the bit line is pre-charged at 0 V during the “01”, “00” writing. In other words, the potential is held in the bit line in accordance with the data stored in the latch circuit.

Thereafter, the selected word line is set to Vcgv10 (about 0.15 V), and the discharging of the bit line is performed. Here, a characteristic respect lies in the data is not transferred to the node CAP2ij from the latch circuit, and the write data of the odd-numbered page transferred during the “READ01” is held in CAP2ij.

When the “11”, “10”, “01”, and “00” writing is insufficient after the bit line discharging, the bit line indicates “L”. When the “10” writing is sufficient, the bit line keeps 0.8 V.

Thereafter, in the time SCLK6, both SEN and LAT turn to “L”, and both SENB and LATB turn to “H”. The clocked inverters CINV1, CINV2 in the latch circuit LATCH are in the inoperative state.

Subsequently, in the time SCLK7, when BLC indicates Vsg (about 4.5 V), and nPRST indicates “L”, the sense node (DTNij) is charged, and the sense node indicates Vdd. Additionally, Naij also indicates Vdd.

Moreover, when nPRST indicates Vdd in the time SCLK8, the sense node (DTNij) is set into the floating state.

When BLCLMP indicate Vsense (e.g., about 1.6 V) in the time SCLK9, the data of the memory cell read in the bit line is transferred to the sense node (DTNij).

That is, for the insufficiently written memory cell among the memory cells subjected to the “11”, “10”, “01”, and “00” writing, since the bit line indicates the potential of 0.3 V or less, the potential of the sense node (DTNij) also drops to the potential of 0.3 V or less.

On the other hand, for the sufficiently written memory cell among the memory cells subjected to the “10” writing, the bit line maintains a pre-charge potential of 0.8 V. Therefore, the MOS transistor for clamp TN9 cuts off, and the sense node (DTNij) maintains Vdd.

In the time SCLK10, the potential of the sense node (DTNij) is as shown in “VERIFY10A: after BL discharge” in Table 3.

Thereafter, in the time SCLK11, REG2 indicates Vsg, and the MOS transistor TN6 (FIG. 2) has the on state.

Here, when the “11”, “01” writing is performed (the odd-numbered page data is “1”), “H” is stored in the node CAP2ij, and therefore the MOS transistor TN1 (FIG. 2) has the on state. That is, COMi (set to Vdd) and the sense node (DTNij) are short-circuited. As a result, the sense node (DTNij) indicates Vdd.

Moreover, when the “10”, “00” writing is performed (the odd-numbered page data is “0”), “L” is stored in the node CAP2ij, and therefore the MOS transistor TN1 (FIG. 2) has the off state. That is, COMi (set to Vdd) and the sense node (DTNij) are electrically disconnected. The sense node is not charged, and the potential of the sense node (DTNij) is unchanged.

Therefore, the potential of the sense node (DTNij) in time SCLK12 is as shown in “VERIFY10A: after sense node re-charge” in Table 3.

Thereafter, in time SCLK13, SEN indicates Vdd, SENB indicates Vss, the clocked inverter CINV1 is set to the operative state, and therefore the potential of the sense node (DTNij) is sensed.

As a result, the node N1 (Naij) of the latch circuit is as shown in “VERIFY10A: after sense node re-charge” in Table 3. Subsequently, a verify operation “VERIFY00” is performed.

2.-2.-4. “VERIFY00”

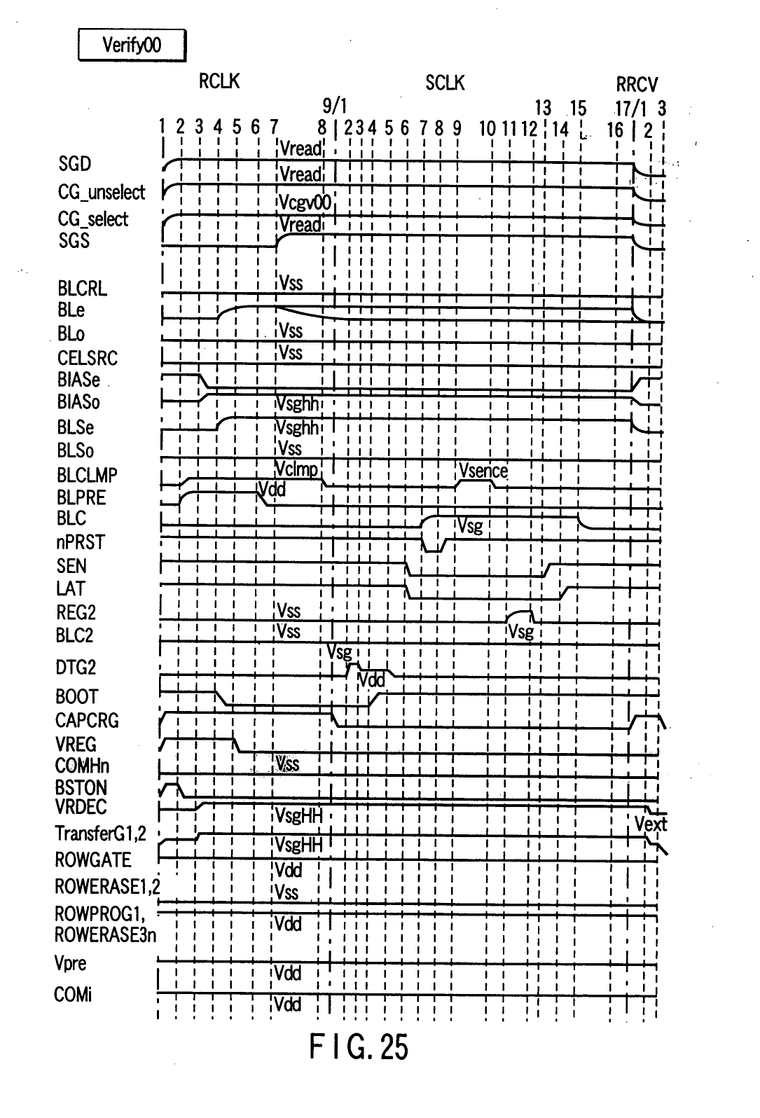

FIG. 25 shows the operation timing of “VERIFY00”. In “VERIFY00”, when the latch circuit holds the write data other than “00”, the write data is held as it is. When the “00” writing is sufficiently performed, the content of the latch circuit indicates the writing unselected.

In the “VERIFY10A” performed before “VERIFY00”, when “10” is judged to be insufficiently written, the latch circuit holds write selection data even after “VERIFY00”.

In the “VERIFY10A” performed before “VERIFY00”, when “10” is judged to be sufficiently written, the latch circuit holds write non-selection data even after “VERIFY00”.

In “VERIFY00”, after the bit line is pre-charged, the selected word line is set to Vcgv00 (e.g., about 1.45 V) shown in FIG. 10, and the bit line is discharged. In this case, the write data of the odd-numbered page held in the latch circuit LATCH is transferred to the node CAP2ij.

When the “11”, “10”, “01”, and “00” writing is insufficient after the discharging of the bit line, the bit line indicates “L”. When the “00” writing is sufficient, the bit line keeps 0.8 V.

Thereafter, in the time SCLK6, both SEN and LAT turn to “L”, and both SENB and LATB turn to “H”. The clocked inverters CINV1, CINV2 in the latch circuit LATCH are in the inoperative state.

Subsequently, in the time SCLK7, when BLC indicates Vsg (about 4.5 V), and nPRST indicates “L”, the sense node (DTNij) is charged, and the sense node indicates Vdd. Additionally, Naij also indicates Vdd.

Moreover, when nPRST indicates Vdd in the time SCLK8, the sense node (DTNij) is set into the floating state.

When BLCLMP indicate Vsense (e.g., about 1.6 V) in the time SCLK9, the data of the memory cell read in the bit line is transferred to the sense node (DTNij).

That is, for the insufficiently written memory cell among the memory cells subjected to the “11”, “01”, “10”, and “00” writing, since the bit line indicates the potential of 0.3 V or less, the potential of the sense node (DTNij) also drops to the potential of 0.3 V or less.

On the other hand, for the sufficiently written memory cell among the memory cells subjected to the “00” writing, the bit line maintains the pre-charge potential of 0.8 V. Therefore, the MOS transistor for clamp TN9 cuts off, and the sense node (DTNij) maintains Vdd.

In the time SCLK10, the potential of the sense node (DTNij) is as shown in “VERIFY00: after BL discharge” in Table 3.

Thereafter, in the time SCLK11, REG2 indicates Vsg, and the MOS transistor TN6 (FIG. 2) has the on state.

Here, when the “11”, “10”, “01” writing is insufficient, “H” is stored in the node CAP2ij, and therefore the MOS transistor TN1 (FIG. 2) has the on state. That is, COMi (set to Vdd) and the sense node (DTNij) are short-circuited. As a result, the sense node (DTNij) indicates Vdd.

On the other hand, when the “00” writing is insufficient, “L” is stored in the node CAP2ij, and therefore the MOS transistor TN1 (FIG. 2) has the off state. That is, COMi (set to Vdd) and the sense node (DTNij) are electrically disconnected. The sense node (DTNij) is not charged, and the potential of the sense node (DTNij) is unchanged.

Therefore, the potential of the sense node (DTNij) in the time SCLK12 is as shown in “VERIFY00: after sense node re-charge” in Table 3.

Thereafter, in the time SCLK13, SEN indicates Vdd, SENB indicates Vss, the clocked inverter CINV1 is set to the operative state, and therefore the potential of the sense node (DTNij) is sensed.

As a result, the rewrite data is stored in the latch circuit. The data is as shown in “rewrite data” in Table 3.

2.-2.-5. “Program Completion Detection”

After “VERIFY10” and “VERIFY00”, the “program completion detection” operation is performed to detect whether or not “10” or “00” is sufficiently written in all the memory cells subjected to the “10” or “00” writing. The operation is similar to that of the even-numbered page.

3. Erase Operation

During an erase operation, an erase potential Vera (e.g., about 20 V) is applied to the cell well.

Moreover, all the word lines in the selected memory cell block are set to the ground potential Vss. As a result, the high electric field is applied to the tunnel oxide films of the memory cells in the selected memory cell block, the electrons in the floating gate electrode are discharged to the channel (cell well), and the threshold voltage of the memory cell drops.

All the word lines in the unselected memory cell block are set into the floating state. As a result, when the erase potential Vera is applied to the cell well, the potential of the word line rises to Vera or the vicinity of Vera by the capacity coupling of the cell well and word line (control gate electrode). Therefore, since the high electric field is not applied to the tunnel oxide films of the memory cells in the unselected memory cell block, the electrons do not move in the floating gate electrode, and the threshold voltage of the memory cell does not fluctuate.

Additionally, in the first memory cell block shown in FIG. 7, the row shield line exists on the memory cell array. During the erase operation, the potential of the row shield line also rises to Vera from Vss similarly to the potential of the cell well. When the row shield line indicates Vera, the potential of the word line in the unselected memory cell block sufficiently rises to Vera or the vicinity of Vera by the capacity coupling between the cell well and the word line, and the erroneous erasing does not occur.

Moreover, in the second memory cell block shown in FIG. 8, instead of the row shield line, a word line driver selection signal line is provided on the memory cell array. During the eras operation, the word line driver selection signal line is set into the floating state. Moreover, the potential of the bit line also indicates Vera. Therefore, since the potential of the word line in the unselected memory cell block sufficiently rises to Vera or the vicinity of Vera by the capacity coupling between the cell well and the word line, the erroneous erasing does not occur.

Additionally, when the row shield line or the block selection line indicates, for example, Vss or Vdd, a large capacity is generated between the word line and the row shield line or the block selection line in the memory cell under the line. As a result, the potential of the word line does not easily rise, and the erroneous erasing occurs.

After the erase potential (erase pulse) Vera is applied to the cell well, the erase verify is performed to verify whether the erasing is sufficiently performed. The erase verify includes erase verify read in which the data of the memory cell is read after the application of the erase pulse, and “erase completion detection” for detecting whether or not an insufficiently erased column is present based on the data read by the erase verify read.

In the memory circuit of this example (e.g., see FIG. 2), since two bit lines BLe, BLo share one data circuit, the erase verify read is performed with respect to the memory cell connected, for example, to the even-numbered bit line BLe, and subsequently the “erase completion detection” is performed so as to detect whether or not the data of all the memory cells connected to the even-numbered bit line BLe is erased.

Thereafter, after the erase verify read is performed with respect to the memory cell connected, for example, to the odd-numbered bit line BLo, the “erase completion detection” is performed so as to detect whether or not the data of all the memory cells connected to the odd-numbered bit line BLo is erased.

Moreover, when the sufficient erasing is confirmed with respect to all the selected memory cells, the erase operation ends. When there is the insufficiently erased memory cell, the erase operation (the application of the erase pulse) is performed again.

The erase operation will be described hereinafter in detail with respect to the operation timing chart.

3.-1. Erase Pulse Application

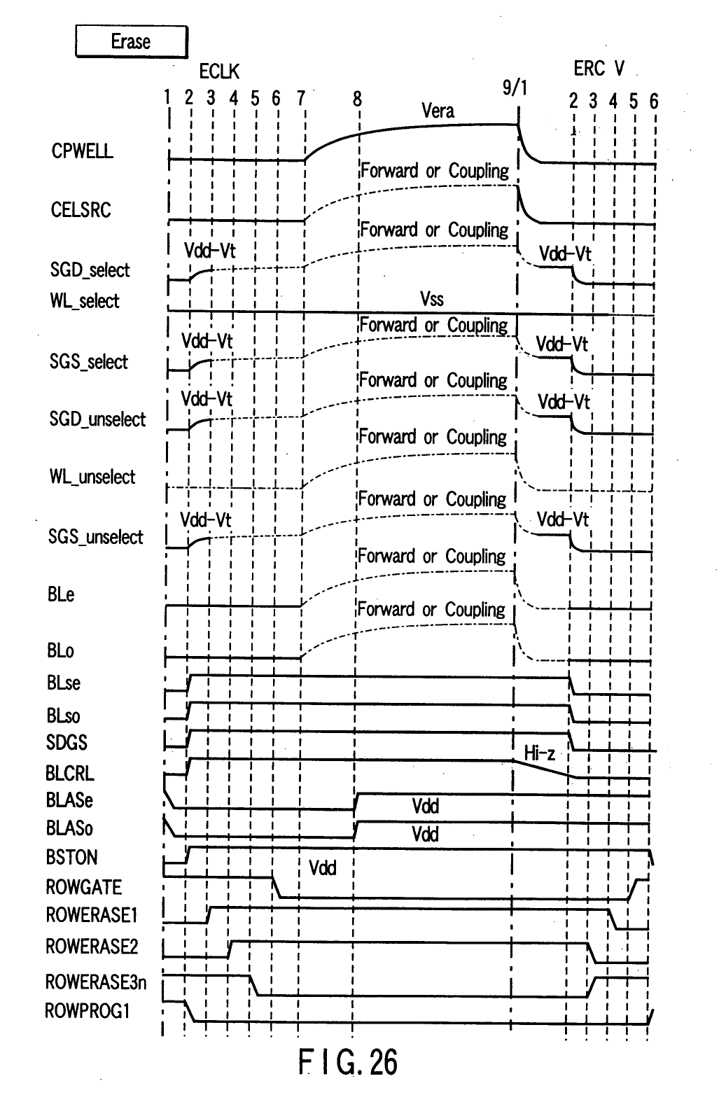

FIG. 26 shows the operation timing concerning the application of the erase pulse.

<Odd-Numbered Memory Cell Block>

In the odd-numbered memory cell block, the word line control circuit (row address decoder and word line driver) for controlling the potentials of the word line and select gate line in the block is disposed on one side of the memory cell array. The first memory cell block will be described hereinafter as an example.

When the first memory cell block is selected, the output signal RDECAD of the row address decoder RADD1 of FIG. 9 indicates Vdd, and the node TransferG1 in the word line driver RMAIN1 of FIG. 10 is set to Vdd. The potentials of the signal lines CG1, CG2, . . . CG16 are set to the ground potential Vss by the switch circuit (FIG. 1). Moreover, the potentials of the signal lines SGD, SGS are set to Vdd.

In this case, the potential of the word lines WL1, WL2, . . . WL16 is set to the ground potential Vss, and the select gate lines SG1, SG2 have a potential of Vdd-Vth (Vth denotes the threshold voltage of the MOS transistor HNt1), and are set into the floating state.

When the first memory cell block is unselected, the output signal RDECAD of the row address decoder RADD1 of FIG. 9 indicates Vss, and the node TransferG1 in the word line driver RMAIN1 of FIG. 10 is set to Vss. As a result, the word lines WL1, WL2, . . . WL16 have the ground potential Vss, and are set into the floating state.

Moreover, the MOS transistors HN7, HN8 are turned on, SGDS indicates Vdd, and therefore the select gate lines SG1, SG2 have a potential of Vdd-Vth (Vth denotes the threshold voltage of the MOS transistors HN7, HN8), and are set into the floating state.

<Even-Numbered Memory Cell Block>

In the even-numbered memory cell block, for the word line control circuit for controlling the potentials of the word line and select gate line in the block, the row address decoder is disposed on one side of the memory cell array, and the word line driver is disposed on the other side of the memory cell array. The second memory cell block will be described hereinafter as an example.

First, in time ECLK2, ROWPROG1 indicates Vss, ROWPROG1B indicates Vdd, and the clocked inverters CINV5, CINV6 in the word line driver RMAIN2 of FIG. 12 are set into the inoperative state. Thereafter, in time ECLK3, ROWERASE1 indicates Vdd, ROWERASE1B indicates Vss, the clocked inverters CINV3 in the row address decoder RADD2 of FIG. 11 is set into the inoperative state, and the clocked inverter CINV4 is set into the operative state.

When the second memory cell block is selected, RDECADS1 indicates Vdd, and therefore the output signal RDECADS of the row address decoder RADD2 of FIG. 11 is set to Vss. Moreover, when the second memory cell block is unselected, RDECADS1 indicates Vss, and therefore the output signal RDECADS of the row address decoder RADD2 of FIG. 11 is set to Vdd.

Thereafter, in time ECLK4, ROWERASE2 indicates Vdd, ROWERASE2B indicates Vss, and the clocked inverter CINV7 is set into the operative state.

As a result, when the second memory cell block is selected, RDECADS2 indicates Vdd, and therefore the node TransferG2 in the word line driver of FIG. 12 is set to Vdd. On the other hand, when the second memory cell block is unselected, RDECADS2 indicates Vss, and therefore the node TransferG2 in the word line driver of FIG. 12 is set to Vss.

Thereafter, when ROWERASE3n indicates Vss in time ECLK5, and the second memory cell block is unselected (RDECADS2 indicates Vss), the data is latched.

Moreover, when ROWGATE indicates Vss in time ECLK6, and the second memory cell block is unselected (RDECADS indicates Vdd), the MOS transistors DHN6, DHN9 (FIGS. 11 and 12) turned off, and the word line driver selection signal line 22 (FIG. 8) is set into the floating state.

In this manner, even when the odd-numbered memory cell block is selected, or even when the even-numbered memory cell block is selected, in time ECLK6, the word line in the selected block is set to Vss, and the word line and select gate line in the unselected block are set into the floating state.

Moreover, for the even-numbered memory cell block, when the block is unselected, the word line driver selection signal line 22 (FIG. 8) indicates Vdd, and is set into the floating state.

Thereafter, a cell well CPWELL is set to Vera (e.g., about 20 V) in time ECLK7. In this case, in the selected block, the high electric field is applied between the word line (ground potential Vss) and the cell well, the electrons in the floating gate electrode of the memory cell are discharged in the cell well, and the data erasing is executed.

Moreover, when the cell well CPWELL is set to Vera (e.g., about 20 V) in the unselected block in time ECLK7, the potential of the word line rises to Vera or the vicinity of Vera by the capacity coupling between the word line and the cell well. In this case, the potential of the word line driver selection signal line 22 (FIG. 8) rises by the capacity coupling between the word line driver selection signal line and the cell well.

Therefore, in the unselected block, since the high electric field is not applied between the word line and the cell well, the electrons in the floating gate electrode of the memory cell are not discharged in the cell well, and the data erasing is not performed.

Additionally, BIASe and BIASo are set to Vdd in time ECLK8, so that surface leak currents of drains of the MOS transistors HN1e, HN1o (FIG. 2) are decreased.

Moreover, a recovery operation is performed after the erasing in and after time ERCV1.

When the potential of the cell well CPWELL drops to about 10 V from Vera, BLCRL is grounded to Vss, and the charges of the bit lines BLe, BLo are discharged. When Vera is about 10 V, the bit lines BLe, BLo drop to about 12 V by the capacity coupling between the bit lines BLe, BLo and the cell well CPWELL.

Therefore, the MOS transistors HN1e, HN1o (FIG. 2) having BIASe and BIASo inputted to the gates thereof do not snap back.

Additionally, when the cell well CPWELL indicates about 20 V, BLCRL is grounded to Vss, the charges of the bit lines BLe, BLo are discharged, the MOS transistors HN1e, HN1o (FIG. 2) having BIASe and BIASo inputted to the gates thereof snap back, and a problem occurs that the MOS transistors are destroyed.

3.-2. “Erase Verify Read”

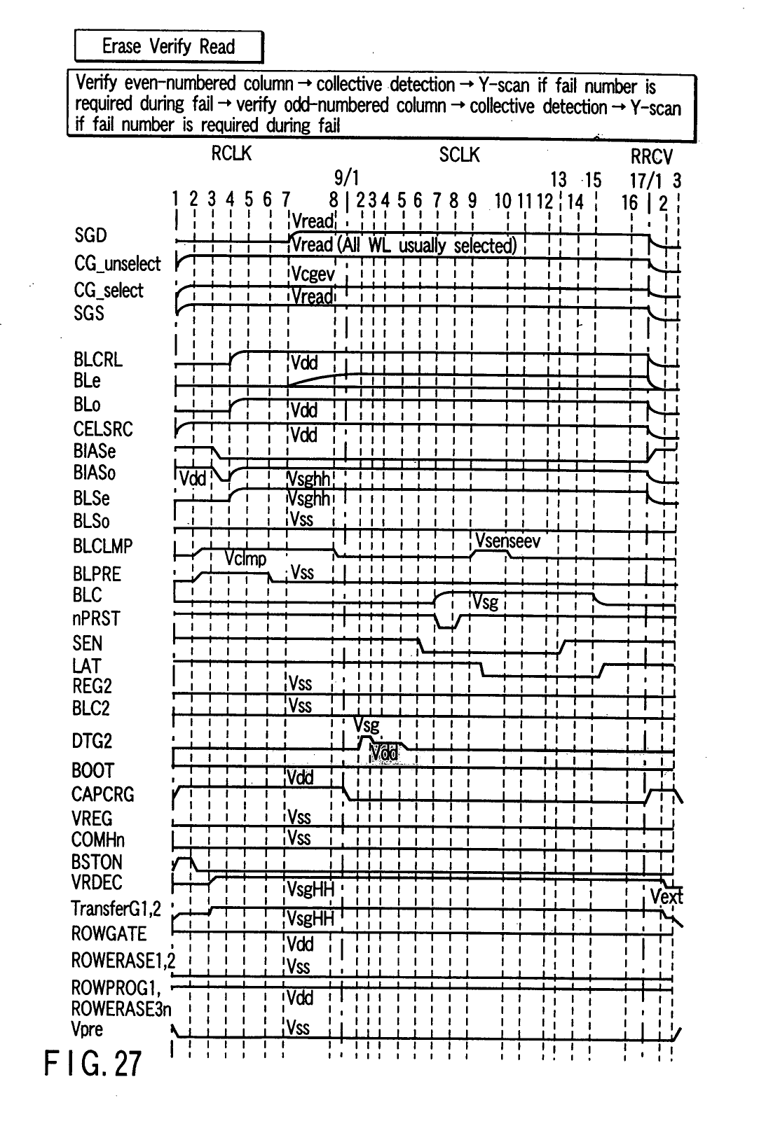

FIG. 27 shows the operation timing of the erase verify read. In this example, it is assumed that the erase verify read is performed with respect to the memory cell connected to the even-numbered bit line BLe, and the odd-numbered bit line BLo is used as the shield bit line. In the erase verify read, the shield bit line BL0 is set to Vdd.

First, CAPCRG is set to Vdd in time RCLK1, and BLCLMP is set to Vclmp (e.g., about 2 V) in time RCLK2. Moreover, when REG1 indicates Vdd in time RCLK5, the selected bit line BLe is set to Vss (0V) (VREG indicates Vss, and CAP1ij indicates Vdd).

In time RCLK7, the selected word line (control gate electrode) CGselect is set to Vcgev (e.g., 0 V), and the select gate line SGD is set to Vread (e.g., about 3.5 V) (SGS indicates Vread).

The memory cells usually connected to the bit line BLe and connected to all the word lines in the selected block are usually subjected to the erase verify read substantially at the same time. Therefore, all the word lines WL1, WL2, . . . WL16 in the selected block are set to Vcgev.

As a result, when the data is sufficiently erased from all the memory cells (memory cells in the 1NAND cell unit) connected to one bit line BLe in the selected one block, the bit line BLe indicates “H”. Moreover, when the data is insufficiently erased from at least one memory cell among the memory cells connected to one bit line BLe in the selected one block, the bit line BLe indicates “L”.

Additionally, in the erase verify read, the unselected bit line BLo is set to Vdd in order to reduce the coupling noise generated between the bit lines.

After the potential of each bit line BLe is verified, the potential of the bit line BLe is sensed similarly as the usual read.

Moreover, when the data is sufficiently erased from all the memory cells connected to one bit line BLe in the selected one block, the sense node DTNij (output node Naij of the latch circuit LATCH) in the data circuit connected to the bit line BLe indicates “H”.

Furthermore, when the data is insufficiently erased from at least one of the memory cells connected to one bit line BLe in the selected one block, the sense node DTNij (output node Naij of the latch circuit LATCH) in the data circuit connected to the bit line BLe indicates “L”.

3.-3. “Erase Completion Detection”

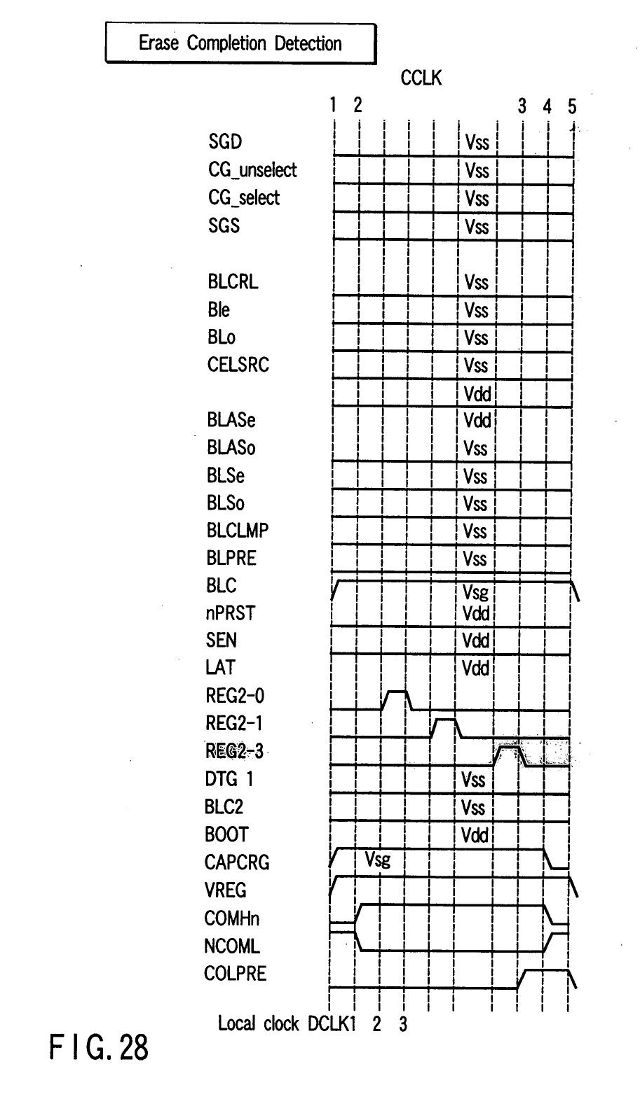

FIG. 28 shows the operation timing of the erase completion detection. After the erase verify read, the “erase completion detection” is performed to detect whether or not the erasing is completed in all the columns.

In FIG. 5, when the output node Naij of the latch circuit LATCH in all the data circuits indicates “H”, FLAG maintains “H”. In FIG. 5, when the output node Naij of the latch circuit LATCH in at least one data circuit indicates “L”, FLAG indicates “L”.

The FLAG nodes are connected to all the columns. When the data is insufficiently erased from at least one of the memory cells in the selected one block, the FLAG node indicates “L”, and the erase pulse is applied again. When the data is sufficiently erased from all the memory cells in the selected one block, the FLAG node indicates “H”, and the erase operation ends.

Additionally, since the “erase completion detection” is substantially similar to the “program completion detection” in the above-described “write operation of the even-numbered page data”, the detailed description of the operation is omitted.

Moreover, in the present embodiment, the multileveled NAND cell type EEPROM device has been described as the example, but the present invention can be applied to another type of the multileveled memory. Examples of the memory cell array include a NOR-type, AND-type (A. Nozoe: ISSCC, Digest of Technical Papers, 1995), DINOR type (S. Kobayashi: ISSCC, Digest of Technical Papers, 1995), virtual ground array type (Lee, et al.: Symposium on VLSI Circuits, Digest of Technical Papers, 1994), and the like.

Furthermore, the present invention is not limited to the flash memory, and can also be applied to the nonvolatile semiconductor memories such as a mask ROM, and EPROM.

As described above, according to a nonvolatile semiconductor memory device of the present invention, when the data stored in the memory cell is set to be multileveled, the number of elements in the data circuit for temporarily storing the multileveled data during the writing/reading is decreased, and the chip area can be inhibited from increasing.

1-50. (canceled)

51. A nonvolatile semiconductor memory device comprising:
a memory cell capable of storing 2-bit data;
a data input/output circuit;
a data hold circuit; and
a bit line connected between the memory cell and the data hold circuit, wherein a first bit data inputted to the data input/output circuit is written in the memory in a write mode, and
during a write voltage application period in which a write voltage is applied to the memory cell in the write mode, a second bit data inputted through the data input/output circuit is held in the data hold circuit, during a verify read operation mode in which it is checked if the first bit data is sufficiently written in the memory is executed, the second bit data inputted through the data input/output circuit is held in the data hold circuit, and in the verify read operation period, the first data read from the memory cell is held on the bit line.

52. A nonvolatile semiconductor memory device according to claim 51, wherein the first bit data read from the memory cell is held on the bit line as a bit line precharge potential in the verify read operation period.

53. A nonvolatile semiconductor memory device according to claim 51, wherein the data hold circuit comprises a latch circuit configured to hold one bit of data.

54. A nonvolatile semiconductor memory device according to claim 51, in which the data hold circuit comprises a latch circuit and a data storage element.

55. A nonvolatile semiconductor memory device according to claim 54, in which in the write mode, the latch circuit temporarily holds data inputted through the data input/output circuit to the data hold circuit.

56. A nonvolatile semiconductor memory device according to claim 54, in which in the verify read operation period, the latch circuit holds data read on the bit line from the memory cell, and the data storage element storages data which is transferred from the data input/output circuit to the data hold circuit and has been held by the latch circuit.

57. A nonvolatile semiconductor memory device according to claim 54, in which the latch circuit comprises a static RAM, and the data storage element comprises a MOS capacitor.

58. A nonvolatile semiconductor memory device according to claim 51, in which the memory cell is a NAND cell.

59. A nonvolatile semiconductor memory device according to claim 51, in which a sense amplifier is connected between the data hold circuit and the data input/output circuit to sense data.
